(19) United States
(12) Patent Application Publication
(10) Pub. No.: US 2015/0049389 A1
(43) Pub. Date: Feb. 19, 2015

(54) DISPLAY DEVICE

(71) Applicant: Sharp Kabushiki Kaisha, Osaka-shi, Osaka (JP)

(72) Inventors: Kiyoshi Minoura, Osaka-shi (JP); Chiaki Minari, Osaka-shi (JP); Tokio Taguchi, Osaka-shi (JP)

(73) Assignee: Sharp Kabushiki Kaisha, Osaka-shi, Osaka (JP)

(21) Appl. No.: 14/377,002

(22) PCT Filed: Jan. 30, 2013
(86) PCT No.: PCT/JP2013/052040

§ 371 Date: Aug. 6, 2014

(30) Foreign Application Priority Data
Feb. 20, 2012 (JP) 2012-034547

(51) Int. Cl. G02B 1/11; G02F 1/1333; G02F 1/1335

(52) U.S. Cl. CPC G02B 1/118; G02F 1/133502; G02F 1/13338; G02F 2001/133562
USPC 359/601

(57) ABSTRACT

Disclosed is a display device capable of suppressing the occurrence of interference fringe in an oblique direction. A front sheet is disposed in front of a display panel with an air layer interposed therebetween. A film is disposed on the front surface of the display panel or on the rear surface of the front sheet. The air layer has a thickness of ≦50 μm. The display panel and/or the front sheet can be warped. The thickness of the air layer varies within a range of 0 μm to 50 μm. Further, the film includes a moth-eye structure on a surface contacting the air layer. Finally, a reflectance at at least one wavelength within a range of 600 to 780 nm is smaller than a reflectance at a wavelength of 550 nm in the reflection spectrum of 5-degree specular reflection of the moth-eye structure.

### TECHNICAL FIELD

The present invention relates to a display device. Specifically, the present invention relates to a display device that is suitable as a display device including a display panel, such as a liquid crystal panel, and a front sheet, such as a touch panel.

### BACKGROUND ART

Display devices including a display panel (e.g., liquid crystal panel) are widely used in apparatus, such as television, mobile phones, and PC displays. Great progress has been made especially in technology to produce small lightweight or big-screen liquid crystal display devices including a liquid crystal panel. The following techniques relating to such devices have recently attracted attention.

The first one is a technique of disposing a touch panel or a laminate of a protection sheet and a touch panel in front of a display panel in a display device for use as mobile devices, such as smart phones and tablet computers. The protection sheet is a component to protect the display panel, and is usually disposed in front of the touch panel.

The second one is a technique of using a display device including a display panel in an outdoor or semi-outdoor display medium, such as digital signage. A display device for digital signage may include a protection sheet in front of the display panel and may further include a touch panel.

The third one is a technique of using a film which has a moth-eye structure capable of suppressing reflection without optical interference as an anti-reflection film for a display device.

Herein, a component disposed in front of a display panel, such as a touch panel or a protection sheet, is also referred to as a front sheet.

The following arts relating to the above techniques have been known.

Patent Literature 1, for example, discloses a display device which includes a transparent touch panel with an anti-reflection function on a rear surface of a rearmost transparent substrate and a display panel. The transparent substrate has fine irregularities functioning as so-called a moth-eye structure on the rear surface.

Non-Patent Literature 1, for example, discloses a method for forming a moth-eye structure by blue ray disk technology.

Non-Patent Literatures 2 to 6, for example, disclose various methods for calculating the reflective properties of structures smaller than visible light wavelength, such as moth-eye structures.

Non-Patent Literature 7, for example, discloses resistive film touch panels, surface capacitance touch panels, and projective capacitance touch panels.

Patent Literature 2, for example, discloses a method for producing a touch panel glass. The method includes a surface-roughening treatment to adjust the surface roughness Ra of an entire surface or a part of a surface of the glass to 3 to 50000 Å. Patent Literature 2 mentions that the touch panel glass preferably has a Young's modulus of not less than 70 GPa.

Patent Literature 3, for example, discloses a tabular component which includes a substrate, a first moth-eye film on one surface of the substrate, and a second moth-eye film on the other surface of the substrate. Light consisting of reflected light on a surface of the first moth-eye film and reflected light on a surface of the second moth-eye film exhibits flat chromatic dispersion within the visible light range.

Patent Literatures 4, 5, and 6, for example, disclose technologies relating to interference-type anti-reflection films. Patent Literatures 4 and 5, for example, disclose a low refractive index thin film including a fine particle layer film in which a layer of fine particles and a layer of polymers are alternately laminated on a substrate. The fine particle layer film has a gap structure which does not scatter visible light.

Patent Literature 6, for example, discloses a low refractive index thin film including a substrate having a softening temperature of not higher than 200° C. and a thin film having a refractive index of from 1.20 to 1.30 on at least one surface of the substrate.

Regarding a method for forming a mold for forming a moth-eye structure, Patent Literature 7, for example, discloses a method for forming an anodic oxide layer, including the steps of (a) preparing an aluminum substrate having an aluminum surface, (b) anodic oxidizing the surface to form a barrier alumina layer, and (c) further anodic oxidizing the surface after the step (b) to form a porous alumina layer having a plurality of fine recesses.

### CITATION LIST

### Patent Literature

Patent Literature 1: JP 2003-50673 A
Patent Literature 2: JP 2010-70445 A
Patent Literature 3: WO 2011/016270
Patent Literature 4: JP 2006-301124 A
Patent Literature 5: JP 2006-301125 A
Patent Literature 6: JP 2006-301126 A
Patent Literature 7: WO 2010/064798

### Non Patent Literature

Non Patent Literature 1: Sohmei Endoh, Kazuya Hayashibe, “Nanomold Fabrication and Nanoimprint Anti-reflection Structures utilized Blu-ray Disc Technology”, Collection of speech at the 7th International Conference on Nanoimprint and Nanoprint Technology (NNT'08)), Japan, 2008, p. 6-7
Non Patent Literature 2: Masao Tsuruta, “Applied Optics”, First edition, vol. 2, Baifukan Co., Ltd, 1990, p. 119-125
Non Patent Literature 3: Grann, Eric B, Moharam, M G, Pommet, Drew A, “Artificial uniaxial and biaxial dielectrics with use of two-dimensional subwavelength binary gratings”, The Journal of the Optical Society of America A, United States, 1994, vol. 11, p. 2695
Non Patent Literature 4: Grann, Eric B, Varga, M G, Pommet, Drew A, “Optical design for antireflective tapered two-dimensional subwavelength binary grating structures”, The Journal of the Optical Society of America A, United States, 1995, vol. 12, p.
Non Patent Literature 5: H. Kogelnik, “Coupled Wave Theory for Thick Hologram Gratings”, The Bell System Technical Journal, United States, 1969, vol. 48, p. 2909
Non Patent Literature 6: Hisao Kikuta, Koichi Iwata, “Formation of Wavefront and Polarization with Sub-Wavelength Gratings”, Japanese Journal of Optics, 1998, vol. 27, First edition, p. 17
Non Patent Literature 7: Edited by Kenji Koshiishi and Osamu Kurosawa, “Understanding Touch Panels (Tatchi paneru ga wakaru hon)”, First edition, Ohmsha Ltd., May 20, 2011, p. 32-33, 40-43, 46-47, 50-51, 56-57

### SUMMARY OF INVENTION

### Technical Problem

In a display device including a display panel and a front sheet, an air layer (air gap), if present, between the display panel and the front sheet may become thinner when external pressure is locally applied to the front sheet (for example, when the front sheet is pressed with a finger). Reflected light on the rear surface of the front sheet and reflected light on the front surface of the display panel may interfere with each other to generate interference fringes. Interference fringes reduce the visibility of a screen of the display panel. Interference fringes may be derived from warping of the front sheet and/or display panel (usually display panel) caused during assembly of the display device. A recent demand for entirely thinner and lighter display devices has led to a trend of thinner air layer, display panel, and front sheet, resulting in an increase in the occurrence of interference fringes.

Light reflected on two interfaces which are apart from each other at a distance of more than 100 μm rarely interferes, and thus substantially no interference fringe occurs. In the case of two interfaces apart from each other at a distance of 50 to 100 μm, interference fringes may be visually observed when high coherent light (e.g., laser beam) is reflected, whereas interference fringes are not prominent when low coherent light (e.g., sunlight, fluorescent light) is reflected. In the case of two interfaces apart from each other at a distance of not more than 50 μm (especially not more than 10 μm), interference fringes are prominent even when low coherent light is reflected.

Interference fringes may be prevented from occurring by filling the air layer with an ultraviolet ray curable resin. After this treatment, however, the front sheet cannot be reassembled or replaced with new one. Moreover, if part of the resin is not exposed to ultraviolet rays, the unexposed part remains uncured.

The following describes a display device 101 of Comparative Embodiment 1 examined by the inventors of the present application.

As shown in FIG. 77, the display device 101 includes a display panel 110, a front sheet 130 disposed in front of the display panel 110 with an air layer 120 interposed therebetween, and a low reflection film 140 attached to the rear surface of the front sheet 130. The low reflection film 140 reduces light reflection on the rear surface of the front sheet 130. Thus, when a screen is observed from the front of the display device 101, occurrence of interference fringes is suppressed. Use of a film having a moth-eye structure (hereinafter, also referred to as moth-eye film) as the low reflection film 140 greatly reduces the reflection of light at the interface between the low reflection film 140 and the air layer 120. Thus, a moth-eye film produces a great effect. However, even if a moth-eye film is used, interference fringes occur on the screen in an observation from an oblique direction as shown in FIG. 78.

This is supposedly because of the following reasons. From an industrial point of view, the heights and the aspect ratios of protrusions in moth-eye structures cannot be sufficiently increased by the current technology. Moth-eye films thus have a little wavelength-dependent reflectance. Under such restriction, the heights and the aspect ratios (especially heights) of protrusions are set so that the luminous reflectance (Y value) of a moth-eye film is as low as possible in a front direction. Moreover, as shown in FIG. 79, the reflection spectrum of the moth-eye structure in a front direction (for example, reflection spectrum of 5-degree specular reflection RS (5°)) is set so that the minimal value of the reflection spectrum is around 550 nm because the visibility is high around 550 nm. Under the above setting, however, when the measurement direction is changed from a front direction to an oblique direction, the reflection spectrum of the moth-eye structure shifts to the short-wavelength side while increasing overall. Namely, as shown in FIG. 79, the reflectance greatly increases around 550 nm in the reflection spectrum of the moth-eye structure in an oblique direction (e.g., reflection spectrum of 45-degree specular reflection RS (45°)). Based on these findings, even in the case of no visible interference fringes in a front direction, presumably interference fringes occur in an oblique direction due to insufficient suppression of light reflectance.

The present invention was made in view of the aforementioned current status, and aims to provide a display device capable of suppressing the occurrence of interference fringes not only in a front direction but also in an oblique direction.

### Solution to Problem

After various studies on display devices capable of suppressing the occurrence of interference fringes not only in a front direction but also in an oblique direction, the inventors of the present invention have focused on the reflection properties of moth-eye structures. The inventors have found that, when a minimal value of the reflection spectrum of a moth-eye structure in a front direction, especially a minimal value of the reflection spectrum of 5-degree specular reflection RS(5°), is controlled to be on the longer wavelength side than 550 nm as shown in FIG. 11, a minimal value of the reflection spectrum in an oblique direction, especially a minimal value of the reflection spectrum of 45-degree specular reflection RS(45°), can be closer to 550 nm. As a result of further studies, the inventors have found that, when the reflectance of at least one wavelength within a range of 600 nm to 780 nm is controlled to be smaller than the reflectance at a wavelength of 550 nm in the reflection spectrum of 5-degree specular reflection on a moth-eye structure, a small Y value can be achieved in an oblique direction while the Y value is within an allowable range in a front direction. Accordingly, they successfully solve the aforementioned problems to complete the present invention.

That is, one aspect of the present invention is a display device (hereinafter, also referred to as the display device of the present invention) including: a display panel, a front sheet disposed in front of the display panel with an air layer interposed therebetween, and a film (first film) disposed on the front surface of the display panel or on the rear surface of the front sheet. The air layer has a thickness of not more than 50 μm. At least one of the display panel and the front sheet can be warped. The thickness of the air layer varies within a range of 0 μm to 50 μm when at least one of the display panel and the front sheet is warped. The film includes a moth-eye structure (first moth-eye structure) on a surface contacting the air layer. A reflectance at at least one wavelength within a range of 600 to 780 nm is smaller than a reflectance at a wavelength of 550 nm in the reflection spectrum of 5-degree specular reflection of the moth-eye structure.

The configuration of the display device of the present invention is not especially limited by other components as long as it essentially includes such components.

The following describes preferable embodiments of the display device of the present invention. The preferable embodiments may be employed in combination. An embodiment including a combination of two or more of the following preferable embodiments is also a preferable embodiment.

The front sheet has a Young's modulus of less than 70 and may further include a component which deforms with the aforementioned film upon deformation of the film. Such a front sheet enables to more efficiently suppress the occurrence of interference fringes.

For achieving both good productivity and an effect of suppressing the occurrence of interference fringes, the moth-eye structure preferably has a height of from 200 nm to 350 nm, and more preferably has a maximum height of not more than 300 nm.

For similar purposes, the moth-eye structure has an aspect ratio of preferably not more than 3, and more preferably not more than 2.5.

In view of antireflection performance in an oblique direction, the moth-eye structure preferably has an aspect ratio of not less than 0.5.

For improving the visibility of a screen of the display panel in observation from an oblique direction, the moth-eye structure has a pitch of preferably not longer than 150 nm, and more preferably not longer than 120 nm. In this case, the moth-eye structure preferably has a pitch randomness of from 25% to 35%. Such a moth-eye structure can surely and effectively improve the visibility in an oblique direction.

For more effectively suppressing the occurrence of interference fringes, the display device of the present invention preferably further includes a second film disposed on either of the front surface of the display panel or the rear surface of the front sheet on which the film (first film) is not disposed. The second film preferably includes a moth-eye structure (second moth-eye structure) on a surface contacting the air layer.

For particularly effectively suppressing the occurrence of interference fringes, a reflectance at at least one wavelength within a range of 600 nm to 780 nm is preferably smaller than the reflectance at a wavelength of 550 nm in the reflection spectrum of 5-degree specular reflection of the second moth-eye structure.

From similar points of view to those concerning the first film, the second film preferably has properties similar to those of the first film.

Specifically, the second moth-eye structure has a height of from 200 nm to 350 nm, and more preferably has a maximum height of not more than 300 nm.

The second moth-eye structure has an aspect ratio of preferably not more than 3, and more preferably not more than 2.5.

The second moth-eye structure preferably has an aspect ratio of not less than 0.5.

The second moth-eye structure has a pitch of preferably not longer than 150 nm, and more preferably not longer than 120 nm. In this case, the second moth-eye structure preferably has a pitch randomness of from 25% to 35%.

Another aspect of the present invention is a film (hereinafter, also referred to as a film of the present invention) having a moth-eye structure on a surface, the moth-eye structure having a pitch of not longer than 150 nm.

The configuration of the film of the present invention is not especially limited by other components as long as it essentially includes such components.

For similar points of view to those concerning the display device of the present invention, examples of preferable embodiments of the film of the present invention include the preferable embodiments of the first film in the display device of the present invention. The preferable embodiments of the film of the present invention may be employed in combination. An embodiment including a combination of two or more of the preferable embodiments is also a preferable embodiment.

### Advantageous Effects of Invention

The present invention enables to provide a display device capable of suppressing the occurrence of interference fringes not only in a front direction but also in an oblique direction.

### BRIEF DESCRIPTION OF DRAWINGS

FIG. 1 is a schematic cross-sectional view of a display device according to Embodiment 1.

FIG. 2 is a schematic cross-sectional view of a display device according to Embodiment 1 when the front sheet is warped.

FIG. 3 is a schematic cross-sectional view of a display device according to Embodiment 1 when the display panel is warped.

FIG. 4 is a schematic cross-sectional view of a display device according to Embodiment 1 when the front sheet and the display panel are warped.

FIG. 5 is a schematic cross-sectional view of a display device according to Embodiment 1 when the front sheet is warped to contact the display panel.

FIG. 6 is a schematic cross-sectional view of a display device according to Embodiment 1 when the display panel is warped to contact the front sheet.

FIG. 7 is a schematic cross-sectional view of a display device according to Embodiment 1 when the front sheet and the display panel are warped to contact each other.

FIG. 8(a) shows an SEM photograph of an entire eye of a moth, and FIG. 8 (b) shows an SEM photograph of a part of an eye of a moth.

FIG. 9(a) and FIG. 9(b) are schematic views illustrating an effect of preventing light reflection in Embodiment 1.

FIG. 10 shows the reflection spectra of the moth-eye film according to Embodiment 1, a conventional LR film, and a conventional AR film.

FIG. 11 is a schematic view of the reflection spectra of a moth-eye film according to Embodiment 1.

FIG. 12 is a schematic perspective view of protrusions of a moth-eye film according to Embodiment 1.

FIG. 13 is a schematic perspective view of protrusions of a moth-eye film according to Embodiment 1.

FIG. 14 is a schematic perspective view of protrusions of a moth-eye film according to Embodiment 1.

FIG. 15 is a schematic perspective view of protrusions of a moth-eye film according to Embodiment 1.

FIG. 16 is a schematic cross-sectional view of a moth-eye film according to Embodiment 1.

FIG. 17 is a schematic cross-sectional view of a moth-eye film according to Embodiment 1.

FIG. 18 is a schematic cross-sectional view of a display device according to Embodiment 1.

FIG. 19 is a cross-sectional view of a liquid crystal cell according to Embodiment 1 in the production process before a pair of substrates are formed into a thin plate.

FIG. 20 is a cross-sectional view of a liquid crystal cell according to Embodiment 1 in the production process after a pair of substrates are formed into a thin plate.

FIG. 21 is a schematic perspective view of a glass plate as a substrate of a mold.

FIG. 22 is a schematic perspective view of an aluminum pipe as a substrate of a mold.

FIG. 23 is a schematic perspective view of an electrodeposited sleeve as a substrate of a mold.

FIG. 24(a) is a schematic perspective view illustrating an anodic oxidation process. FIG. 24(b) is a schematic perspective view illustrating an etching process.

FIG. 25 is a schematic perspective view illustrating a process of applying a mold release agent.

FIG. 26 is a schematic perspective view illustrating a process of applying a mold release agent.

FIG. 27 is a schematic cross-sectional view illustrating a shape transfer process.

FIG. 28 is a schematic cross-sectional view illustrating a shape transfer process.

FIG. 29 is an SEM photograph of a cross section of a film 1.

FIG. 30 is an SEM photograph of a cross section of a mold for the film 1.

FIG. 31 is an SEM photograph of cross sections of a film 2 and a mold for the film 2.

FIG. 32 is an SEM photograph of a cross section of a film 3.

FIG. 33 is an SEM photograph of a cross section of a mold for the film 3.

FIG. 34 is an SEM photograph of a cross section of a film 12.

FIG. 35 is an SEM photograph of a cross section of a film 13.

FIG. 36 is an SEM photograph of a cross section of a film 14.

FIG. 37 is a schematic view illustrating a method for measuring the spectrum of specularly reflected light.

FIG. 38 (a) and FIG. 38 (b) show the spectra of specularly reflected light on a film 1.

FIG. 39(a) and FIG. 39(b) show the spectra of specularly reflected light on a film 2.

FIG. 40(a) and FIG. 40(b) show the spectra of specularly reflected light on a film 3.

FIG. 41 (a) and FIG. 41 (b) show the spectra of specularly reflected light on a film 4.

FIG. 42 (a) and FIG. 42(b) show the spectra of specularly reflected light on a film 5.

FIG. 43(a) and FIG. 43(b) show the spectra of specularly reflected light on a film 6.

FIG. 44 (a) and FIG. 44 (b) show the spectra of specularly reflected light on a film 7.

FIG. 45(a) and FIG. 45(b) show the spectra of specularly reflected light on a film 8.

FIG. 46(a) and FIG. 46(b) show the spectra of specularly reflected light on a film 9.

FIG. 47 (a) and FIG. 47 (b) show the spectra of specularly reflected light on a film 10.

FIG. 48 (a) and FIG. 48 (b) show the spectra of specularly reflected light on a film 11.

FIG. 49(a) and FIG. 49(b) show the spectra of specularly reflected light on a film 12.

FIG. 50(a) and FIG. 50(b) show the spectra of specularly reflected light on a film 13.

FIG. 51(a) and FIG. 51(b) show the spectra of specularly reflected light on a film 14.

FIG. 52 is a graph collectively showing the reflection spectra of 5-degree specular reflection of the films 1 to 3.

FIG. 53 is a graph collectively showing the reflection spectra of 45-degree specular reflection of the films 1 to 3.

FIG. 54 shows reflection spectra of 0-degree specular reflections of a moth-eye structure determined by calculation based on the effective refractive index medium theory.

FIG. 55 shows reflection spectra of 45-degree specular reflections of a moth-eye structure determined by calculation based on the effective refractive index medium theory.

FIG. 56(a), FIG. 56(b), and FIG. 56(c) are schematic views illustrating the effective refractive index medium theory.

FIG. 57 shows schematic views of multi-layered films in the effective refractive index medium theory.

FIG. 58 is a schematic cross-sectional view illustrating a method of measuring a general haze (front haze).

FIG. 59 is a schematic cross-sectional view of a moth-eye film according to Embodiment 1.

FIG. 60 is a schematic view illustrating a method of observing a moth-eye film according to Embodiment 1.

FIG. 61 is a photograph of two kinds of moth-eye films taken for observing light guide components.

FIG. 62 is a photograph of five kinds of samples for observing deviation hazes taken from an angle of 45 degrees to the normal directions of the main surfaces of the samples.

FIG. 63 is a photograph of five kinds of samples for observing deviation hazes taken from an angle of 50 degrees to the normal directions of the main surfaces of the samples.

FIG. 64 is a photograph of five kinds of samples for observing deviation hazes taken from an angle of 60 degrees to the normal directions of the main surfaces of the samples.

FIG. 65 is a photograph of five kinds of samples for observing deviation hazes taken from an angle of 70 degrees to the normal directions of the main surfaces of the samples.

FIG. 66 is a photograph of five kinds of samples for observing deviation hazes taken from an angle of 75 degrees to the normal directions of the main surfaces of the samples.

FIG. 67 is a photograph of five kinds of samples for observing deviation hazes taken from an angle of 80 degrees to the normal directions of the main surfaces of the samples.

FIG. 68 is a schematic cross-sectional view of samples for measuring front hazes and deviation hazes.

FIG. 69 is a schematic cross-sectional view illustrating a method of measuring an deviation haze.

FIG. 70 shows the results of measurements of front hazes and deviation hazes.

FIG. 71 is a photograph of two kinds of moth-eye films taken for observing the deviation haze.

FIG. 72 is a photograph of two kinds of moth-eye films taken for observing the deviation haze.

FIG. 73 is a photograph of two kinds of moth-eye films taken for observing the deviation haze.

FIG. 74 is a photograph of two kinds of moth-eye films taken for observing the deviation haze.

FIG. 75 is a schematic cross-sectional view of a moth-eye film according to Embodiment 1.

FIG. 76 is a graph showing the distribution of the distances between pores in an anodic oxidation layer.

FIG. 77 is a schematic cross-sectional view of a display device according to Comparative Embodiment 1.

FIG. 78 is a schematic perspective view of a display device according to Comparative Embodiment 1.

FIG. 79 is a schematic view of the reflection spectra of a moth-eye film according to Comparative Embodiment 1.

### DESCRIPTION OF EMBODIMENTS

The terms used herein will be defined below.

The term “front” means a position closer to a viewer. Further, the term “front surface” means a surface on the viewer side. The “rear surface” or “back surface” means a surface opposite to the viewer side. Thus, the rear surface of a front sheet is a surface facing a display panel. The front surface of the display panel is a surface facing the front sheet.

The reflection spectrum of x-degree (x is any number satisfying the inequation: 0≦x<90) specular reflection means the spectrum of specularly reflected light that reflects at a reflection angle of x°. The reflection angle is formed by the normal direction of the main surface of a sample and the direction of the reflected light, and the incident angle is formed by the normal direction and the direction of the incident light.

The Young's modulus is a value determined by a bending resonance method.

The height of the moth-eye structure is an average of the heights of any ten protrusions.

The aspect ratio of the moth-eye structure is a value obtained by dividing the height of a moth-eye structure by the pitch of the moth-eye structure.

The pitch of the moth-eye structure is an average of the pitches of any ten pairs of protrusions. A pitch of protrusions is a distance between two points at which hypothetical perpendicular lines from the apexes of two adjacent protrusions reach the same plane. The plane is parallel to the main surface of the moth-eye film.

In the case of producing a moth-eye structure using a mold having a large number of depressions on its surface, the pitch of the moth-eye structure is substantially the same as the pitch of the mold. Similarly to the case of the moth-eye structure, the pitch of the mold is an average of the pitches of any ten pairs of depressions. A pitch of depressions is a distance between two points at which hypothetical perpendicular lines from the deepest points of two adjacent depressions reach the same plane. The plane is parallel to the main surface of the mold.

Herein, fractions of the measured values of the heights and the pitches of protrusions and the depths and the pitches of depressions are treated by the following method (method also called Swedish rounding). Namely, when the units digit is 3, 4, 5, 6, or 7, it is round down/up to the nearest 5, and when 8, 9, 0, 1, or 2, to the nearest 0.

The pitch randomness of the moth-eye structure is a value obtained as follows: the distances from the apex of a protrusion to the apexes of the first to third nearest protrusions are measured for multiple protrusions; an average value (average distance) and the standard deviation of the distances are calculated; the standard deviation is divided by the average value; and the result is expressed in percentage.

In the case of producing a moth-eye structure with a mold having a large number of depressions on its surface, the pitch randomness of the moth-eye structure is substantially the same as the pitch randomness of the mold. Similarly to the pitch randomness of the moth-eye structure, the pitch randomness of the mold is a value obtained as follows: the distances from the deepest point of a depression to the deepest points of the first to third nearest depressions are measured for multiple depressions; an average value (average distance) and the standard deviation of the distances are calculated; the standard deviation is divided by the average value; and the result is expressed in percentage.

The number of the protrusions or depressions for calculating the pitch randomness of the moth-eye structure or the mold may be unlimitedly set appropriately. The number may be within a range of 100 to 300 for reducing errors.

The average value herein means an arithmetic mean value unless otherwise stated.

The visible light means light having a wavelength of 380 to 780 nm. A wavelength of not longer than the visible light wavelength specifically means a wavelength of not longer than 380 nm.

The present invention will be mentioned in more detail referring to the drawings in the following embodiments, but is not limited to these embodiments.

### Embodiment 1

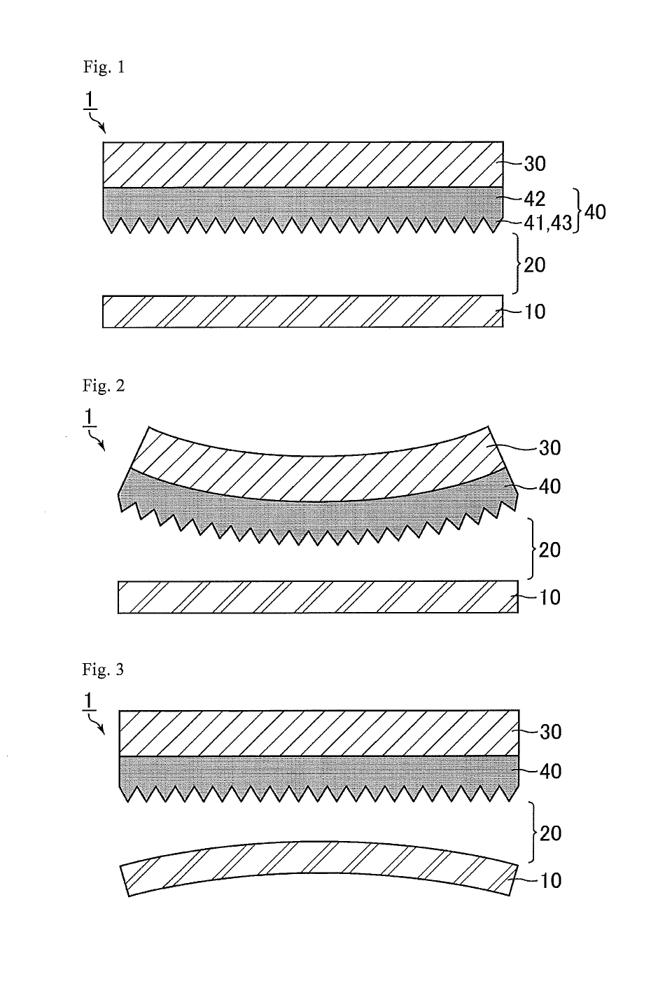

A display device 1 of this embodiment includes a display panel 10, a translucent front sheet 30, and a film (moth-eye film) 40 having a moth-eye structure (nanostructure) 41, as shown in FIG. 1. The front sheet 30 is disposed in front of the display panel 10 with an air layer 20 interposed therebetween, and is located between the display panel 10 and a viewer of images on the display panel 10. The thickness of the air layer 20 is not more than 50 μm (preferably not more than 10 μm). The moth-eye film 40 is attached to the rear surface of the front sheet 30. The moth-eye structure 41 including a large number of protrusions (protruded portions) 43 is formed on the rear surface of the moth-eye film 40, i.e., on the surface contacting the air layer 20. The moth-eye film 40 further includes a substrate 42 which supports the protrusions 43. The front sheet 30 and the moth-eye film 40 are disposed over the entire display area of the display panel 10.

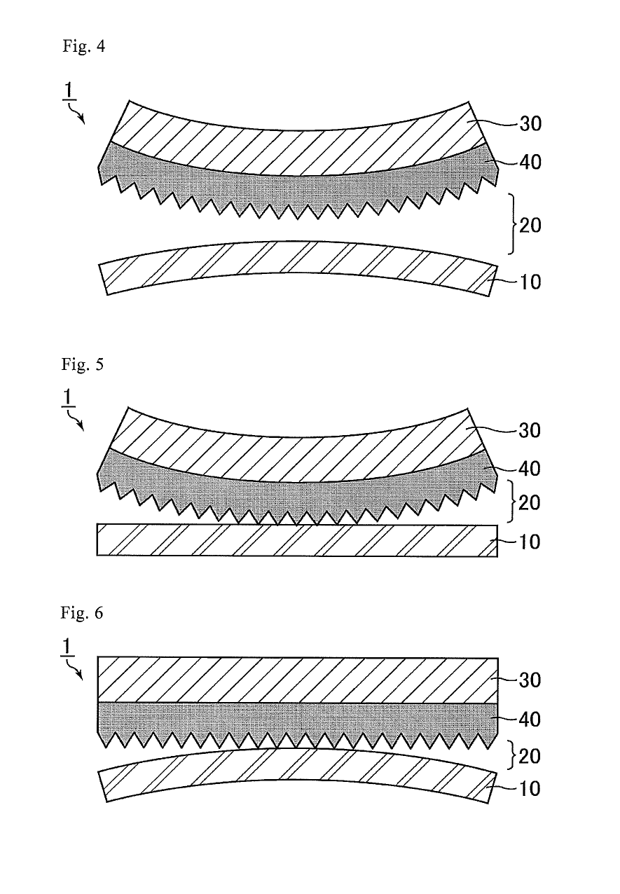

At least one of the display panel 10 and the front sheet 30 can be warped, usually when an external pressure is applied thereto to cause internal stress. As shown in FIG. 2, the front sheet 30 may be warped toward the display panel 10 when a pressure is applied to its front surface (for example, when the front surface is pressed with a finger). As shown in FIG. 3, the display panel 10 may be warped toward the front sheet 30 when a pressure is applied to its edge (for example, when the edge is pressed down by another component). As shown in FIG. 4, the front sheet 30 and the display panel 10 may be warped toward each other. Moreover, as shown in FIG. 5 to FIG. 7, the front sheet 30 and the display panel may contact each other while at least one of them is warped. In the above cases, the air layer 20 has an uneven thickness at a region facing at least one of the warped portion of the front sheet 30 and the warped portion of the display panel 10. The thickness varies in a range of from 0 μm to 50 μm (preferably not more than 10 μm). Interference fringes may thus occur due to reflected light on the front surface of the display panel 10 and reflected light on the rear surface of the front sheet 30 in this embodiment; however, the moth-eye film 40 disposed in the embodiment suppresses the occurrence of interference fringes not only in a front direction but also in an oblique direction, as described later.

The region of the air layer 20 with an uneven thickness may be in any size as long as the region can be visually observed by naked eyes. The size is usually not smaller than 1 mm² (preferably not smaller than 100 mm²) but not larger than the display area of the display panel 10.

The pitches of the protrusions 43 are not longer than the visible light wavelength. The protrusions 43 are each tapered toward the apex. A cross section of each protrusion 43 parallel to the main surface of the moth-eye film 40 (hereinafter, also referred to as horizontal cross section) closer to the apex has a smaller area.

The moth-eye structure 41 enables to effectively reduce light reflection at an interface between the air layer 20 and the moth-eye film 40. The principle will be described below.

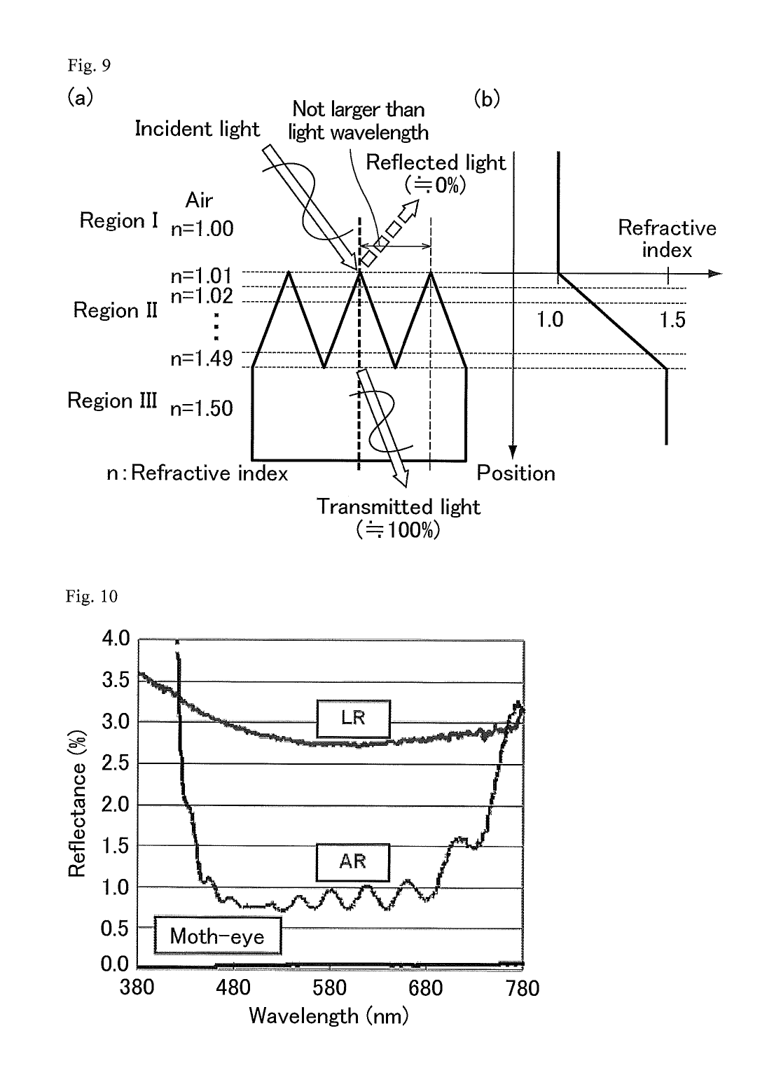

When the refractive index suddenly changes within a distance smaller than the wavelength of incident light at an interface between two substances in the normal direction, the light reflects at the interface. Conversely, light reflection can be prevented by reducing the change in the refractive index at the interface. The substrate 42 has a refractive index of about 1.3 to 1.8, which is greatly different from the refractive index (=1.0) of air. The pitches and the heights of the protrusions 43 are in the nanometer scale. The protrusions 43 are spread over the substrate 42 like an eye of a moth as shown in FIG. 8(a) and FIG. 8(b). Thus, as shown in FIG. 9(a) and FIG. 9(b), the refractive index at an interface between the air layer 20 and the moth-eye film 40 continuously changes (see Region II in FIG. 9(a) and FIG. 9(b)). In such a structure, incident light does not recognize the interface and thus mostly passes through the interface without reflecting on the interface.

The moth-eye film 40 can exert greater antireflection performance than conventional LR films and AR films as shown in FIG. 10, and can also achieve a super low reflectance (for example, minimum value of 0.05%) in entire visible light wavelength range. As compared to LR films and AR films, the moth-eye film 40 is less colored, and shows less change in the antireflection performance due to change in the observation direction.

The reflectance of the moth-eye film 40 can be determined not only by actual measurement but also by calculation. Examples of the measurement method include calculation based on the effective refractive index medium theory (effective medium theory). According to the theory, a submicron-scale structure is coarse grained and is considered as a medium having an average reflective index of the solute of space including the structure (such as solute forming the structure, or air). According to the theory, the moth-eye structure 41 can be considered as a multi-layered film consisting of a large number of films whose refractive indexes vary by gradation.

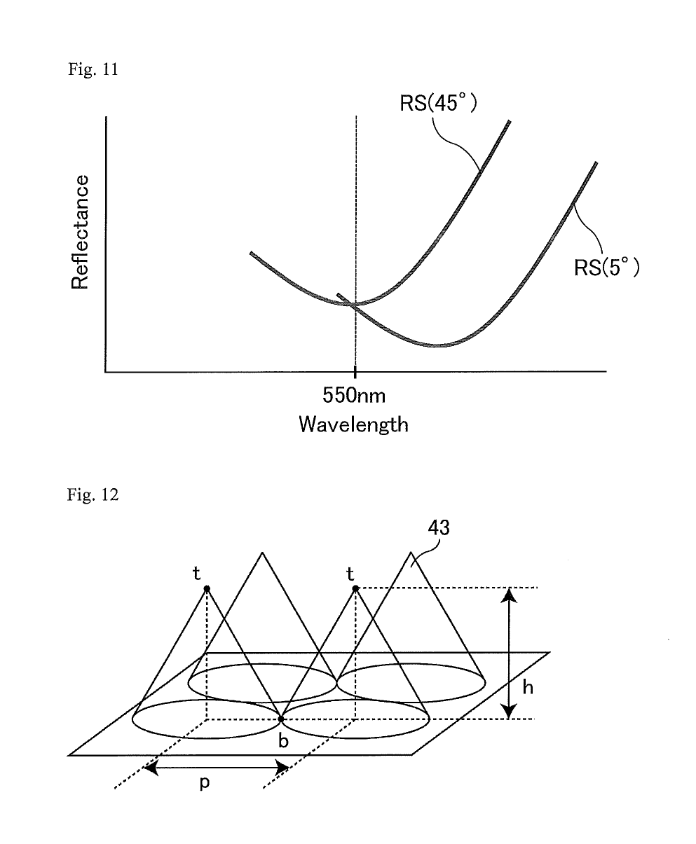

Although the moth-eye film 40 exerts excellent antireflection performance over the entire visible light range, the reflectance shows a little wavelength dependence due to insufficient heights and aspect ratios of the protrusions 43. Specifically, the reflection spectrum of the moth-eye structure 41 in a front direction (for example, reflection spectrum of 5-degree specular reflection RS (5°)) and the reflection spectrum in an oblique direction (for example, reflection spectrum of 45-degree specular reflection RS (45°)) each include at least one minimal value as shown in FIG. 11. If the measurement direction is changed from a front direction to an oblique direction, the reflection spectrum of the moth-eye structure 41 shifts to the short-wavelength side while increasing overall.

In this embodiment, a reflectance at at least one wavelength within a range of from 600 nm (preferably from 650 nm) to 780 nm is set to be smaller than a reflectance at a wavelength of 550 nm in the reflection spectrum of 5-degree specular reflection RS(5°). This setting enables to prevent the reflectance at a wavelength of 550 nm from increasing in the reflection spectrum in an oblique direction (e.g., reflection spectrum of 45-degree specular reflection RS (45°)), thereby preventing an increase in the Y value in an oblique direction. Accordingly, occurrence of interference fringes can be suppressed in observation of a screen from an oblique direction even when at least one of the display panel 10 and the front sheet 30 is warped.

Even if the reflection spectrum RS(5°) is set as above, the Y value in the moth-eye film 40 in a front direction does not extremely increase. Thus, occurrence of interference fringes in a front direction can also be suppressed.

As mentioned earlier, the conditions for this embodiment are set such that a low reflectance is achieved in as wide a viewing angle range as possible, not such that the best reflectance is achieved in a front direction.

Moth-eye films in which the heights and the aspect ratios of protrusions are sufficiently high have a reflectance with no wavelength dependence. Unfortunately, industrial production of such films is difficult.

In contrast, this embodiment, in which the heights and the aspect ratios of the protrusions 43 are not necessarily very high, can achieve both good productivity and an effect of suppressing the occurrence of interference fringes.

The specularly reflected light spectrum of the moth-eye film 40 depends on the pitch and height, especially height, of the moth-eye structure 41. Thus, the specularly reflected light spectrum of the moth-eye film 40 can be appropriately controlled by appropriately changing the pitch and height (especially height) of the moth-eye structure 41.

The reflection spectrum of LR films can be controlled. However, since LR films have high reflectance, occurrence of interference fringes cannot be suppressed even if the reflection spectrum is controlled.

As shown in FIG. 11, the reflection spectrum of 5-degree specular reflection RS(5°) of the moth-eye structure 41 preferably includes a minimal reflectance smaller than the reflectance at 550 nm within a wavelength range of 600 nm to 780 nm (preferably within a wavelength range of 650 nm to 780 nm). More preferably, the reflection spectrum monotonously decreases at a wavelength of from 550 nm to longer wavelengths, and includes a minimal reflectance smaller than the reflectance at 550 nm within a wavelength range of 600 nm to 780 nm (preferably within a wavelength range of 650 nm to 780 nm). The spectrum. RS(5°) may monotonously decrease within a wavelength range of 600 nm to 780 nm (preferably within a wavelength range of 650 nm to 780 nm).

For achieving ideal antireflection performance with no wavelength dependence, the heights of the protrusions 43 are preferably as high as possible in the nanometer scale, which unfortunately leads to lower industrial productivity. Thus, for achieving both good productivity and an effect of suppressing the occurrence of interference fringes, the moth-eye structure 41 preferably has a height of from 200 nm to 350 nm, and more preferably has a maximum height of not higher than 300 nm. A height of less than 200 nm may fail to achieve sufficient antireflection performance. All the protrusions 43 may or may not have the same height.

For achieving ideal antireflection performance with no wavelength dependence, the aspect ratios of the protrusions 43 are preferably as high as possible in the nanometer scale, which unfortunately leads to lower industrial productivity. Thus, for achieving both good productivity and an effect of suppressing the occurrence of interference fringes, the moth-eye structure 41 has an aspect ratio of preferably not more than 3, and more preferably not more than 2.5. A smaller aspect ratio does not negatively affect the antireflection performance in a front direction but may deteriorate the antireflection performance in an oblique direction. Thus, the moth-eye structure 41 preferably has an aspect ratio of not less than 0.5. All the protrusions 43 may or may not have the same aspect ratio.

The protrusions 43 may have any pitch that is not longer than the visible light wavelength. For improving the visibility of a screen of the display panel 10 from an oblique direction, the pitch of the moth-eye structure 41 is preferably not longer than 150 nm, and more preferably not longer than 120 nm. All the protrusions 43 may have the same pitch; namely, the protrusions 43 may be arranged at a fixed interval. For more surely and effectively achieving the above effects, or specifically, for preventing the visibility of the screen of the display panel 10 from being deteriorated by markedly strong diffracted light when the screen is observed from an oblique direction, the protrusions 43 preferably do not have the same pitch, namely the protrusions 43 are preferably irregularly arranged. More specifically, the moth-eye structure 41 preferably has a pitch randomness of from 25% to 350.

The moth-eye film 40 is not directly touched almost at all after a final product is completed. Thus, the moth-eye structure 41 does not necessarily have a high scratch resistance. Scratch resistance at about a level that endures handling during assembly is sufficient.

The protrusions 43 may have a variety of shapes. All the protrusions 43 may or may not have the same shape.

Examples of the horizontal cross sectional shape of the protrusions 43 include round, elliptical, triangular, quadlangular, and other polygonal shapes. Each protrusion 43 entirely has the same horizontal cross sectional shape, or different horizontal cross sectional shape depending on the position of the cross section. In view of employing a highly productive production method (described later) using a mold, preferably each protrusion 43 entirely has a round horizontal cross section.

A cross section of each protrusion 43 orthogonal to the main surface of the moth-eye film 40 (hereinafter, also referred to as orthogonal cross section) is in a sine-wave like, triangular, or trapezoidal shape or other shapes, for example. The apex of each protrusion 43 may be flat. Adjacent protrusions 43 may have a flat area between them. For improving the antireflection performance in the above cases, the flat area is preferably as small as possible. For similar purposes, the moth-eye structure 41 preferably includes no flat area.

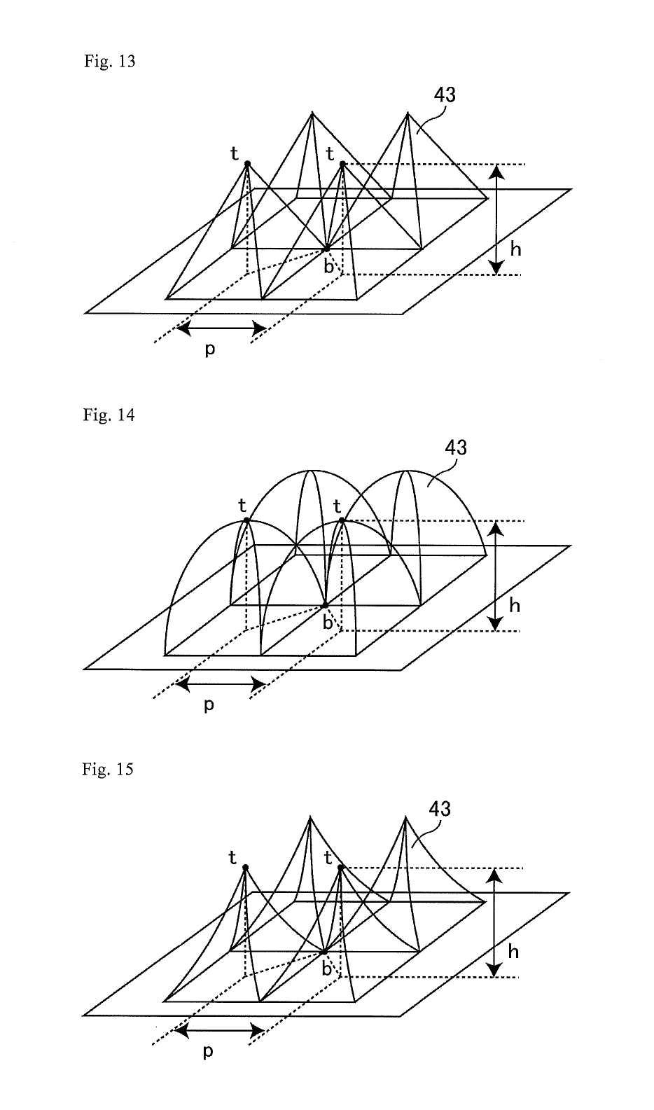

FIG. 12 to FIG. 15 show examples of more specific shapes of the protrusions 43. The protrusions 43 may be in a circular cone shape as shown in FIG. 12, in a quadrangular pyramid shape as shown in FIG. 13, in a dome-like (bell-like) shape including an outwardly curved side face between the apex to the bottom as shown in FIG. 14, or in a needle-like shape including steeply angled side faces between the apex to the bottom. Moreover, for example, the protrusions 43 may be in a circular or polygonal cone shape having steps in the side face(s).

As shown in FIG. 12 to FIG. 15, assuming that t represents the apex of each protrusion 43, the pitch p of the protrusions 43 is expressed by a distance between two points at which hypothetical perpendicular lines from adjacent apexes reach the same plane. The plane is parallel to the main surface of the moth-eye film 40. The height h of each protrusion 43 is expressed by a distance (shortest distance) from the apex t to a plane having a bottom point b at which the protrusion 43 contacts an adjacent protrusion 43.

For preventing the antireflection effect from being anisotropic, the protrusions 43 are preferably arranged in a dotted pattern as shown in FIG. 12 to FIG. 15, or may be linearly formed.

The substrate 42, which is integrally formed with the protrusions 43, supports the protrusions 43. Preferable examples of the material of the substrate 42 and the protrusions 43 include ultraviolet ray curable resins such as acrylate resin, and methacrylate resin.

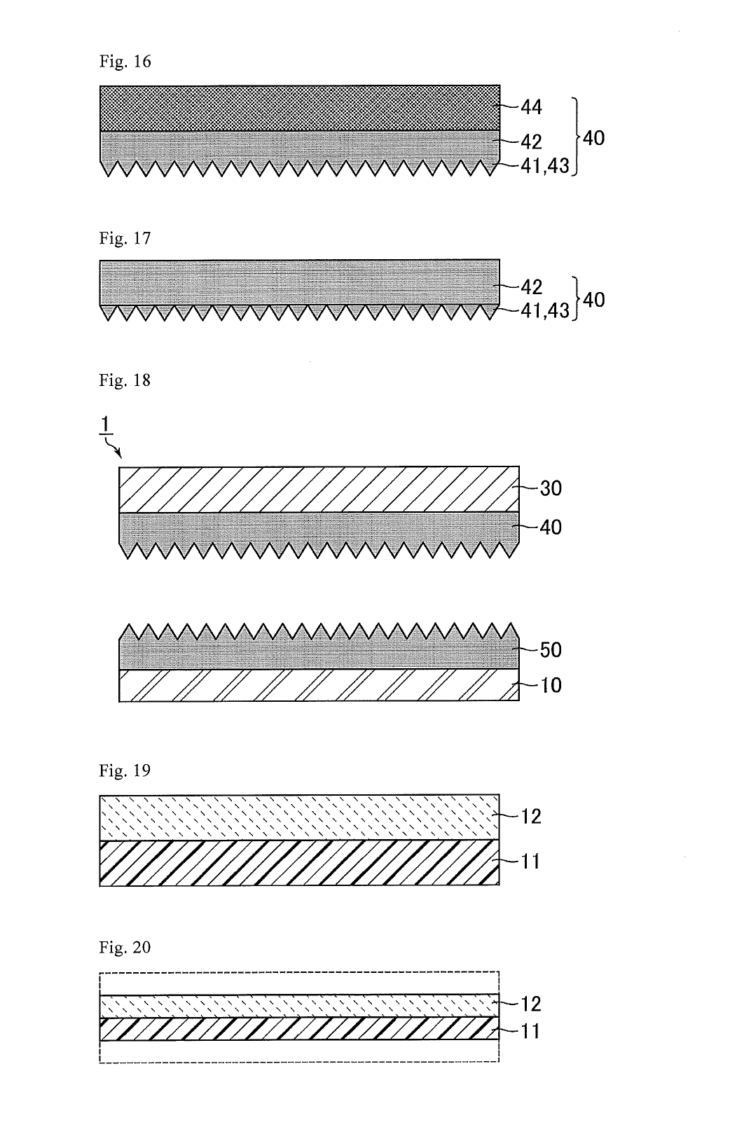

The moth-eye film 40 may include another substrate other than the substrate 42. For example, as shown in FIG. 16, the moth-eye film 40 may further include a substrate 44, such as a TAC film. The substrate 42 may be disposed on the substrate 44.

The refractive indexes of the protrusions 43 and a substrate such as the substrate 42 may be set appropriately, but are usually 1.3 to 1.8. The difference between the refractive index of the protrusions 43 and that of the substrate is preferably as small as possible, or more specifically the difference is preferably not more than 0.005, and more preferably not more than 0.002.

FIG. 1 shows the protrusions 43 integrated with the substrate 42. As shown in FIG. 17, the protrusions 43 may not be integrated with the substrate 42. In this case, the protrusions 43 may be separated from one another on the substrate 42.

The display device 1 may further include a moth-eye film 50 that is similar to the moth-eye film 40 as shown in FIG. 18. The moth-eye film 50 is attached to the front surface of the display panel 10. The moth-eye film 50 has a moth-eye structure in front of the moth-eye film 50, i.e., on a surface contacting the air layer 20, the moth-eye structure including many protrusions (protruded portions). This embodiment enables to more efficiently suppress the occurrence of interference fringes.

The features of the moth-eye film 50, such as characteristics of the reflection spectrum and the shapes of the protrusions, may be set appropriately. The moth-eye film 50 preferably has the features described in relation to the moth-eye film 40.

The moth-eye film 40 and the moth-eye film 50 may be attached to the front sheet 30 and the display panel 10, respectively, with an adhesive, preferably with a pressure sensitive adhesive. Use of a pressure sensitive adhesive enables detachment and reattachment of the films and easy change of the films.

The front sheet 30 may have any function, but preferably has a function of, for example, a touch panel, a protection sheet, a parallax barrier, or a component having these functions in combination.

The type of the touch panel may be appropriately selected. Examples of the touch panel include resistance film type, capacitive type, ultrasonic type, and electromagnetic induction type touch panels. Examples of the capacitive type touch panel include surface capacitive type and projection capacitive type touch panels. Resistance film type touch panels cost low. Surface capacitive type touch panels distinctively have high precision, high durability, and high sensitivity. Projection capacitive type touch panels are suitable for mobile devices, especially smart phones and tablet computers.

Non Patent Literature 2, which relates to touch panels, describes an example where a touch panel in a size of 40 inch has a surface deflection (warpage) of 1 mm or more. Thus, interference fringes are considered to occur in a conventional display device with a large touch panel. In contrast, the embodiment of the present invention can exert an effect of suppressing the occurrence of interference fringes regardless of the sizes of the display panel 10 and the front sheet 30.

Non Patent Literature 2 also describes the trend of using glass rather than plastic as a material of protection sheets for touch panels to produce thinner mobile phones with high quality sensation. It describes that use of chemically tempered glass is studied for enhancing the strength, presumably because plastic is vulnerable to scratches while glass is not. Patent Literature 2 describes that the glass for touch panels preferably has a Young's modulus of not less than 70 GPa. Moreover, glass for touch panels having a Young's modulus of 7300 kGf/mm², i.e., approximately 73 GPa (Trade Name: ULTRA FINE FLAT GLASS, produced by NSG Group) is available from the market. Patent Literature 1 describes that transparent substrates having fine irregularities thereon are preferably rigid, not flexible enough to be deformed by a pressure by pressing a touch panel. Moreover, glass plates having a Young's modulus of approximately 7100 kGf/mm² are known.

Thinner display devices are and will be continuously desired. Thinner substrates, such as substrates for touch panels and protection sheets for touch panels, may hardly maintain a Young's modulus of not less than 70 GPa. Moreover, scratch resistant plastic films are being developed. If plastic films are used instead of glass substrates, such films may hardly maintain a Young's modulus of not less than 70 GPa. In these cases, a rigidity enough to prevent deformation by pressing cannot be surely achieved. Examples of materials that can substitute for glass include polyethylene terephthalate (PET), polyethylene naphthalate (PEN), acrylic resin, and polycarbonate, among which PET and acrylic resin are preferred. Also, the following materials are known: PET films having a Young's modulus of approximately 55 kGf/mm², PET films having a Young's modulus of approximately 630 kGf/mm², PET monofilament having a Young's modulus of approximately 870 kGf/mm², and PET monofilament having a Young's modulus of approximately 1500 kGf/mm²; PEN films having a Young's modulus of approximately 63 kGf/mm², PEN films having a Young's modulus of approximately 740 kGf/mm², and PEN monofilament having a Young's modulus of approximately 2400 kGf/mm²; acrylic plates having a Young's modulus of approximately 340 kGf/mm²; and polycarbonate plates having a Young's modulus of approximately 210 kGf/mm².

The display device 1 of the present embodiment, which can exert an effect of suppressing the occurrence of interference fringes regardless of the rigidity of the front sheet 30, can greatly contribute to the aforementioned circumstances.

Specifically, the front sheet 30 may include a component (usually, an insulating substrate or an insulating film facing the entire display region of the display panel 10) which deforms with the moth-eye film 40 upon deformation of the moth-eye film 40. The deformable component may have a Young's modulus of less than 70 GPa. This structure can also sufficiently exert an effect of suppressing the occurrence of interference fringes.

FIG. 1 shows the front sheet 30 which entirely deforms with the moth-eye film 40. If, for example, the front sheet 30 is a resistance film type touch panel which includes an insulating substrate provided with a transparent conductive film and a flexible film disposed over the insulating substrate with an air layer interposed therebetween, the insulating substrate deforms with the moth-eye film 40, whereas the flexible film does not deform with the moth-eye film 40. In the case of the aforementioned front sheet 30 including a buffer layer such as an air layer, a component (part of the front sheet) between the buffer layer of the front sheet 30 and the air layer 20 deforms with the moth-eye film 40.

The display panel 10 may be of any type, and examples thereof include liquid crystal panels, organic EL panels, inorganic EL panels, and PDPs.

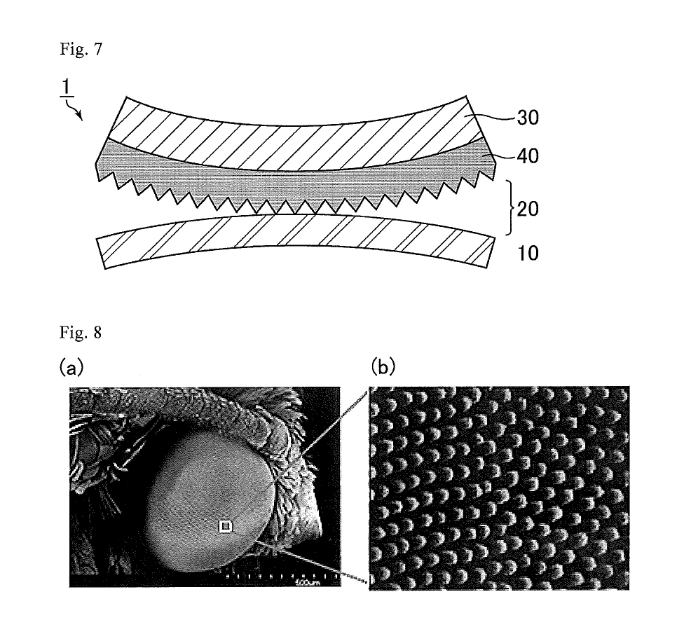

If the display panel 10 is a liquid crystal panel, a pair of substrates 11 and 12 each having a thickness of 0.7 mm are assembled to form a liquid crystal cell as shown in FIG. 19, and then the substrates 11 and 12 are etched to make them thinner. The thickness of each of the thinned substrates 11 and 12 is usually controlled to be 0.5 mm. After a liquid crystal panel is produced through steps, such as a step of attaching a polarizer and an optical film (viewing angle compensation film) and a step of mounting a driver, the liquid crystal panel is combined with a back light unit using a bezel to thereby produce a liquid crystal module. In the liquid crystal module, the edge (usually edge on four sides) is pressed down to the back light unit by the bezel. Then, the liquid crystal module is assembled into a housing and is combined with the front sheet 30. If each of the thinned substrates has a thickness of 0.5 mm, the liquid crystal panel does not almost at all warp even when it is incorporated in the liquid crystal module. In contrast, if the thickness of the substrates 11 and 12 is reduced to less than 0.5 mm (for example not more than 0.3 mm), the liquid crystal panel incorporated in the liquid crystal module is highly likely warped, leading to a risk of external projection of a central portion of the liquid crystal panel. As a result, the air layer 20 is highly likely to have an uneven thickness as shown in FIG. 3, FIG. 4, FIG. 6, and FIG. 7. Thus, in the case of using a liquid crystal panel that includes a pair of substrates each having a thickness of less than 0.5 mm (for example, not more than 0.3 mm) as the display panel 10, a greater effect of suppressing occurrence of interference fringes can be achieved.

The air layer 20 provides a space for deformation of the front sheet 30 when external force is applied to the front sheet 30. Deformation of the front sheet 30 disperses and absorbs external force, and thus the display panel 10 is protected.

The air layer 20 may have any thickness of not more than 50 μm. The thickness may be appropriately set depending on the purpose of use of the present embodiment and may be not more than 10 μm. The air layer 20 having such a thickness enables to more effectively suppress the occurrence of interference fringes. In the case of the air layer 20 having a thickness of more than 100 μm, basically interference fringes do not occur. The air layer 20 may have a thickness of not less than 10 μm, considering that the tolerance of the total thickness of the polarizer, optical film, and liquid crystal cell is not more than 10 μm in the liquid crystal display device.

The moth-eye structure may be formed by any method in the present embodiment. In view of the productivity and cost, a preferable method includes preparing a mold and transferring the shape of the mold. A method using a mold with an anodized aluminum layer (hereinafter, also referred to as a porous alumina mold) is particularly preferable. The following describes a method of producing the moth-eye film 40 or 50 using a porous alumina mold.

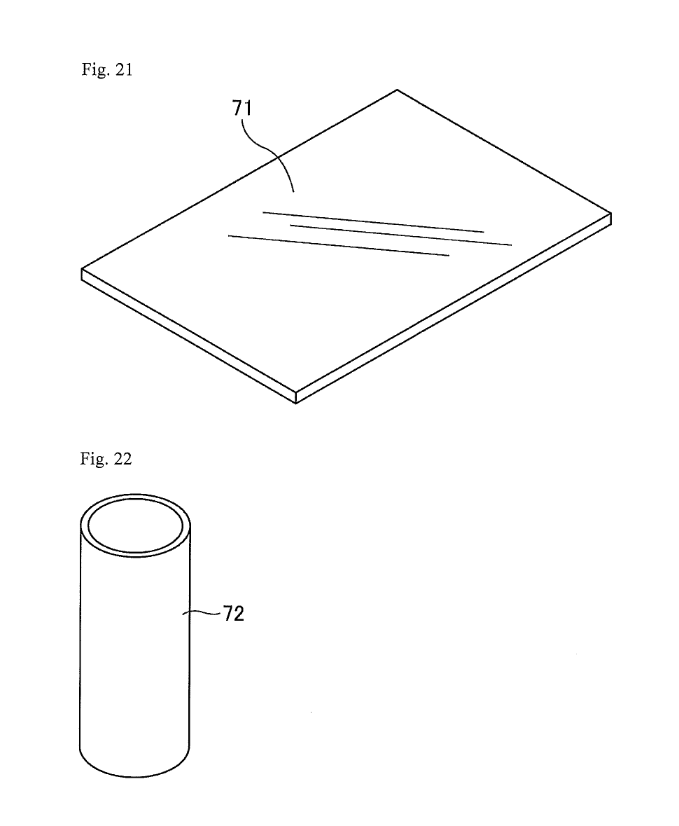

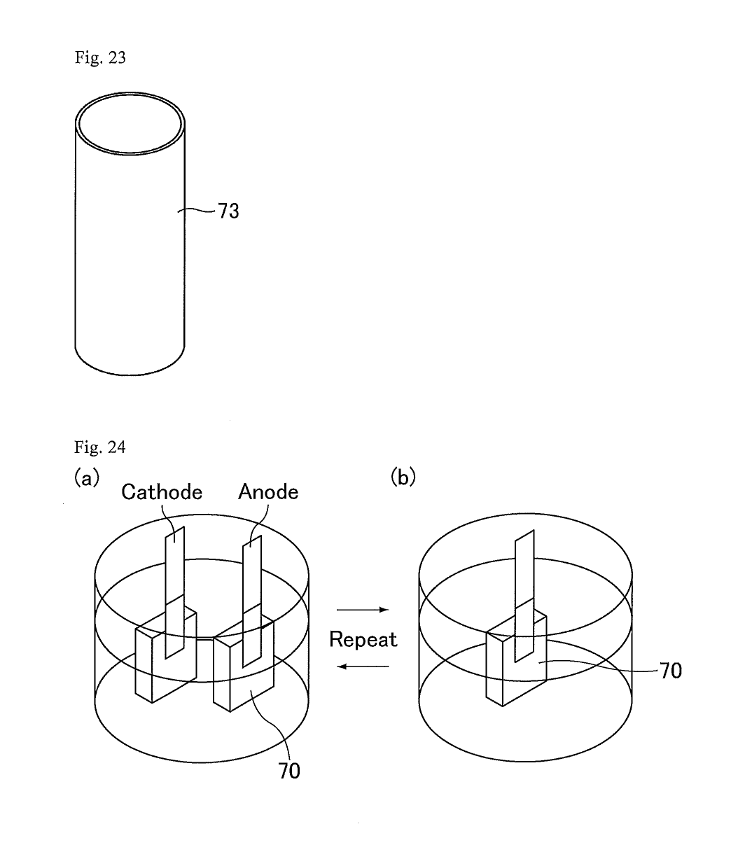

First, a substrate 70 is prepared. The substrate 70 has two types, a flat plate and a seamless roll. A glass plate 71 having a size of 1.6 m×1 m×2.8 mm (thickness) as shown in FIG. 21 is used as the flat plate. An aluminum pipe 72 having a size of 1.6 m×300 φ×15 mm (thickness) as shown in FIG. 22 or an electrodeposited sleeve 73 having a size of 1.55 m×300 φ×0.15 mm (thickness) as shown in FIG. 23 is used as the seamless roll. The electrodeposited sleeve 73 is prepared by forming an insulating coating on the surface of a nickel roll by electrodeposition. The aforementioned sizes are merely examples, and may be changed appropriately.

Then, an aluminum film having a thickness of approximately 0.5 μm to 2 μm is formed by sputtering on the surface of the glass plate 71 or the electrodeposited sleeve 73.

Next, anodic oxidation and etching treatment are repeatedly performed on the substrate 70 as shown in FIG. 24 (a) and FIG. 24 (b). The substrate 70 undergoes anodic oxidation five times in a 0.03 wt % oxalic acid solution having a temperature of 5° C. and etching treatment four times in a 1 mol/L phosphoric acid solution having a temperature of 30° C. The substrate 70 is washed with water between the anodic oxidation and the etching treatment to avoid mixing of the solutions used. Accordingly, an anodized layer with a large number of fine pores is formed on the surface of the substrate 70.

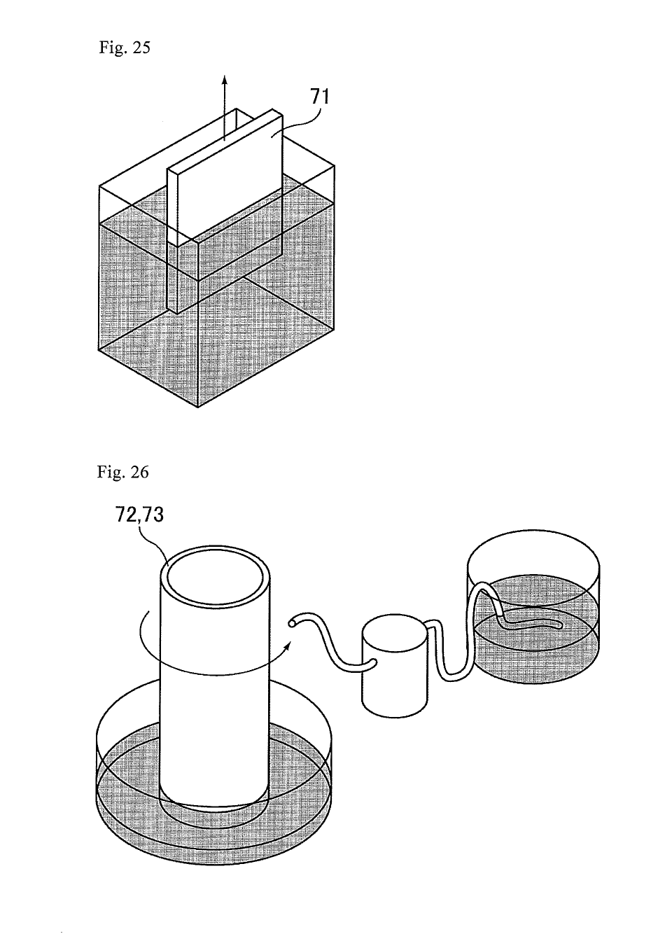

Thereafter, a mold release agent is applied to the substrate 70. In the case of the glass plate 71, it is immersed in a mold release agent as shown in FIG. 25. In the case of the aluminum pipe 72 or the electrodeposited sleeve 73, a mold release agent is poured with a hose over the aluminum pipe 72 or the electrodeposited sleeve 73, which is rotated, as shown in FIG. 26. OPTOOL DSX (produced by Daikin Industries Ltd.) is used as the mold release agent. OPTOOL DSX is diluted with hydrofluoroether to have a concentration of 0.1 wt %. Too high a concentration of OPTOOL DSX, e.g., not less than 0.5 wt %, tends to result in uneven application. The mold release agent is air dried by allowing it to stand for one day to be fixed. After the fixing, hydrofluoroether (HFE) is continuously poured with a hose over the substrate 70 for 10 minutes for rinsing.

A porous alumina mold having an inverted shape of the moth-eye structure is completed through the above steps. The mold is used for a shape transfer process.

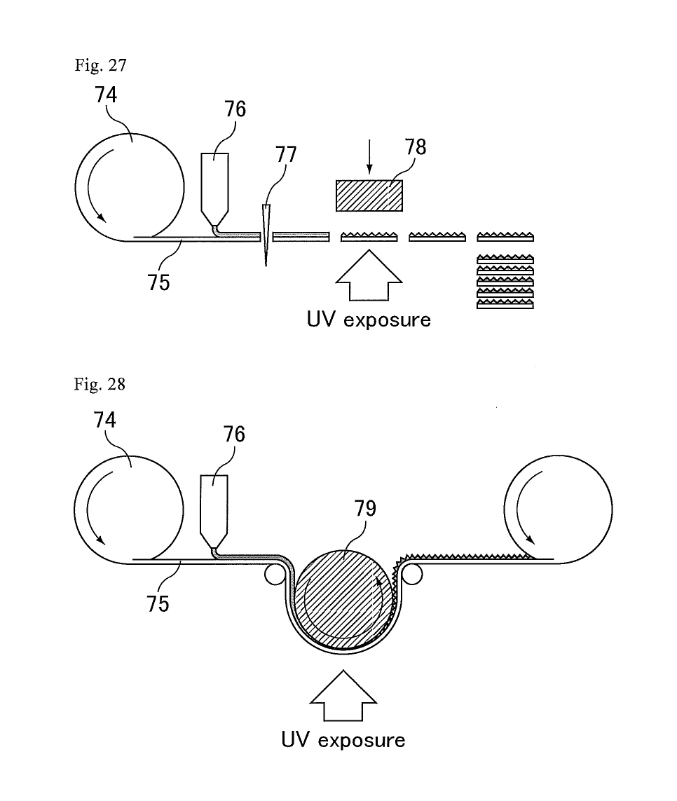

In the case of the glass plate 71, as shown in FIG. 27, a substrate film 75 (e.g., a TAC film) is pulled out from a film roll 74 which is a roll of the substrate film 75. An ultraviolet ray curable resin is applied to the substrate film 75 with a die coater 76. The substrate film 75 with the resin is cut in a predetermined size with a cutter 77. Next, an embossing device 78 including the porous alumina mold is pressed to the resin. The mold, the resin, and the substrate film 75 closely adhered together are irradiated with ultraviolet rays from under the substrate film 75 to cure the resin. Thereafter, a laminate of the cured resin and the substrate film 75 is released from the mold. In this manner, conical shapes are transferred on the surface of the cured resin so that conical protrusions are formed. The completed films are sequentially laminated.

In the case of the aluminum pipe 72 or the electrodeposited sleeve 73, as shown in FIG. 28, the substrate film 75 is pulled out from the film roll 74, and then an ultraviolet ray curable resin is applied to the substrate film 75 with the die coater 76. Next, an embossing device 79 including the porous alumina mold is pressed to the resin. The mold, the resin, and the substrate film 75 closely adhered together are irradiated with ultraviolet rays from under the substrate film 75 to cure the resin. Thereafter, a laminate of the cured resin and the substrate film 75 is released from the mold. In this manner, conical shapes are transferred on the surface of the cured resin so that conical protrusions are formed. The completed film is rolled up.

The moth-eye structure having an aspect ratio of more than 3 would easily cause clogging of the resin in the porous alumina mold, breaking of the substrate film 75, and peeling of the anodized layer.

For preventing the clogging of the resin, a mold release agent is preferably added to the ultraviolet ray curable resin. A mold release agent usually acts as a foaming agent. Thus, a defoaming agent is preferably added together with a mold release agent if added.

Regarding the moth-eye structure having a higher aspect ratio, the temperature of the resin and the pressure for pressing the embossing device are preferably as high as possible in order to prevent foam generation in the resin.

### (Evaluation Test 1)

According to the above method, 14 kinds of moth-eye films (films 1 to 14) were actually produced using a glass plate as a substrate under conditions shown in Table 1. The porous alumina molds used for the films 1 to 14 were produced under different conditions, specifically, different voltages between anode and cathode (hereinafter, also referred to simply as voltage) during the anode oxidation treatment, different times for the anode oxidation treatment (AO time), and different etching times. A TAC film having a thickness of 80 μm was used as a substrate film. The ultraviolet ray curable resin was controlled to have a thickness of 8 μm upon application.

TABLE 1

| Film | Voltage | AO time | Etching | Depth D | Pitch P | Height H |
|---|---|---|---|---|---|---|
| No. | (V) | (sec) | time (min) | (nm) | (nm) | (nm) |
| 1 | 35 | 290 | 15 | 265 | 85 | 140 |
| 2 | 35 | 350 | 15 | 320 | 85 | 170 |
| 3 | 35 | 336 | 11.1 | 350 | 85 | 230 |
| 4 | 45 | 140 | 16.25 | 300 | 115 | 165 |
| 5 | 45 | 160 | 16.25 | 340 | 115 | 185 |
| 6 | 45 | 180 | 16.25 | 370 | 115 | 205 |
| 7 | 45 | 200 | 16.25 | 410 | 115 | 225 |
| 8 | 45 | 240 | 16.25 | 470 | 115 | 260 |
| 9 | 45 | 300 | 16.25 | 570 | 115 | 315 |
| 10 | 45 | 360 | 16.25 | 655 | 115 | 360 |
| 11 | 45 | 420 | 16.25 | 720 | 115 | 400 |
| 12 | 80 | 25 | 25 | 340 | 190 | 190 |
| 13 | 80 | 35 | 25 | 500 | 190 | 280 |
| 14 | 80 | 55 | 25 | 800 | 190 | 450 |

The depth D of the pores of the porous alumina mold is an average value of the depths of any 10 pores in an SEM photograph of a cross section (a face orthogonal to the main face) of the mold.

The height H of the moth-eye structure is an average value of the heights of any 10 protrusions in an SEM photograph of a cross section (a face orthogonal to the main face) of the moth-eye film.

The pitch P of the moth-eye structure is an average value of the pitches of any 10 pairs of pores in an SEM photograph of a cross section (a face orthogonal to the main face) of the mold.

The pitch of the moth-eye structure usually depends on the voltage during the anode oxidation treatment. This test gave a similar result. A higher voltage led to a longer pitch of the moth-eye structure.

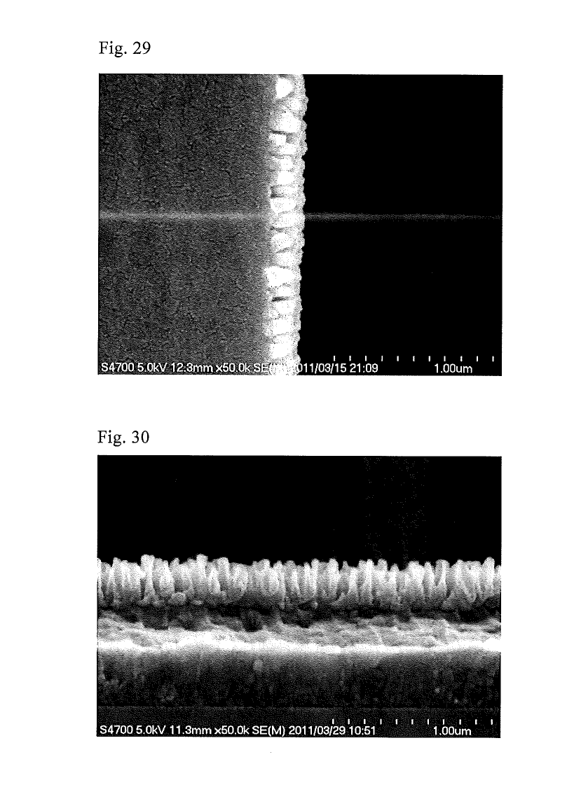

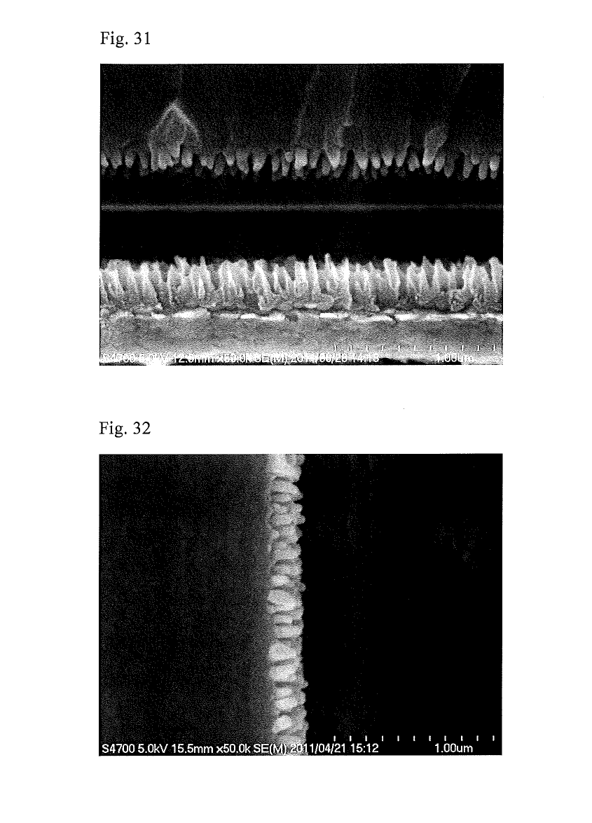

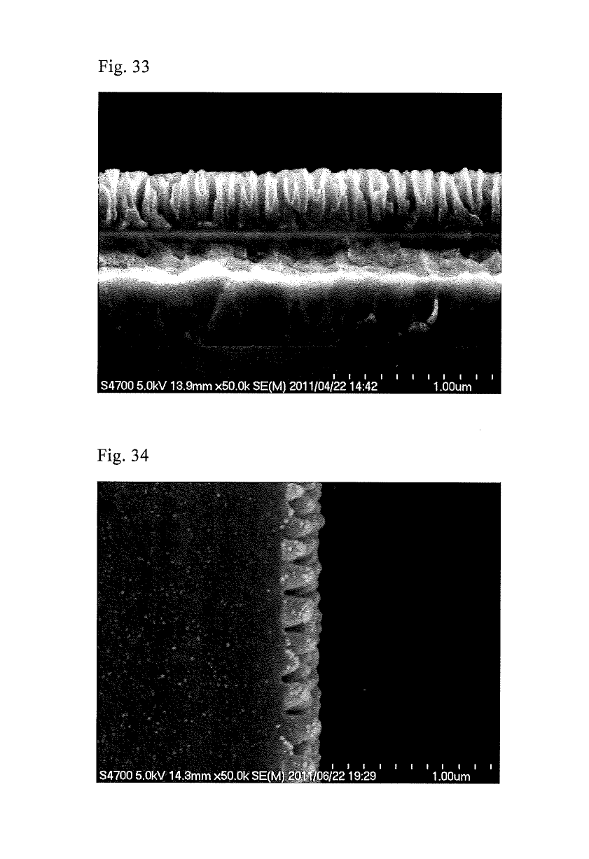

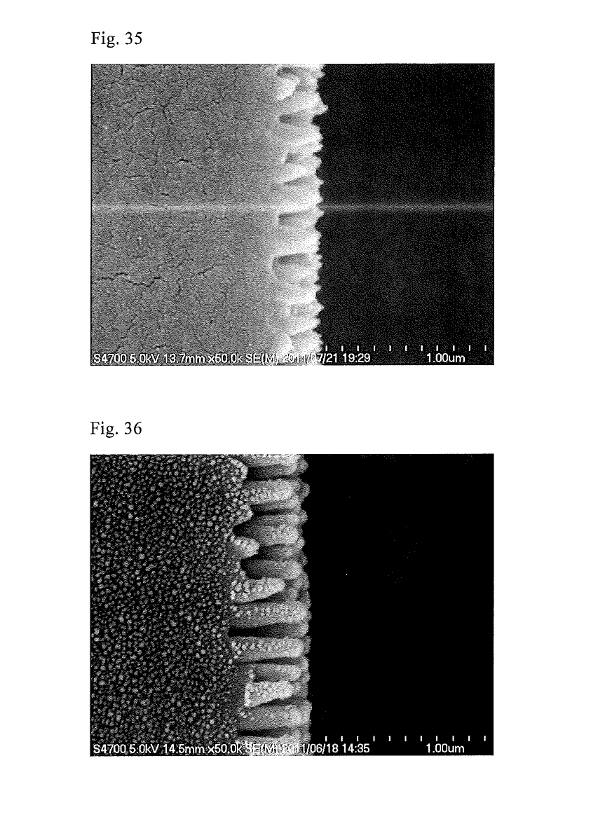

FIG. 29 is an SEM photograph of a cross section of the film 1. FIG. 30 is an SEM photograph of the mold for the film 1. FIG. 31 is an SEM photograph of cross sections of the film 2 and the mold for the film 2. FIG. 32 is an SEM photograph of a cross section of the film 3. FIG. 33 is an SEM photograph of the mold for the film 3. FIG. 34 is an SEM photograph of a cross section of the film 12. FIG. 35 is an SEM photograph of a cross section of the film 13. FIG. 36 is an SEM photograph of a cross section of the film 14.

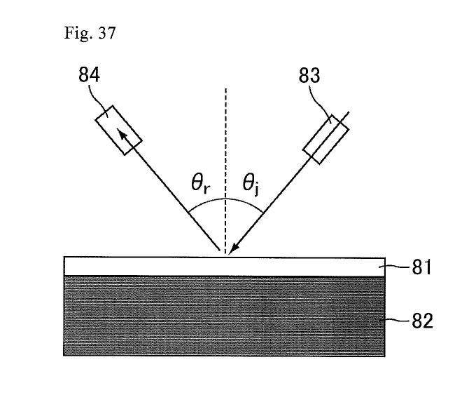

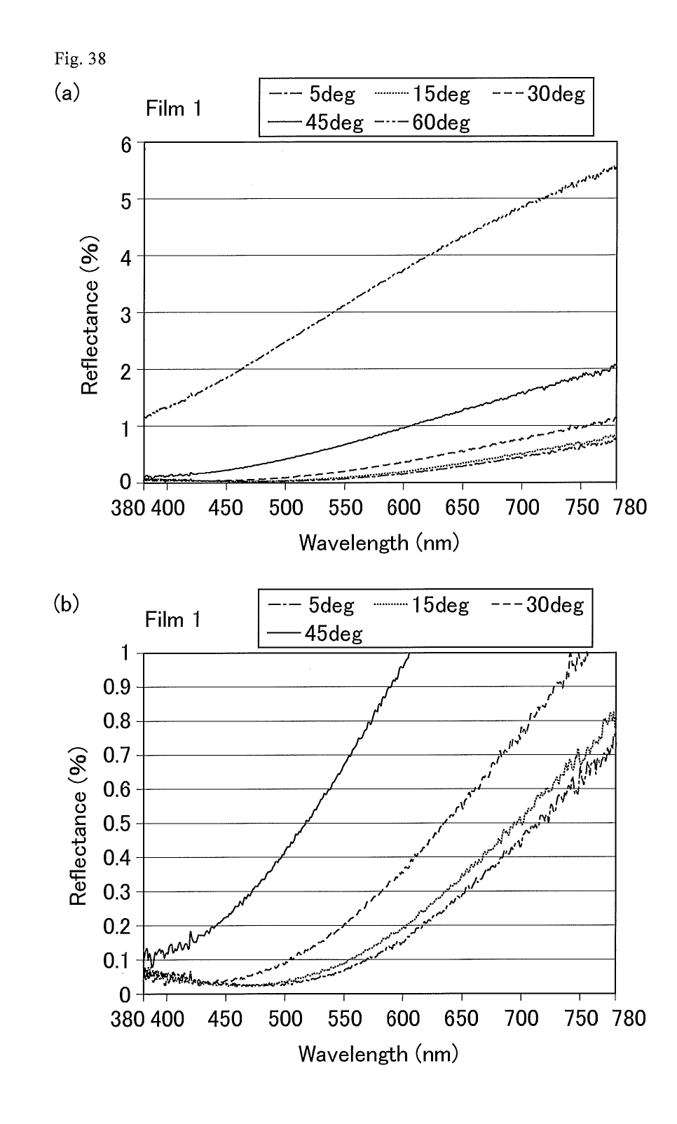

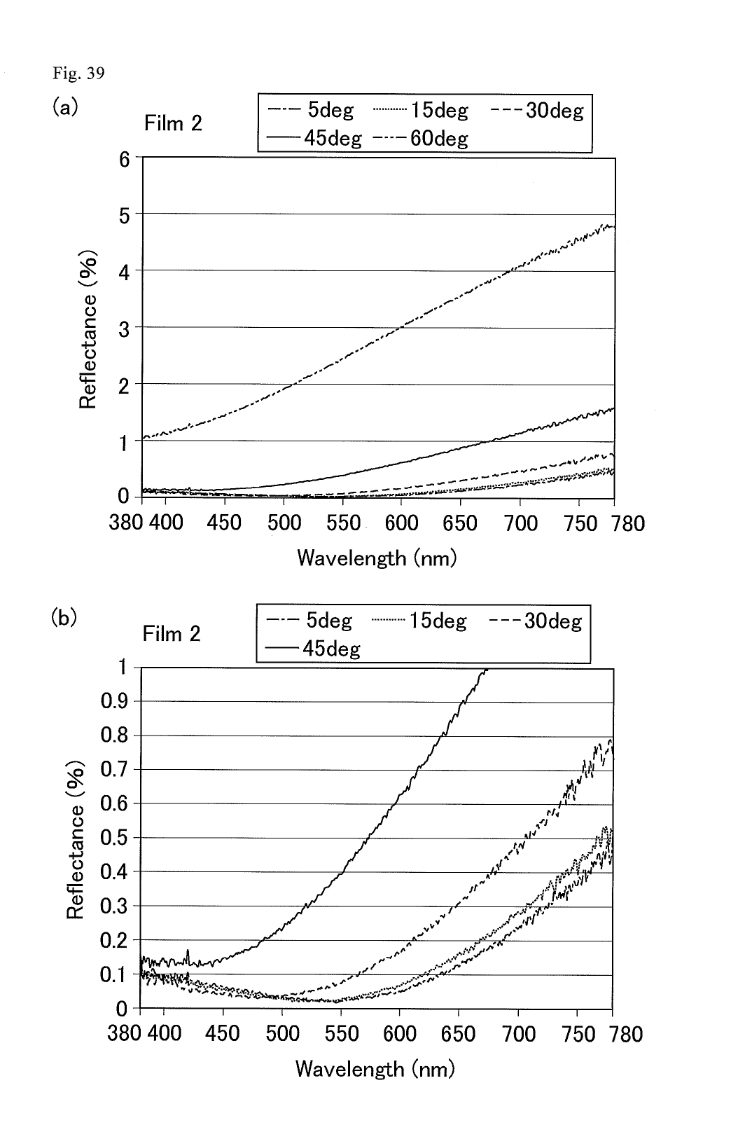

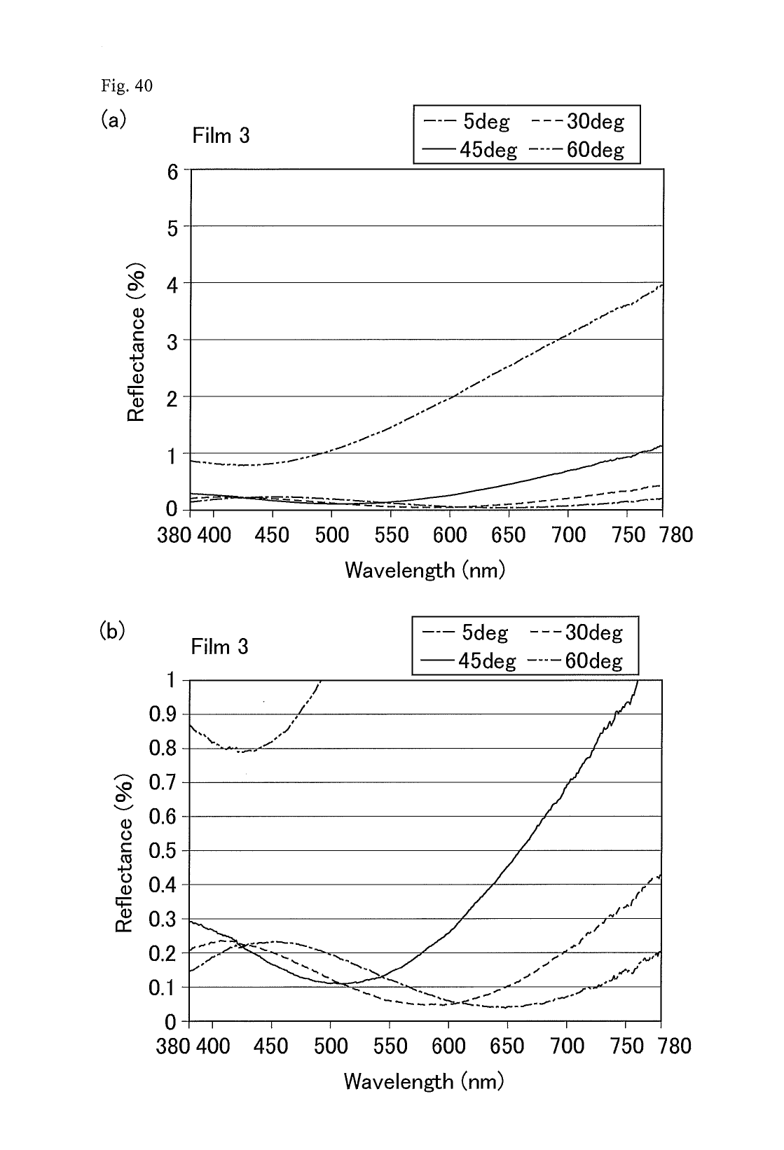

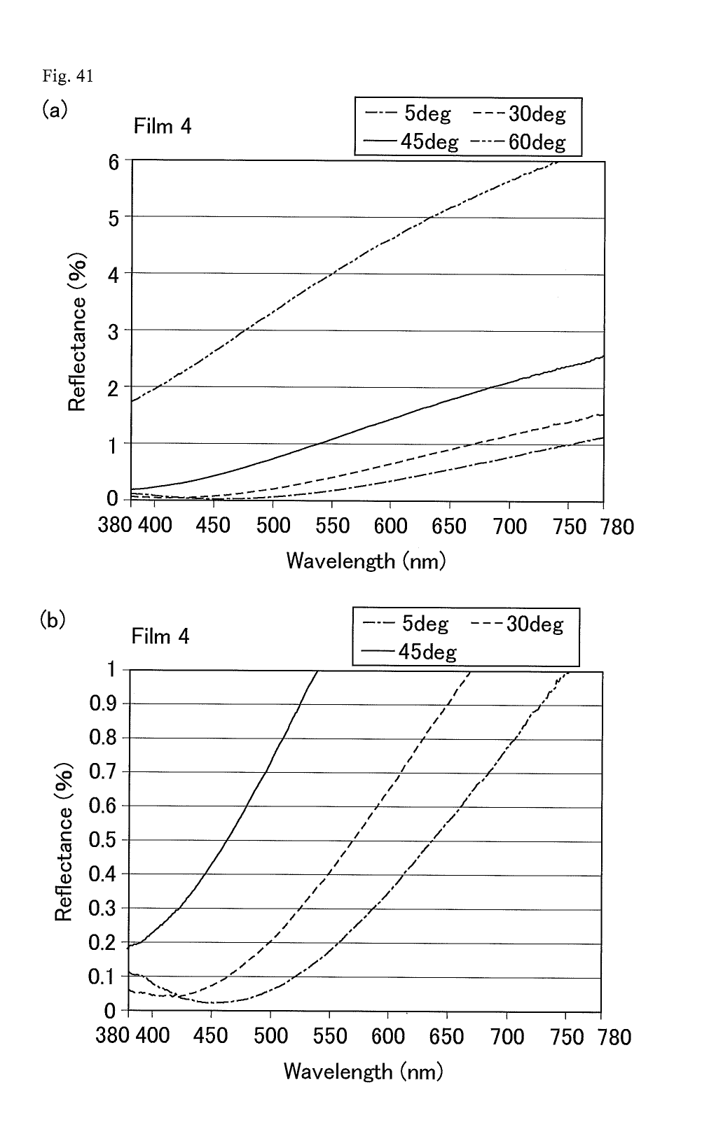

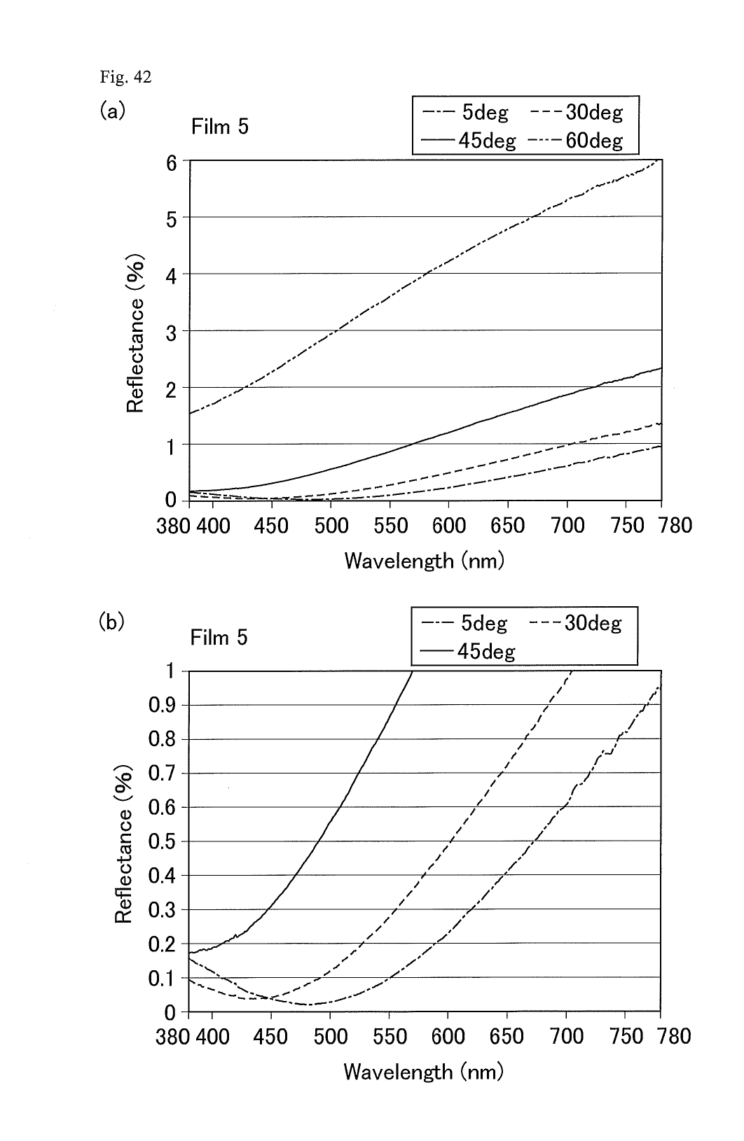

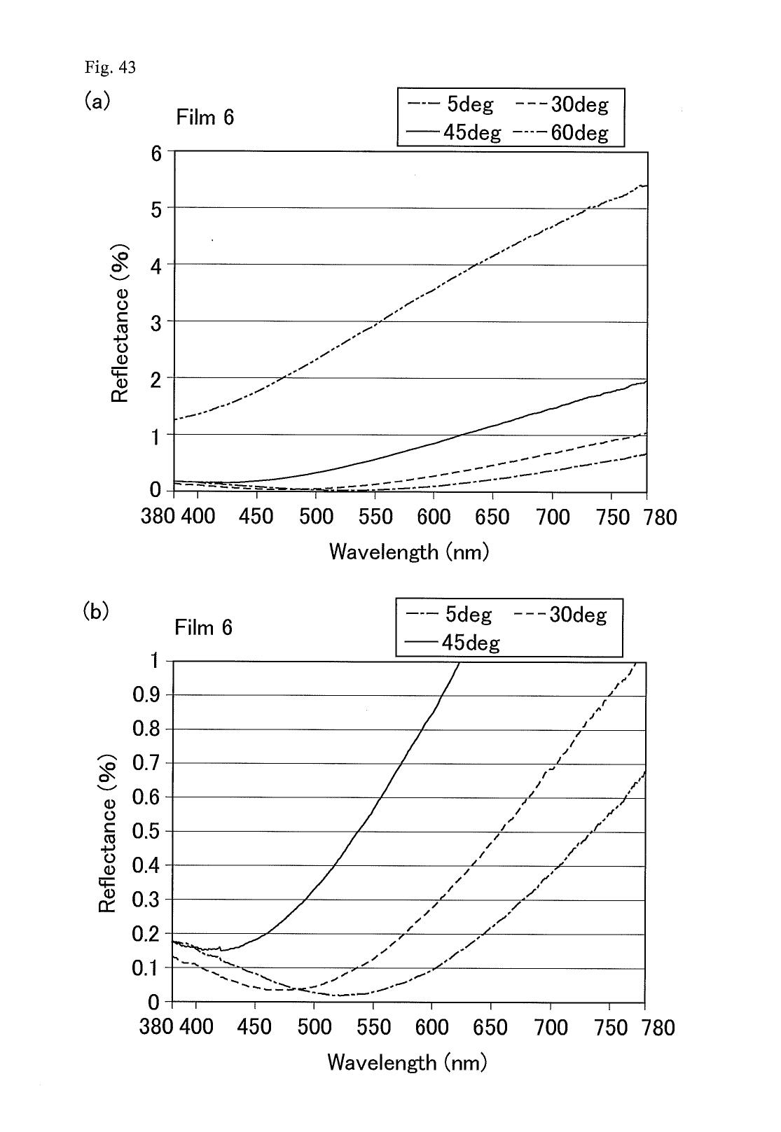

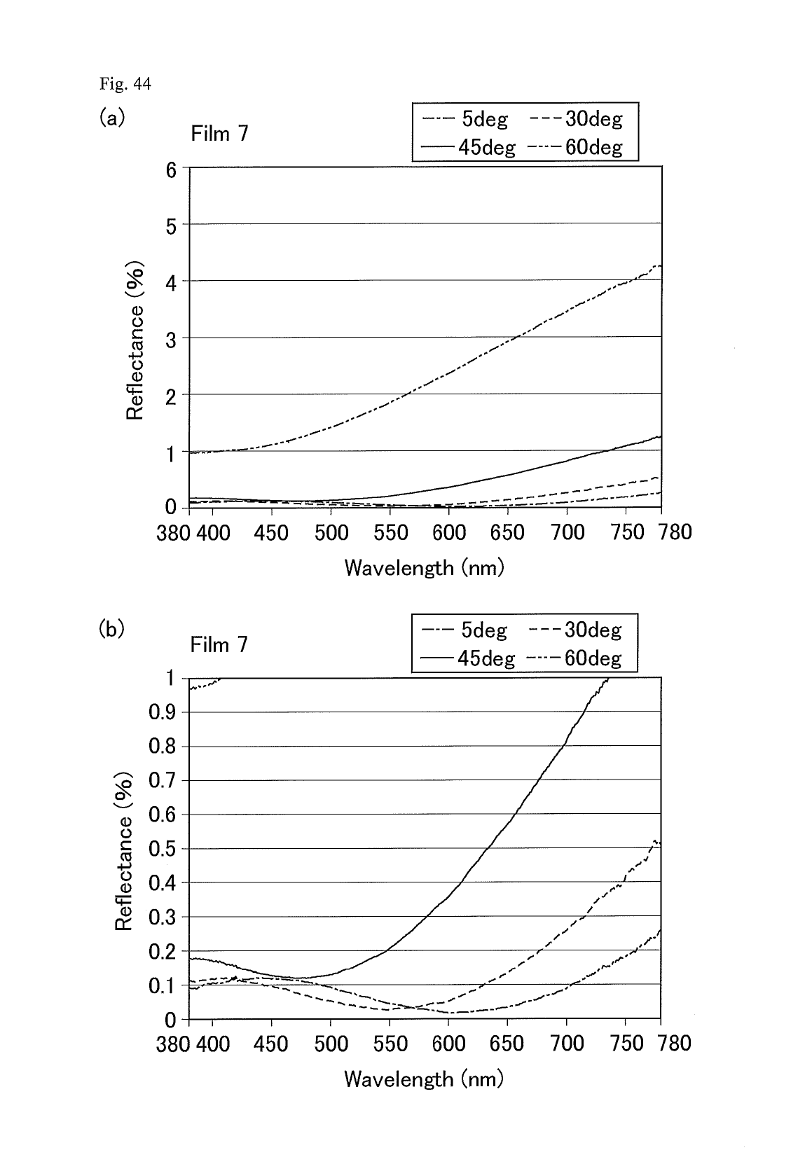

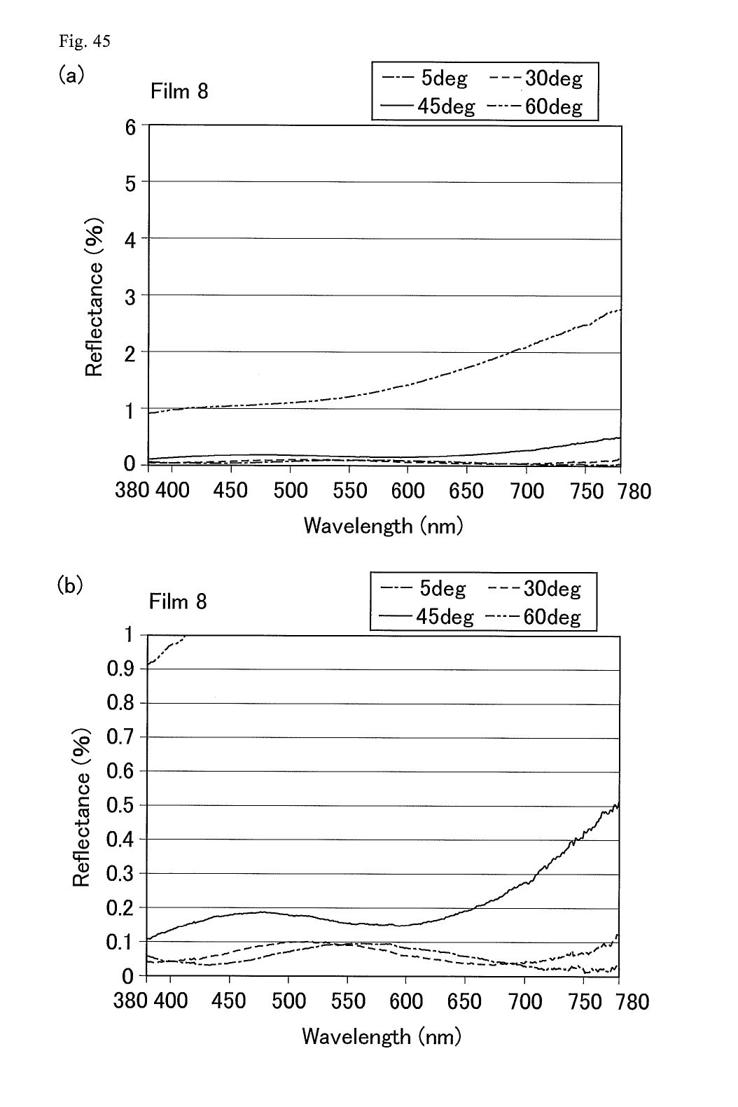

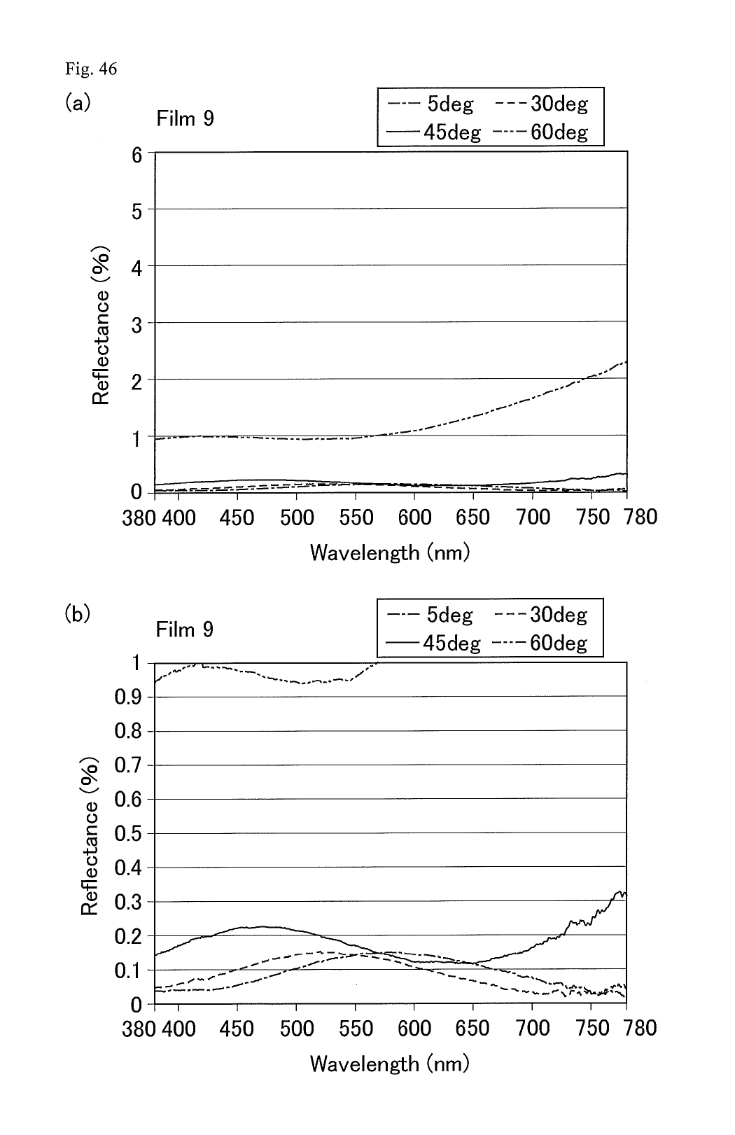

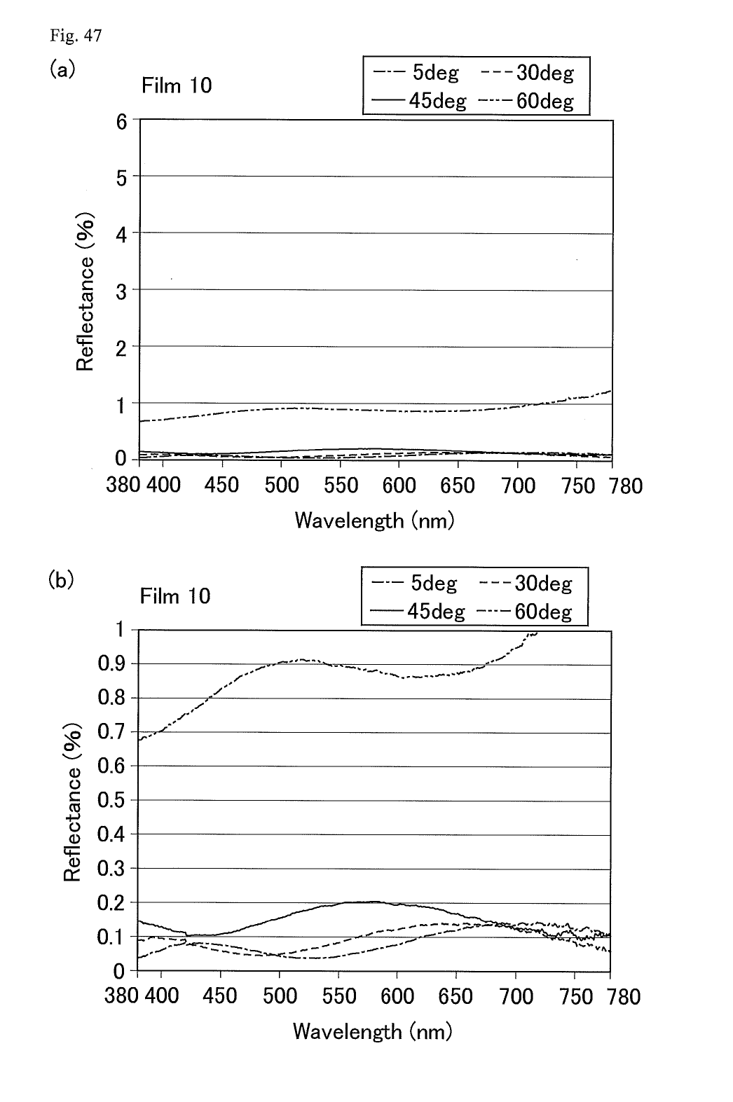

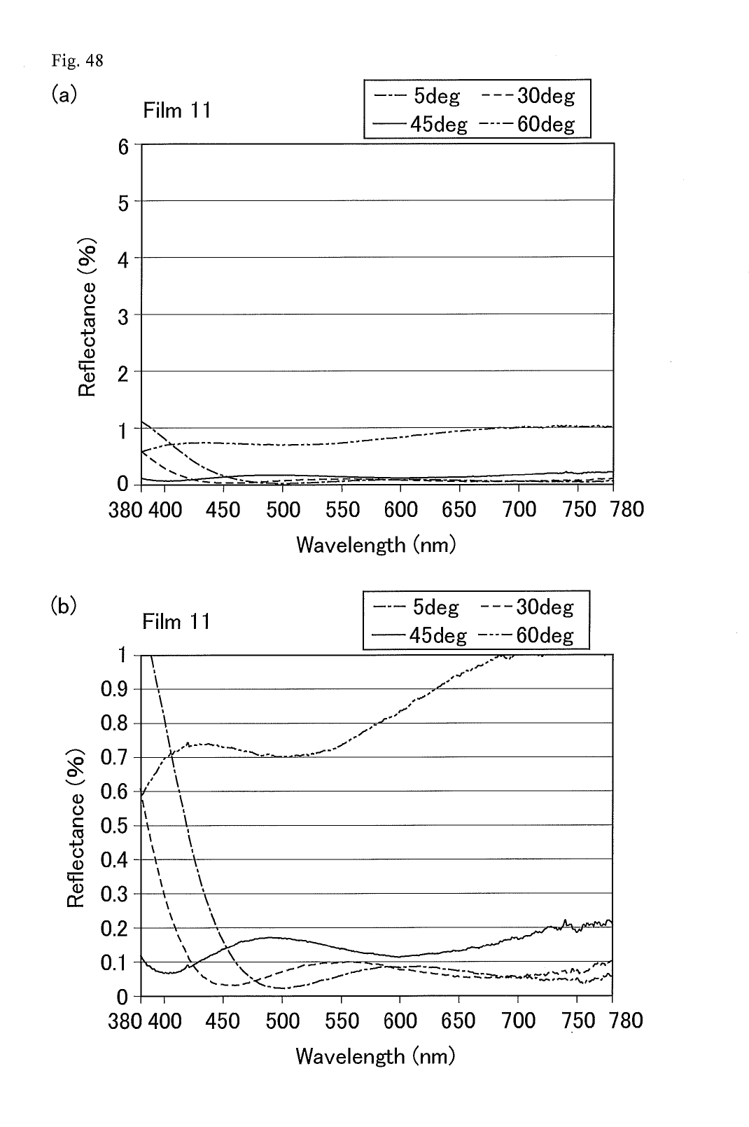

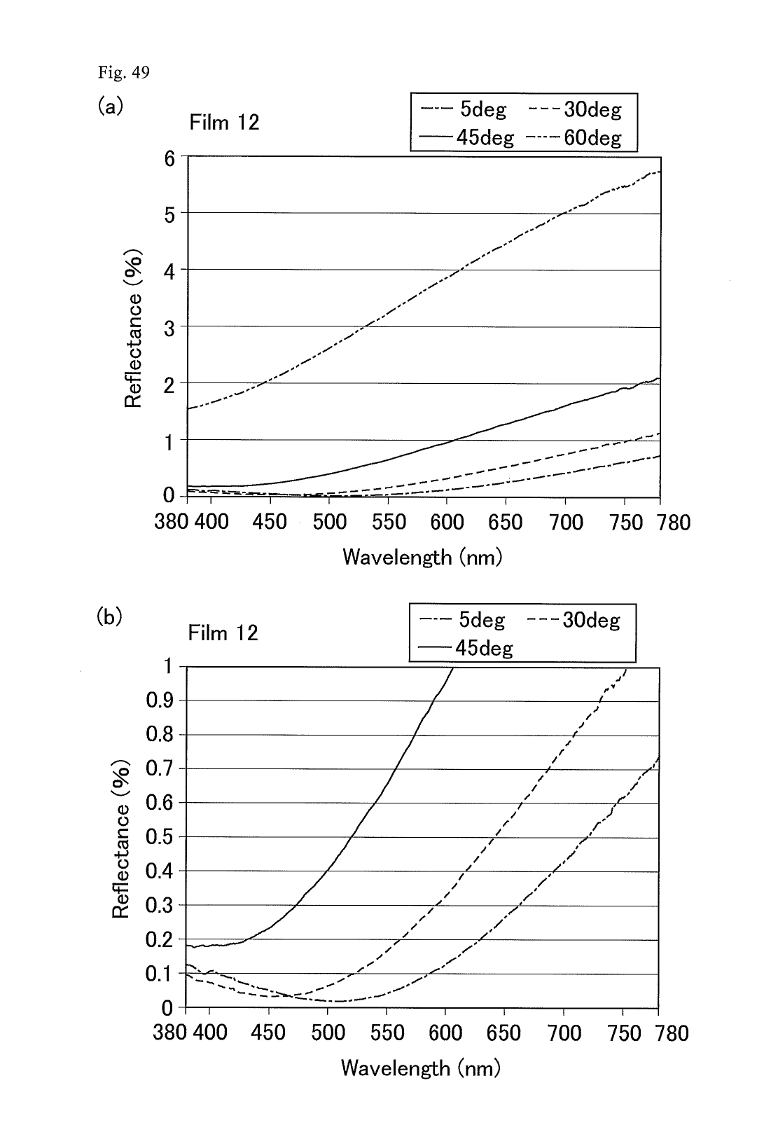

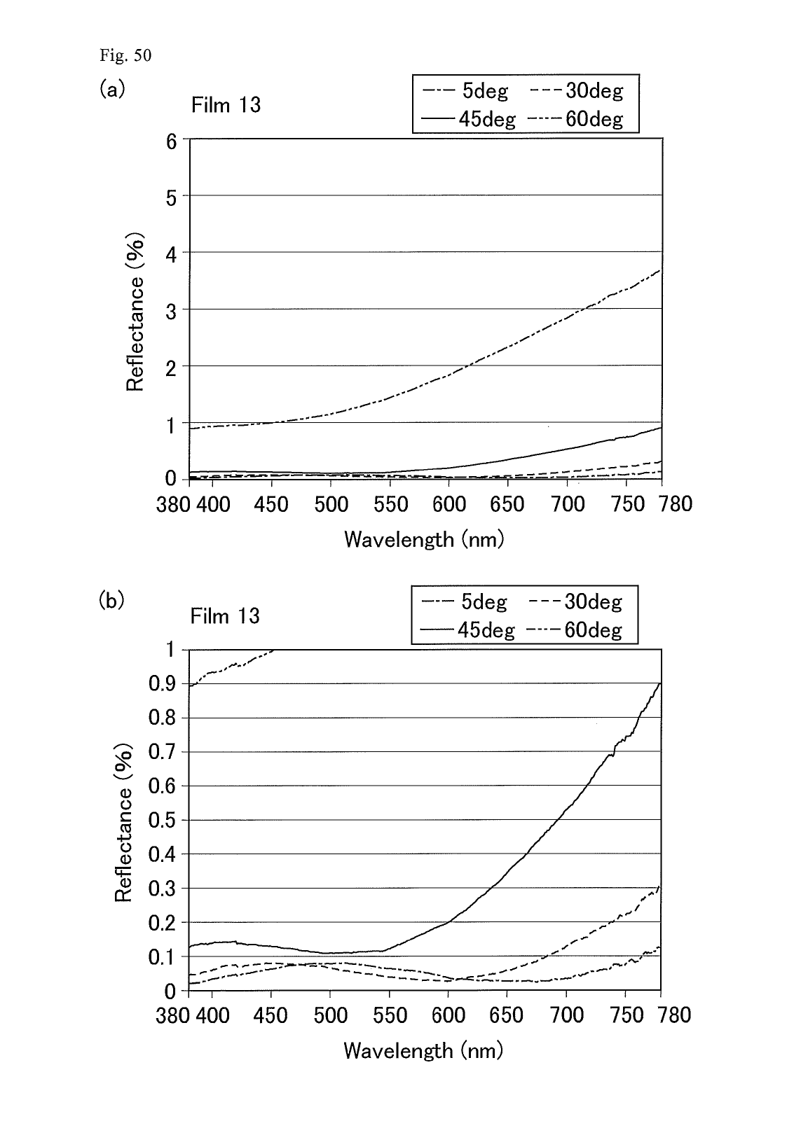

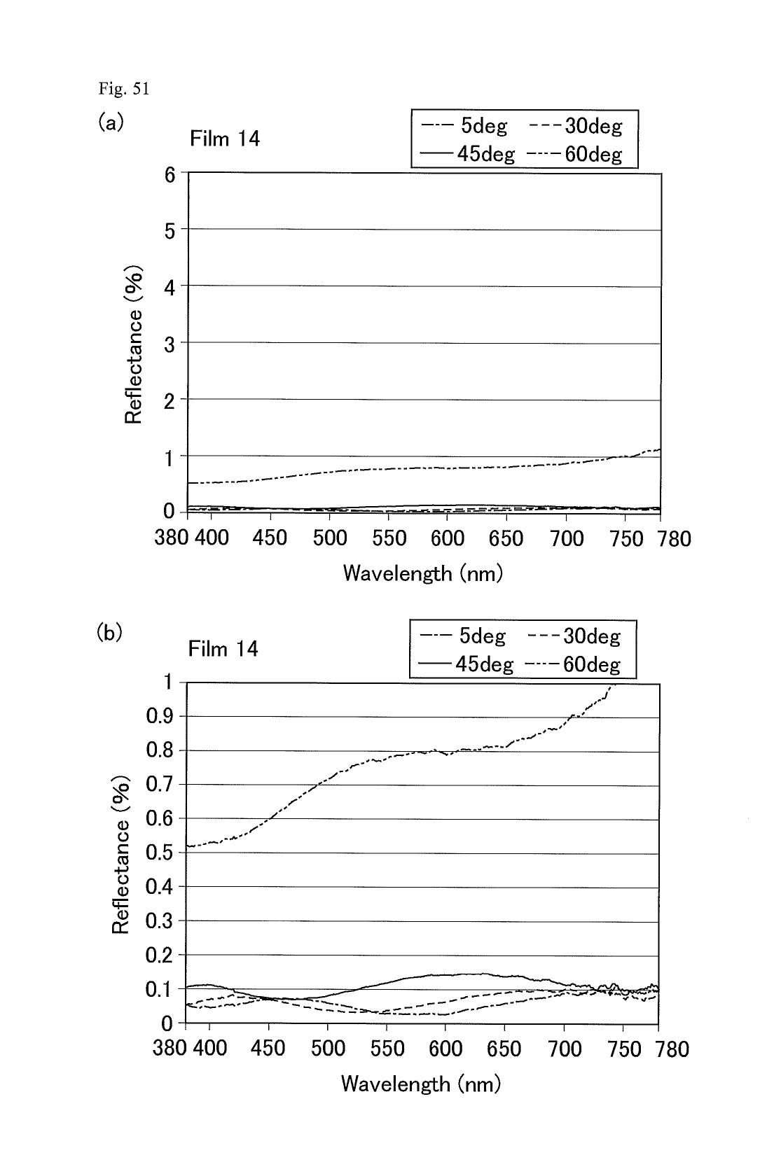

Next, 14 samples were prepared from the films 1 to 14. The specularly reflected light spectra of the films 1 to 14 were measured using these samples. As shown in FIG. 37, each sample was produced by attaching a moth-eye film 81 (one of the films 1 to 14) to a black acrylic plate 82 via an adhesive layer (not shown) having a thickness of 20 μm. An ultraviolet-visible spectrophotometer V-550 (produced by Jasco Corporation) was used for the measurement. The spectrophotometer includes a light projecting section 83 and a light receiving section 84 as shown in FIG. 37. Light (incident light) is emitted from the light projecting section 83 to the surface of a sample. The light receiving section 84 is disposed in a travelling direction of light (specularly reflected light) specularly reflected on the surface of the sample. Measurement angles (=reflection angle θᵣ=incident angle θᵢ) are the following five angles: 5 degrees, 15 degrees, 30 degrees, 45 degrees, and 60 degrees. FIG. 38 to FIG. 51 show the results. Table 2 to Table 15 show the reflectances at typical wavelengths.

Table 2 shows the result of the film 1.

TABLE 2

| Wavelength | Reflectance (%) | | | | |
|---|---|---|---|---|---|
| (nm) | 5 degrees | 15 degrees | 30 degrees | 45 degrees | 60 degrees |
| 780 | 0.728 | 0.802 | 1.127 | 2.016 | 5.574 |
| 770 | 0.704 | 0.805 | 1.055 | 1.977 | 5.512 |
| 760 | 0.675 | 0.720 | 1.013 | 1.865 | 5.394 |
| 750 | 0.663 | 0.672 | 0.974 | 1.866 | 5.294 |
| 740 | 0.608 | 0.669 | 0.930 | 1.805 | 5.185 |
| 730 | 0.562 | 0.633 | 0.911 | 1.746 | 5.133 |
| 720 | 0.506 | 0.586 | 0.840 | 1.679 | 5.029 |
| 710 | 0.485 | 0.546 | 0.817 | 1.641 | 4.952 |
| 700 | 0.431 | 0.498 | 0.779 | 1.587 | 4.855 |
| 690 | 0.409 | 0.465 | 0.719 | 1.506 | 4.735 |
| 680 | 0.380 | 0.439 | 0.684 | 1.441 | 4.651 |
| 670 | 0.359 | 0.407 | 0.640 | 1.401 | 4.528 |
| 660 | 0.322 | 0.371 | 0.592 | 1.323 | 4.428 |
| 650 | 0.289 | 0.350 | 0.543 | 1.273 | 4.292 |
| 640 | 0.262 | 0.314 | 0.522 | 1.205 | 4.221 |
| 630 | 0.234 | 0.278 | 0.474 | 1.143 | 4.104 |
| 620 | 0.207 | 0.248 | 0.436 | 1.095 | 3.999 |
| 610 | 0.179 | 0.216 | 0.407 | 1.033 | 3.869 |
| 600 | 0.150 | 0.194 | 0.353 | 0.957 | 3.745 |
| 590 | 0.134 | 0.176 | 0.331 | 0.900 | 3.618 |
| 580 | 0.117 | 0.148 | 0.292 | 0.849 | 3.513 |
| 570 | 0.102 | 0.127 | 0.269 | 0.793 | 3.372 |
| 560 | 0.084 | 0.107 | 0.232 | 0.728 | 3.254 |
| 550 | 0.066 | 0.087 | 0.202 | 0.671 | 3.118 |
| 540 | 0.056 | 0.077 | 0.172 | 0.617 | 2.993 |
| 530 | 0.051 | 0.061 | 0.149 | 0.568 | 2.859 |
| 520 | 0.038 | 0.054 | 0.134 | 0.507 | 2.737 |
| 510 | 0.032 | 0.045 | 0.112 | 0.466 | 2.602 |
| 500 | 0.026 | 0.034 | 0.086 | 0.418 | 2.487 |
| 490 | 0.023 | 0.029 | 0.076 | 0.371 | 2.343 |
| 480 | 0.022 | 0.026 | 0.061 | 0.332 | 2.221 |
| 470 | 0.025 | 0.025 | 0.052 | 0.286 | 2.095 |
| 460 | 0.024 | 0.024 | 0.041 | 0.255 | 1.962 |
| 450 | 0.031 | 0.027 | 0.038 | 0.223 | 1.842 |
| 440 | 0.031 | 0.031 | 0.031 | 0.193 | 1.732 |
| 430 | 0.032 | 0.033 | 0.031 | 0.172 | 1.617 |
| 420 | 0.055 | 0.064 | 0.054 | 0.181 | 1.573 |
| 410 | 0.056 | 0.046 | 0.046 | 0.142 | 1.415 |
| 400 | 0.051 | 0.050 | 0.041 | 0.119 | 1.323 |
| 390 | 0.065 | 0.064 | 0.045 | 0.121 | 1.223 |
| 380 | 0.077 | 0.079 | 0.037 | 0.095 | 1.159 |

Table 3 shows the result of the film 2.

TABLE 3

| Wavelength | Reflectance (%) | | | | |
|---|---|---|---|---|---|
| (nm) | 5 degrees | 15 degrees | 30 degrees | 45 degrees | 60 degrees |
| 780 | 0.527 | 0.511 | 0.732 | 1.595 | 4.830 |
| 770 | 0.414 | 0.483 | 0.721 | 1.513 | 4.719 |
| 760 | 0.401 | 0.456 | 0.727 | 1.478 | 4.616 |
| 750 | 0.366 | 0.396 | 0.673 | 1.436 | 4.542 |
| 740 | 0.359 | 0.404 | 0.601 | 1.393 | 4.510 |
| 730 | 0.343 | 0.350 | 0.586 | 1.282 | 4.382 |
| 720 | 0.280 | 0.322 | 0.554 | 1.258 | 4.292 |
| 710 | 0.266 | 0.295 | 0.520 | 1.205 | 4.212 |
| 700 | 0.237 | 0.284 | 0.469 | 1.145 | 4.096 |
| 690 | 0.218 | 0.256 | 0.442 | 1.099 | 3.991 |
| 680 | 0.195 | 0.224 | 0.396 | 1.056 | 3.879 |
| 670 | 0.166 | 0.209 | 0.369 | 0.983 | 3.790 |
| 660 | 0.137 | 0.181 | 0.346 | 0.936 | 3.670 |
| 650 | 0.123 | 0.162 | 0.310 | 0.889 | 3.565 |
| 640 | 0.110 | 0.139 | 0.280 | 0.823 | 3.470 |
| 630 | 0.093 | 0.117 | 0.255 | 0.772 | 3.341 |
| 620 | 0.079 | 0.099 | 0.226 | 0.718 | 3.253 |
| 610 | 0.066 | 0.083 | 0.192 | 0.678 | 3.131 |
| 600 | 0.051 | 0.065 | 0.168 | 0.628 | 3.013 |
| 590 | 0.044 | 0.056 | 0.149 | 0.584 | 2.899 |
| 580 | 0.037 | 0.048 | 0.130 | 0.529 | 2.788 |
| 570 | 0.030 | 0.039 | 0.110 | 0.484 | 2.677 |
| 560 | 0.025 | 0.031 | 0.094 | 0.441 | 2.568 |
| 550 | 0.023 | 0.025 | 0.074 | 0.394 | 2.447 |
| 540 | 0.021 | 0.022 | 0.060 | 0.360 | 2.342 |
| 530 | 0.023 | 0.024 | 0.055 | 0.332 | 2.234 |
| 520 | 0.027 | 0.031 | 0.052 | 0.307 | 2.139 |
| 510 | 0.028 | 0.023 | 0.042 | 0.263 | 2.015 |
| 500 | 0.033 | 0.029 | 0.036 | 0.234 | 1.920 |
| 490 | 0.037 | 0.032 | 0.033 | 0.213 | 1.807 |
| 480 | 0.045 | 0.038 | 0.030 | 0.189 | 1.710 |
| 470 | 0.054 | 0.044 | 0.034 | 0.171 | 1.625 |
| 460 | 0.055 | 0.051 | 0.036 | 0.157 | 1.537 |
| 450 | 0.063 | 0.056 | 0.040 | 0.146 | 1.443 |
| 440 | 0.064 | 0.062 | 0.043 | 0.128 | 1.371 |
| 430 | 0.071 | 0.065 | 0.047 | 0.139 | 1.309 |
| 420 | 0.104 | 0.088 | 0.077 | 0.170 | 1.290 |
| 410 | 0.104 | 0.082 | 0.075 | 0.125 | 1.205 |
| 400 | 0.097 | 0.083 | 0.070 | 0.140 | 1.122 |
| 390 | 0.114 | 0.099 | 0.099 | 0.140 | 1.087 |
| 380 | 0.138 | 0.110 | 0.115 | 0.157 | 1.034 |

Table 4 shows the result of the film 3.

TABLE 4

| Wavelength | Reflectance (%) | | | |
|---|---|---|---|---|
| (nm) | 5 degrees | 30 degrees | 45 degrees | 60 degrees |
| 780 | 0.208 | 0.435 | 1.110 | 3.951 |
| 770 | 0.181 | 0.409 | 1.047 | 3.831 |
| 760 | 0.159 | 0.373 | 1.006 | 3.717 |
| 750 | 0.149 | 0.334 | 0.932 | 3.604 |
| 740 | 0.131 | 0.315 | 0.887 | 3.532 |
| 730 | 0.106 | 0.287 | 0.846 | 3.421 |
| 720 | 0.094 | 0.259 | 0.781 | 3.307 |
| 710 | 0.082 | 0.226 | 0.734 | 3.200 |
| 700 | 0.070 | 0.206 | 0.693 | 3.083 |
| 690 | 0.063 | 0.185 | 0.638 | 2.979 |
| 680 | 0.050 | 0.161 | 0.594 | 2.872 |
| 670 | 0.048 | 0.137 | 0.545 | 2.752 |
| 660 | 0.042 | 0.116 | 0.500 | 2.648 |
| 650 | 0.041 | 0.102 | 0.454 | 2.530 |
| 640 | 0.040 | 0.087 | 0.410 | 2.422 |
| 630 | 0.042 | 0.074 | 0.373 | 2.307 |
| 620 | 0.046 | 0.064 | 0.335 | 2.198 |
| 610 | 0.053 | 0.055 | 0.295 | 2.080 |
| 600 | 0.059 | 0.048 | 0.258 | 1.964 |
| 590 | 0.070 | 0.048 | 0.232 | 1.869 |
| 580 | 0.081 | 0.048 | 0.207 | 1.765 |
| 570 | 0.093 | 0.049 | 0.181 | 1.659 |
| 560 | 0.108 | 0.054 | 0.157 | 1.554 |
| 550 | 0.120 | 0.059 | 0.141 | 1.454 |
| 540 | 0.135 | 0.069 | 0.126 | 1.365 |
| 530 | 0.151 | 0.080 | 0.120 | 1.282 |
| 520 | 0.166 | 0.094 | 0.113 | 1.198 |
| 510 | 0.180 | 0.108 | 0.109 | 1.120 |
| 500 | 0.195 | 0.122 | 0.110 | 1.053 |
| 490 | 0.207 | 0.139 | 0.115 | 0.990 |
| 480 | 0.219 | 0.157 | 0.124 | 0.936 |
| 470 | 0.227 | 0.171 | 0.134 | 0.888 |
| 460 | 0.230 | 0.187 | 0.151 | 0.847 |
| 450 | 0.232 | 0.202 | 0.167 | 0.819 |
| 440 | 0.230 | 0.213 | 0.190 | 0.801 |
| 430 | 0.225 | 0.222 | 0.207 | 0.793 |
| 420 | 0.222 | 0.235 | 0.237 | 0.801 |
| 410 | 0.206 | 0.234 | 0.251 | 0.799 |
| 400 | 0.188 | 0.230 | 0.267 | 0.818 |
| 390 | 0.165 | 0.221 | 0.283 | 0.840 |
| 380 | 0.145 | 0.206 | 0.289 | 0.869 |

Table 5 shows the result of the film 4.

TABLE 5

| Wavelength | Reflectance (%) | | | |
|---|---|---|---|---|
| (nm) | 5 degrees | 30 degrees | 45 degrees | 60 degrees |
| 780 | 1.135 | 1.544 | 2.575 | 6.270 |
| 770 | 1.093 | 1.513 | 2.498 | 6.219 |
| 760 | 1.047 | 1.450 | 2.422 | 6.131 |
| 750 | 0.995 | 1.395 | 2.382 | 6.024 |
| 740 | 0.953 | 1.360 | 2.342 | 5.987 |
| 730 | 0.911 | 1.303 | 2.275 | 5.900 |
| 720 | 0.876 | 1.264 | 2.221 | 5.828 |
| 710 | 0.821 | 1.210 | 2.162 | 5.754 |
| 700 | 0.777 | 1.163 | 2.095 | 5.649 |
| 690 | 0.729 | 1.110 | 2.038 | 5.562 |
| 680 | 0.683 | 1.061 | 1.977 | 5.465 |
| 670 | 0.647 | 1.009 | 1.911 | 5.365 |
| 660 | 0.599 | 0.960 | 1.847 | 5.270 |
| 650 | 0.557 | 0.904 | 1.784 | 5.180 |
| 640 | 0.516 | 0.858 | 1.715 | 5.068 |
| 630 | 0.473 | 0.806 | 1.648 | 4.968 |
| 620 | 0.429 | 0.754 | 1.580 | 4.848 |
| 610 | 0.388 | 0.701 | 1.507 | 4.737 |
| 600 | 0.348 | 0.650 | 1.436 | 4.610 |
| 590 | 0.312 | 0.600 | 1.367 | 4.515 |
| 580 | 0.276 | 0.552 | 1.306 | 4.401 |
| 570 | 0.242 | 0.504 | 1.230 | 4.262 |
| 560 | 0.207 | 0.456 | 1.157 | 4.140 |
| 550 | 0.176 | 0.407 | 1.082 | 4.003 |
| 540 | 0.147 | 0.365 | 1.009 | 3.874 |
| 530 | 0.121 | 0.324 | 0.946 | 3.753 |
| 520 | 0.099 | 0.282 | 0.874 | 3.614 |
| 510 | 0.076 | 0.241 | 0.802 | 3.472 |
| 500 | 0.060 | 0.204 | 0.734 | 3.327 |
| 490 | 0.045 | 0.172 | 0.670 | 3.192 |
| 480 | 0.033 | 0.143 | 0.606 | 3.048 |
| 470 | 0.027 | 0.115 | 0.542 | 2.906 |
| 460 | 0.023 | 0.090 | 0.483 | 2.755 |
| 450 | 0.023 | 0.072 | 0.430 | 2.618 |
| 440 | 0.025 | 0.057 | 0.378 | 2.474 |
| 430 | 0.032 | 0.046 | 0.332 | 2.340 |
| 420 | 0.048 | 0.045 | 0.294 | 2.223 |
| 410 | 0.062 | 0.042 | 0.258 | 2.077 |
| 400 | 0.079 | 0.043 | 0.228 | 1.954 |
| 390 | 0.100 | 0.052 | 0.198 | 1.842 |
| 380 | 0.113 | 0.061 | 0.184 | 1.729 |

Table 6 shows the result of the film 5.

TABLE 6

| Wavelength | Reflectance (%) | | | |
|---|---|---|---|---|
| (nm) | 5 degrees | 30 degrees | 45 degrees | 60 degrees |
| 780 | 0.957 | 1.342 | 2.319 | 6.024 |
| 770 | 0.910 | 1.303 | 2.264 | 5.893 |
| 760 | 0.868 | 1.247 | 2.210 | 5.785 |
| 750 | 0.819 | 1.207 | 2.149 | 5.721 |
| 740 | 0.773 | 1.158 | 2.100 | 5.660 |
| 730 | 0.755 | 1.121 | 2.050 | 5.560 |
| 720 | 0.702 | 1.075 | 1.978 | 5.484 |
| 710 | 0.666 | 1.026 | 1.929 | 5.372 |
| 700 | 0.606 | 0.974 | 1.859 | 5.299 |
| 690 | 0.571 | 0.926 | 1.800 | 5.188 |
| 680 | 0.529 | 0.876 | 1.735 | 5.099 |
| 670 | 0.489 | 0.826 | 1.667 | 4.989 |
| 660 | 0.447 | 0.774 | 1.600 | 4.886 |
| 650 | 0.411 | 0.724 | 1.542 | 4.782 |
| 640 | 0.374 | 0.681 | 1.478 | 4.682 |
| 630 | 0.336 | 0.628 | 1.411 | 4.576 |
| 620 | 0.300 | 0.582 | 1.341 | 4.460 |
| 610 | 0.265 | 0.535 | 1.268 | 4.339 |
| 600 | 0.228 | 0.489 | 1.198 | 4.218 |
| 590 | 0.201 | 0.444 | 1.135 | 4.103 |
| 580 | 0.173 | 0.403 | 1.073 | 3.988 |
| 570 | 0.146 | 0.359 | 1.002 | 3.858 |
| 560 | 0.120 | 0.318 | 0.933 | 3.737 |
| 550 | 0.097 | 0.276 | 0.864 | 3.595 |
| 540 | 0.076 | 0.240 | 0.799 | 3.465 |
| 530 | 0.061 | 0.210 | 0.737 | 3.346 |
| 520 | 0.047 | 0.177 | 0.675 | 3.214 |
| 510 | 0.036 | 0.146 | 0.612 | 3.069 |
| 500 | 0.027 | 0.119 | 0.557 | 2.936 |
| 490 | 0.023 | 0.095 | 0.499 | 2.803 |
| 480 | 0.020 | 0.079 | 0.446 | 2.669 |
| 470 | 0.024 | 0.063 | 0.397 | 2.533 |
| 460 | 0.029 | 0.049 | 0.350 | 2.400 |
| 450 | 0.037 | 0.040 | 0.309 | 2.269 |
| 440 | 0.046 | 0.039 | 0.271 | 2.142 |
| 430 | 0.058 | 0.038 | 0.238 | 2.027 |
| 420 | 0.082 | 0.047 | 0.225 | 1.923 |
| 410 | 0.097 | 0.052 | 0.202 | 1.816 |
| 400 | 0.117 | 0.064 | 0.187 | 1.707 |
| 390 | 0.136 | 0.078 | 0.181 | 1.620 |
| 380 | 0.158 | 0.094 | 0.172 | 1.534 |

Table 7 shows the result of the film 6.

TABLE 7

| Wavelength | Reflectance (%) | | | |
|---|---|---|---|---|
| (nm) | 5 degrees | 30 degrees | 45 degrees | 60 degrees |
| 780 | 0.676 | 1.040 | 1.954 | 5.432 |
| 770 | 0.635 | 0.990 | 1.897 | 5.361 |
| 760 | 0.588 | 0.946 | 1.818 | 5.240 |
| 750 | 0.556 | 0.906 | 1.769 | 5.156 |
| 740 | 0.524 | 0.865 | 1.704 | 5.078 |
| 730 | 0.483 | 0.825 | 1.670 | 5.018 |
| 720 | 0.453 | 0.772 | 1.605 | 4.888 |
| 710 | 0.409 | 0.729 | 1.537 | 4.788 |
| 700 | 0.376 | 0.684 | 1.468 | 4.691 |
| 690 | 0.345 | 0.644 | 1.407 | 4.585 |
| 680 | 0.311 | 0.600 | 1.362 | 4.500 |
| 670 | 0.280 | 0.549 | 1.292 | 4.392 |
| 660 | 0.247 | 0.512 | 1.228 | 4.278 |
| 650 | 0.221 | 0.468 | 1.163 | 4.162 |
| 640 | 0.191 | 0.424 | 1.101 | 4.055 |
| 630 | 0.164 | 0.386 | 1.043 | 3.942 |
| 620 | 0.141 | 0.351 | 0.980 | 3.818 |
| 610 | 0.116 | 0.311 | 0.914 | 3.698 |
| 600 | 0.093 | 0.276 | 0.848 | 3.566 |
| 590 | 0.077 | 0.245 | 0.795 | 3.457 |
| 580 | 0.062 | 0.212 | 0.740 | 3.342 |
| 570 | 0.051 | 0.181 | 0.682 | 3.208 |
| 560 | 0.038 | 0.152 | 0.622 | 3.081 |
| 550 | 0.029 | 0.125 | 0.567 | 2.941 |
| 540 | 0.023 | 0.106 | 0.515 | 2.829 |
| 530 | 0.021 | 0.088 | 0.465 | 2.704 |
| 520 | 0.020 | 0.071 | 0.417 | 2.582 |
| 510 | 0.022 | 0.056 | 0.370 | 2.456 |
| 500 | 0.027 | 0.044 | 0.331 | 2.327 |
| 490 | 0.033 | 0.037 | 0.290 | 2.207 |
| 480 | 0.041 | 0.035 | 0.258 | 2.094 |
| 470 | 0.053 | 0.034 | 0.228 | 1.979 |
| 460 | 0.066 | 0.035 | 0.200 | 1.862 |
| 450 | 0.082 | 0.042 | 0.181 | 1.758 |
| 440 | 0.094 | 0.049 | 0.165 | 1.665 |
| 430 | 0.108 | 0.061 | 0.156 | 1.574 |
| 420 | 0.128 | 0.079 | 0.159 | 1.501 |
| 410 | 0.135 | 0.090 | 0.152 | 1.422 |
| 400 | 0.154 | 0.107 | 0.160 | 1.360 |
| 390 | 0.170 | 0.112 | 0.162 | 1.309 |
| 380 | 0.176 | 0.133 | 0.174 | 1.260 |

Table 8 shows the result of the film 7.

TABLE 8

| Wavelength | Reflectance (%) | | | |
|---|---|---|---|---|
| (nm) | 5 degrees | 30 degrees | 45 degrees | 60 degrees |
| 780 | 0.258 | 0.511 | 1.235 | 4.261 |
| 770 | 0.228 | 0.488 | 1.187 | 4.155 |
| 760 | 0.205 | 0.449 | 1.121 | 4.028 |
| 750 | 0.181 | 0.416 | 1.081 | 3.948 |
| 740 | 0.166 | 0.381 | 1.022 | 3.872 |
| 730 | 0.145 | 0.356 | 0.973 | 3.763 |
| 720 | 0.126 | 0.318 | 0.932 | 3.664 |
| 710 | 0.106 | 0.287 | 0.872 | 3.568 |
| 700 | 0.087 | 0.257 | 0.816 | 3.452 |
| 690 | 0.072 | 0.233 | 0.767 | 3.336 |
| 680 | 0.064 | 0.203 | 0.718 | 3.246 |
| 670 | 0.051 | 0.180 | 0.664 | 3.124 |
| 660 | 0.040 | 0.157 | 0.616 | 3.020 |
| 650 | 0.033 | 0.135 | 0.570 | 2.920 |
| 640 | 0.026 | 0.116 | 0.528 | 2.810 |
| 630 | 0.024 | 0.099 | 0.487 | 2.701 |
| 620 | 0.020 | 0.081 | 0.444 | 2.589 |
| 610 | 0.019 | 0.065 | 0.396 | 2.471 |
| 600 | 0.017 | 0.051 | 0.357 | 2.362 |
| 590 | 0.023 | 0.044 | 0.328 | 2.264 |
| 580 | 0.027 | 0.039 | 0.295 | 2.158 |
| 570 | 0.031 | 0.034 | 0.262 | 2.058 |
| 560 | 0.039 | 0.030 | 0.234 | 1.950 |
| 550 | 0.044 | 0.026 | 0.206 | 1.848 |
| 540 | 0.053 | 0.028 | 0.185 | 1.752 |
| 530 | 0.063 | 0.033 | 0.169 | 1.668 |
| 520 | 0.074 | 0.039 | 0.153 | 1.583 |
| 510 | 0.081 | 0.044 | 0.141 | 1.492 |
| 500 | 0.092 | 0.052 | 0.129 | 1.414 |
| 490 | 0.099 | 0.058 | 0.124 | 1.347 |
| 480 | 0.107 | 0.068 | 0.119 | 1.275 |
| 470 | 0.112 | 0.076 | 0.119 | 1.214 |
| 460 | 0.116 | 0.088 | 0.122 | 1.158 |
| 450 | 0.117 | 0.096 | 0.127 | 1.112 |
| 440 | 0.119 | 0.102 | 0.133 | 1.070 |
| 430 | 0.116 | 0.108 | 0.142 | 1.038 |
| 420 | 0.118 | 0.123 | 0.156 | 1.029 |
| 410 | 0.106 | 0.118 | 0.163 | 1.006 |
| 400 | 0.105 | 0.117 | 0.170 | 0.983 |
| 390 | 0.094 | 0.112 | 0.175 | 0.976 |
| 380 | 0.090 | 0.112 | 0.176 | 0.970 |

Table 9 shows the result of the film 8.

TABLE 9

| Wavelength | Reflectance (%) | | | |
|---|---|---|---|---|
| (nm) | 5 degrees | 30 degrees | 45 degrees | 60 degrees |
| 780 | 0.022 | 0.121 | 0.515 | 2.759 |
| 770 | 0.016 | 0.094 | 0.478 | 2.710 |
| 760 | 0.021 | 0.079 | 0.446 | 2.596 |
| 750 | 0.019 | 0.066 | 0.425 | 2.486 |
| 740 | 0.029 | 0.077 | 0.396 | 2.436 |
| 730 | 0.023 | 0.055 | 0.353 | 2.334 |
| 720 | 0.023 | 0.048 | 0.328 | 2.261 |
| 710 | 0.026 | 0.040 | 0.299 | 2.182 |
| 700 | 0.030 | 0.039 | 0.275 | 2.092 |
| 690 | 0.036 | 0.039 | 0.258 | 2.033 |
| 680 | 0.041 | 0.037 | 0.234 | 1.946 |
| 670 | 0.046 | 0.034 | 0.219 | 1.867 |
| 660 | 0.054 | 0.036 | 0.207 | 1.793 |
| 650 | 0.058 | 0.037 | 0.191 | 1.728 |
| 640 | 0.066 | 0.042 | 0.179 | 1.665 |
| 630 | 0.070 | 0.048 | 0.168 | 1.604 |
| 620 | 0.075 | 0.051 | 0.160 | 1.537 |
| 610 | 0.080 | 0.057 | 0.153 | 1.475 |
| 600 | 0.083 | 0.060 | 0.148 | 1.418 |
| 590 | 0.090 | 0.067 | 0.149 | 1.381 |
| 580 | 0.093 | 0.075 | 0.149 | 1.332 |
| 570 | 0.094 | 0.081 | 0.152 | 1.286 |
| 560 | 0.094 | 0.088 | 0.154 | 1.248 |
| 550 | 0.094 | 0.090 | 0.155 | 1.212 |
| 540 | 0.091 | 0.093 | 0.160 | 1.180 |
| 530 | 0.090 | 0.097 | 0.166 | 1.163 |
| 520 | 0.084 | 0.100 | 0.174 | 1.136 |
| 510 | 0.078 | 0.099 | 0.177 | 1.116 |
| 500 | 0.070 | 0.099 | 0.178 | 1.102 |
| 490 | 0.065 | 0.094 | 0.183 | 1.089 |
| 480 | 0.056 | 0.088 | 0.187 | 1.077 |
| 470 | 0.047 | 0.083 | 0.184 | 1.063 |
| 460 | 0.041 | 0.076 | 0.182 | 1.056 |
| 450 | 0.037 | 0.067 | 0.178 | 1.047 |
| 440 | 0.033 | 0.059 | 0.174 | 1.037 |
| 430 | 0.031 | 0.053 | 0.164 | 1.023 |
| 420 | 0.038 | 0.050 | 0.158 | 1.018 |
| 410 | 0.037 | 0.044 | 0.144 | 0.990 |
| 400 | 0.042 | 0.041 | 0.133 | 0.971 |
| 390 | 0.047 | 0.039 | 0.122 | 0.938 |
| 380 | 0.056 | 0.042 | 0.105 | 0.916 |

Table 10 shows the result of the film 9.

TABLE 10

| Wavelength | Reflectance (%) | | | |
|---|---|---|---|---|
| (nm) | 5 degrees | 30 degrees | 45 degrees | 60 degrees |
| 780 | 0.018 | 0.050 | 0.314 | 2.312 |
| 770 | 0.032 | 0.049 | 0.316 | 2.214 |
| 760 | 0.027 | 0.031 | 0.268 | 2.100 |
| 750 | 0.026 | 0.028 | 0.234 | 2.035 |
| 740 | 0.045 | 0.031 | 0.233 | 1.951 |
| 730 | 0.042 | 0.025 | 0.221 | 1.867 |
| 720 | 0.057 | 0.034 | 0.187 | 1.804 |
| 710 | 0.062 | 0.027 | 0.179 | 1.729 |
| 700 | 0.074 | 0.031 | 0.163 | 1.652 |
| 690 | 0.078 | 0.034 | 0.148 | 1.590 |
| 680 | 0.089 | 0.040 | 0.140 | 1.517 |
| 670 | 0.098 | 0.050 | 0.132 | 1.461 |
| 660 | 0.105 | 0.058 | 0.122 | 1.385 |
| 650 | 0.115 | 0.065 | 0.116 | 1.334 |
| 640 | 0.121 | 0.070 | 0.118 | 1.275 |
| 630 | 0.130 | 0.079 | 0.120 | 1.223 |
| 620 | 0.136 | 0.089 | 0.121 | 1.175 |
| 610 | 0.141 | 0.098 | 0.121 | 1.124 |
| 600 | 0.142 | 0.105 | 0.121 | 1.085 |
| 590 | 0.147 | 0.116 | 0.131 | 1.056 |
| 580 | 0.150 | 0.125 | 0.138 | 1.030 |
| 570 | 0.148 | 0.132 | 0.147 | 1.005 |
| 560 | 0.146 | 0.137 | 0.160 | 0.983 |
| 550 | 0.142 | 0.141 | 0.169 | 0.958 |
| 540 | 0.135 | 0.143 | 0.178 | 0.951 |
| 530 | 0.131 | 0.149 | 0.189 | 0.947 |
| 520 | 0.124 | 0.152 | 0.199 | 0.946 |
| 510 | 0.112 | 0.146 | 0.208 | 0.940 |
| 500 | 0.102 | 0.142 | 0.213 | 0.943 |
| 490 | 0.094 | 0.135 | 0.222 | 0.948 |
| 480 | 0.082 | 0.131 | 0.223 | 0.954 |
| 470 | 0.071 | 0.121 | 0.225 | 0.962 |
| 460 | 0.062 | 0.109 | 0.221 | 0.974 |
| 450 | 0.054 | 0.100 | 0.221 | 0.978 |
| 440 | 0.047 | 0.088 | 0.212 | 0.986 |
| 430 | 0.041 | 0.079 | 0.201 | 0.986 |
| 420 | 0.041 | 0.072 | 0.198 | 1.005 |
| 410 | 0.040 | 0.066 | 0.184 | 0.991 |
| 400 | 0.040 | 0.057 | 0.171 | 0.978 |
| 390 | 0.037 | 0.050 | 0.155 | 0.963 |
| 380 | 0.037 | 0.049 | 0.142 | 0.941 |

Table 11 shows the result of the film 10.

TABLE 11

| Wavelength | Reflectance (%) | | | |
|---|---|---|---|---|
| (nm) | 5 degrees | 30 degrees | 45 degrees | 60 degrees |
| 780 | 0.111 | 0.058 | 0.104 | 1.255 |
| 770 | 0.119 | 0.070 | 0.106 | 1.188 |
| 760 | 0.130 | 0.080 | 0.104 | 1.126 |
| 750 | 0.120 | 0.086 | 0.107 | 1.124 |
| 740 | 0.131 | 0.095 | 0.115 | 1.060 |
| 730 | 0.139 | 0.098 | 0.104 | 1.029 |
| 720 | 0.141 | 0.113 | 0.119 | 1.009 |
| 710 | 0.138 | 0.115 | 0.122 | 0.993 |
| 700 | 0.136 | 0.124 | 0.125 | 0.950 |
| 690 | 0.139 | 0.131 | 0.134 | 0.925 |
| 680 | 0.136 | 0.137 | 0.144 | 0.911 |
| 670 | 0.133 | 0.135 | 0.153 | 0.891 |
| 660 | 0.128 | 0.138 | 0.158 | 0.879 |
| 650 | 0.119 | 0.135 | 0.168 | 0.875 |
| 640 | 0.114 | 0.137 | 0.177 | 0.868 |
| 630 | 0.106 | 0.136 | 0.186 | 0.866 |
| 620 | 0.100 | 0.135 | 0.190 | 0.863 |
| 610 | 0.088 | 0.128 | 0.192 | 0.863 |
| 600 | 0.077 | 0.122 | 0.194 | 0.864 |
| 590 | 0.070 | 0.119 | 0.199 | 0.873 |
| 580 | 0.063 | 0.113 | 0.204 | 0.882 |
| 570 | 0.055 | 0.103 | 0.202 | 0.883 |
| 560 | 0.050 | 0.093 | 0.202 | 0.890 |
| 550 | 0.043 | 0.082 | 0.197 | 0.897 |
| 540 | 0.038 | 0.074 | 0.190 | 0.899 |
| 530 | 0.037 | 0.066 | 0.184 | 0.910 |
| 520 | 0.038 | 0.061 | 0.177 | 0.912 |
| 510 | 0.040 | 0.052 | 0.167 | 0.910 |
| 500 | 0.043 | 0.048 | 0.154 | 0.905 |
| 490 | 0.049 | 0.046 | 0.145 | 0.895 |
| 480 | 0.057 | 0.045 | 0.134 | 0.884 |
| 470 | 0.064 | 0.047 | 0.123 | 0.869 |
| 460 | 0.069 | 0.050 | 0.112 | 0.847 |
| 450 | 0.075 | 0.056 | 0.107 | 0.827 |
| 440 | 0.078 | 0.064 | 0.103 | 0.802 |
| 430 | 0.079 | 0.073 | 0.104 | 0.772 |
| 420 | 0.081 | 0.090 | 0.111 | 0.757 |
| 410 | 0.073 | 0.091 | 0.115 | 0.728 |
| 400 | 0.059 | 0.094 | 0.128 | 0.703 |
| 390 | 0.047 | 0.095 | 0.134 | 0.688 |
| 380 | 0.035 | 0.087 | 0.145 | 0.677 |

Table 12 shows the result of the film 11.

TABLE 12

| Wavelength | Reflectance (%) | | | |
|---|---|---|---|---|
| (nm) | 5 degrees | 30 degrees | 45 degrees | 60 degrees |
| 780 | 0.057 | 0.102 | 0.205 | 1.009 |
| 770 | 0.045 | 0.089 | 0.204 | 1.016 |
| 760 | 0.040 | 0.074 | 0.206 | 1.021 |
| 750 | 0.050 | 0.074 | 0.185 | 1.012 |
| 740 | 0.049 | 0.072 | 0.221 | 1.031 |
| 730 | 0.045 | 0.067 | 0.200 | 1.024 |
| 720 | 0.046 | 0.061 | 0.184 | 0.995 |
| 710 | 0.054 | 0.058 | 0.175 | 1.008 |
| 700 | 0.053 | 0.051 | 0.165 | 1.004 |
| 690 | 0.054 | 0.052 | 0.163 | 0.989 |
| 680 | 0.059 | 0.050 | 0.148 | 0.989 |
| 670 | 0.063 | 0.053 | 0.142 | 0.970 |
| 660 | 0.068 | 0.053 | 0.139 | 0.954 |
| 650 | 0.073 | 0.055 | 0.130 | 0.937 |
| 640 | 0.077 | 0.060 | 0.128 | 0.921 |
| 630 | 0.082 | 0.063 | 0.122 | 0.900 |
| 620 | 0.084 | 0.067 | 0.120 | 0.876 |
| 610 | 0.085 | 0.073 | 0.117 | 0.861 |
| 600 | 0.082 | 0.075 | 0.113 | 0.836 |
| 590 | 0.084 | 0.084 | 0.116 | 0.815 |
| 580 | 0.081 | 0.092 | 0.120 | 0.795 |
| 570 | 0.076 | 0.096 | 0.124 | 0.776 |
| 560 | 0.068 | 0.098 | 0.131 | 0.755 |
| 550 | 0.060 | 0.097 | 0.138 | 0.735 |
| 540 | 0.049 | 0.096 | 0.145 | 0.719 |
| 530 | 0.041 | 0.093 | 0.153 | 0.713 |
| 520 | 0.033 | 0.091 | 0.161 | 0.709 |
| 510 | 0.026 | 0.080 | 0.165 | 0.704 |
| 500 | 0.022 | 0.070 | 0.168 | 0.701 |
| 490 | 0.026 | 0.058 | 0.171 | 0.706 |
| 480 | 0.037 | 0.047 | 0.168 | 0.707 |
| 470 | 0.063 | 0.037 | 0.161 | 0.716 |
| 460 | 0.101 | 0.030 | 0.150 | 0.724 |
| 450 | 0.161 | 0.033 | 0.136 | 0.729 |
| 440 | 0.240 | 0.040 | 0.119 | 0.737 |
| 430 | 0.345 | 0.066 | 0.101 | 0.739 |
| 420 | 0.487 | 0.117 | 0.090 | 0.743 |
| 410 | 0.641 | 0.194 | 0.068 | 0.720 |
| 400 | 0.811 | 0.295 | 0.066 | 0.696 |
| 390 | 0.971 | 0.431 | 0.078 | 0.640 |
| 380 | 1.118 | 0.600 | 0.117 | 0.586 |

Table 13 shows the result of the film 12.

TABLE 13

| Wavelength | Reflectance (%) | | | |
|---|---|---|---|---|
| (nm) | 5 degrees | 30 degrees | 45 degrees | 60 degrees |
| 780 | 0.738 | 1.127 | 2.104 | 5.761 |
| 770 | 0.696 | 1.078 | 2.034 | 5.698 |
| 760 | 0.657 | 1.023 | 1.977 | 5.579 |
| 750 | 0.617 | 0.980 | 1.920 | 5.468 |
| 740 | 0.574 | 0.948 | 1.860 | 5.425 |
| 730 | 0.544 | 0.903 | 1.797 | 5.340 |
| 720 | 0.505 | 0.855 | 1.735 | 5.212 |
| 710 | 0.466 | 0.810 | 1.679 | 5.126 |
| 700 | 0.428 | 0.763 | 1.613 | 5.018 |
| 690 | 0.395 | 0.721 | 1.535 | 4.917 |
| 680 | 0.364 | 0.672 | 1.484 | 4.799 |
| 670 | 0.329 | 0.623 | 1.417 | 4.700 |
| 660 | 0.293 | 0.579 | 1.353 | 4.595 |
| 650 | 0.264 | 0.539 | 1.289 | 4.468 |
| 640 | 0.233 | 0.494 | 1.228 | 4.362 |
| 630 | 0.202 | 0.454 | 1.161 | 4.244 |
| 620 | 0.177 | 0.411 | 1.090 | 4.125 |
| 610 | 0.148 | 0.368 | 1.030 | 3.988 |
| 600 | 0.125 | 0.327 | 0.959 | 3.866 |
| 590 | 0.107 | 0.294 | 0.906 | 3.752 |
| 580 | 0.088 | 0.263 | 0.848 | 3.633 |
| 570 | 0.069 | 0.228 | 0.779 | 3.500 |
| 560 | 0.054 | 0.196 | 0.719 | 3.374 |
| 550 | 0.041 | 0.165 | 0.655 | 3.239 |
| 540 | 0.032 | 0.137 | 0.601 | 3.113 |
| 530 | 0.025 | 0.116 | 0.554 | 2.994 |
| 520 | 0.021 | 0.098 | 0.502 | 2.868 |
| 510 | 0.018 | 0.077 | 0.449 | 2.747 |
| 500 | 0.019 | 0.063 | 0.403 | 2.618 |
| 490 | 0.021 | 0.050 | 0.364 | 2.500 |
| 480 | 0.025 | 0.040 | 0.329 | 2.382 |
| 470 | 0.031 | 0.035 | 0.288 | 2.265 |
| 460 | 0.040 | 0.033 | 0.258 | 2.155 |
| 450 | 0.049 | 0.032 | 0.232 | 2.057 |
| 440 | 0.058 | 0.035 | 0.214 | 1.958 |
| 430 | 0.069 | 0.040 | 0.196 | 1.867 |
| 420 | 0.087 | 0.055 | 0.188 | 1.806 |
| 410 | 0.093 | 0.061 | 0.181 | 1.717 |
| 400 | 0.105 | 0.072 | 0.180 | 1.651 |
| 390 | 0.108 | 0.078 | 0.178 | 1.585 |
| 380 | 0.122 | 0.095 | 0.181 | 1.542 |

Table 14 shows the result of the film 13.

TABLE 14

| Wavelength | Reflectance (%) | | | |
|---|---|---|---|---|
| (nm) | 5 degrees | 30 degrees | 45 degrees | 60 degrees |
| 780 | 0.124 | 0.310 | 0.901 | 3.689 |
| 770 | 0.108 | 0.280 | 0.850 | 3.566 |
| 760 | 0.083 | 0.243 | 0.789 | 3.443 |
| 750 | 0.076 | 0.220 | 0.743 | 3.335 |
| 740 | 0.075 | 0.202 | 0.693 | 3.251 |
| 730 | 0.058 | 0.186 | 0.661 | 3.154 |
| 720 | 0.053 | 0.166 | 0.611 | 3.051 |
| 710 | 0.044 | 0.147 | 0.565 | 2.955 |
| 700 | 0.034 | 0.128 | 0.529 | 2.837 |
| 690 | 0.031 | 0.108 | 0.489 | 2.739 |
| 680 | 0.027 | 0.092 | 0.451 | 2.634 |
| 670 | 0.026 | 0.078 | 0.414 | 2.527 |
| 660 | 0.026 | 0.068 | 0.378 | 2.424 |
| 650 | 0.027 | 0.058 | 0.344 | 2.322 |
| 640 | 0.028 | 0.048 | 0.308 | 2.226 |
| 630 | 0.029 | 0.043 | 0.279 | 2.136 |
| 620 | 0.030 | 0.039 | 0.250 | 2.034 |
| 610 | 0.033 | 0.033 | 0.225 | 1.937 |
| 600 | 0.036 | 0.027 | 0.199 | 1.830 |
| 590 | 0.045 | 0.028 | 0.184 | 1.757 |
| 580 | 0.051 | 0.029 | 0.168 | 1.679 |
| 570 | 0.057 | 0.032 | 0.152 | 1.589 |
| 560 | 0.060 | 0.035 | 0.136 | 1.515 |
| 550 | 0.064 | 0.039 | 0.121 | 1.438 |
| 540 | 0.067 | 0.044 | 0.115 | 1.369 |
| 530 | 0.073 | 0.048 | 0.113 | 1.313 |
| 520 | 0.077 | 0.054 | 0.112 | 1.258 |
| 510 | 0.079 | 0.058 | 0.110 | 1.199 |
| 500 | 0.078 | 0.066 | 0.110 | 1.150 |
| 490 | 0.078 | 0.072 | 0.111 | 1.112 |
| 480 | 0.077 | 0.073 | 0.116 | 1.080 |
| 470 | 0.074 | 0.076 | 0.121 | 1.047 |
| 460 | 0.069 | 0.078 | 0.124 | 1.018 |
| 450 | 0.063 | 0.079 | 0.129 | 0.994 |
| 440 | 0.056 | 0.077 | 0.131 | 0.979 |
| 430 | 0.050 | 0.073 | 0.133 | 0.961 |
| 420 | 0.047 | 0.075 | 0.143 | 0.959 |
| 410 | 0.040 | 0.071 | 0.140 | 0.941 |
| 400 | 0.033 | 0.058 | 0.138 | 0.934 |
| 390 | 0.024 | 0.050 | 0.136 | 0.914 |
| 380 | 0.021 | 0.045 | 0.126 | 0.893 |

Table 15 shows the result of the film 14.

TABLE 15

| Wavelength | Reflectance (%) | | | |
|---|---|---|---|---|
| (nm) | 5 degrees | 30 degrees | 45 degrees | 60 degrees |
| 780 | 0.096 | 0.073 | 0.101 | 1.137 |
| 770 | 0.089 | 0.074 | 0.103 | 1.115 |
| 760 | 0.094 | 0.077 | 0.094 | 1.039 |
| 750 | 0.087 | 0.076 | 0.099 | 1.013 |
| 740 | 0.101 | 0.093 | 0.112 | 0.998 |
| 730 | 0.098 | 0.096 | 0.109 | 0.950 |
| 720 | 0.096 | 0.091 | 0.112 | 0.930 |
| 710 | 0.085 | 0.098 | 0.111 | 0.904 |
| 700 | 0.088 | 0.100 | 0.115 | 0.884 |
| 690 | 0.081 | 0.093 | 0.124 | 0.867 |
| 680 | 0.076 | 0.098 | 0.126 | 0.853 |
| 670 | 0.070 | 0.094 | 0.131 | 0.839 |
| 660 | 0.065 | 0.095 | 0.139 | 0.832 |
| 650 | 0.059 | 0.091 | 0.137 | 0.814 |
| 640 | 0.053 | 0.086 | 0.141 | 0.814 |
| 630 | 0.047 | 0.083 | 0.145 | 0.808 |
| 620 | 0.042 | 0.079 | 0.145 | 0.804 |
| 610 | 0.033 | 0.070 | 0.143 | 0.802 |
| 600 | 0.026 | 0.062 | 0.141 | 0.789 |
| 590 | 0.028 | 0.059 | 0.140 | 0.804 |
| 580 | 0.027 | 0.053 | 0.137 | 0.795 |
| 570 | 0.027 | 0.047 | 0.134 | 0.794 |
| 560 | 0.027 | 0.042 | 0.127 | 0.788 |
| 550 | 0.029 | 0.038 | 0.118 | 0.779 |
| 540 | 0.032 | 0.034 | 0.111 | 0.770 |
| 530 | 0.039 | 0.033 | 0.105 | 0.765 |
| 520 | 0.047 | 0.033 | 0.095 | 0.756 |
| 510 | 0.053 | 0.035 | 0.088 | 0.739 |
| 500 | 0.058 | 0.038 | 0.080 | 0.716 |
| 490 | 0.065 | 0.042 | 0.074 | 0.698 |
| 480 | 0.070 | 0.047 | 0.071 | 0.675 |
| 470 | 0.071 | 0.055 | 0.069 | 0.651 |
| 460 | 0.072 | 0.062 | 0.070 | 0.625 |
| 450 | 0.069 | 0.069 | 0.073 | 0.599 |
| 440 | 0.065 | 0.073 | 0.077 | 0.576 |
| 430 | 0.057 | 0.076 | 0.085 | 0.554 |
| 420 | 0.053 | 0.081 | 0.099 | 0.546 |
| 410 | 0.050 | 0.074 | 0.105 | 0.534 |
| 400 | 0.045 | 0.068 | 0.111 | 0.530 |
| 390 | 0.045 | 0.061 | 0.109 | 0.521 |
| 380 | 0.054 | 0.051 | 0.105 | 0.519 |

Comparison among the films having the same pitch (films 1 to 3, 4 to 11, and 12 to 14) indicates the following.

As the height of the moth-eye structure increases, the entire spectrum shifts to the right.

As the measurement angle increases, the entire spectrum shifts to the upper left.

These changes are well noted by paying attention to the minimal point of the spectrum.

Table 16 below shows the Y values of the films 1 to 14 calculated based on the spectra. Fourteen kinds of display devices are assembled using the films 1 to 14. Each display device includes a display panel and a touch panel having one of the films 1 to 14 attached to the rear surface. The display devices provided with any of the film 1, 2, 4, 5, 6, and 12 correspond to the comparative examples of the present invention. The display devices provided with any of the film 3, 7, 8, 9, 11, 13, and 14 correspond to the examples of the present invention. The display device provided with the film 10 corresponds to the reference example. Occurrence of interference fringes in each display device was checked by pressing the front face of the touch panel by a finger. The result shows that the interference fringes are weakened to an unnoticeable level when the Y value is not more than 0.25%.

TABLE 16

| | Y value | | | | |
|---|---|---|---|---|---|
| Film No. | 5 degrees | 15 degrees | 30 degrees | 45 degrees | 60 degrees |
| 1 | 0.09 | 0.12 | 0.24 | 0.72 | 3.20 |
| 2 | 0.04 | 0.05 | 0.10 | 0.45 | 2.53 |
| 3 | 0.12 | | 0.07 | 0.18 | 1.56 |
| 4 | 0.22 | | 0.45 | 1.13 | 4.08 |
| 5 | 0.13 | | 0.32 | 0.92 | 3.67 |
| 6 | 0.06 | | 0.17 | 0.62 | 3.04 |
| 7 | 0.05 | | 0.05 | 0.25 | 1.94 |
| 8 | 0.08 | | 0.08 | 0.16 | 1.27 |
| 9 | 0.13 | | 0.13 | 0.16 | 1.01 |
| 10 | 0.06 | | 0.09 | 0.19 | 0.89 |
| 11 | 0.06 | | 0.08 | 0.14 | 0.77 |
| 12 | 0.07 | | 0.20 | 0.72 | 3.33 |
| 13 | 0.06 | | 0.04 | 0.15 | 1.53 |
| 14 | 0.04 | | 0.05 | 0.12 | 0.77 |

These results indicate that the following films are effective for weakening the interference fringes in an angle from the normal direction of the display panel to a 45 degree direction. The film 3 is the best among the films 1 to 3. Though the film 2 has a low Y value in a 5 degree direction, the film 3 is preferred for suppressing interference fringes in a 5 degree direction and a 45 degree direction. For similar purposes, the films 7 to 11 are preferred among the films 4 to 11, and the films 13 and 14 are preferred among the films 12 to 14. A higher moth-eye structure exerts a higher effect of suppressing the occurrence of interference fringes but deteriorates the film-releasing property in the shape transferring step. A lower possible moth-eye structure is thus preferable in industrial production. Hence, the films 7, 8, and 10 are preferable for achieving both good productivity and an effect of suppressing the occurrence of interference fringes.

Interference fringes in a direction of not more than 45 degree were evaluated because the visibility in the range is especially important for mobile devices such as smart phones and tablet computers.

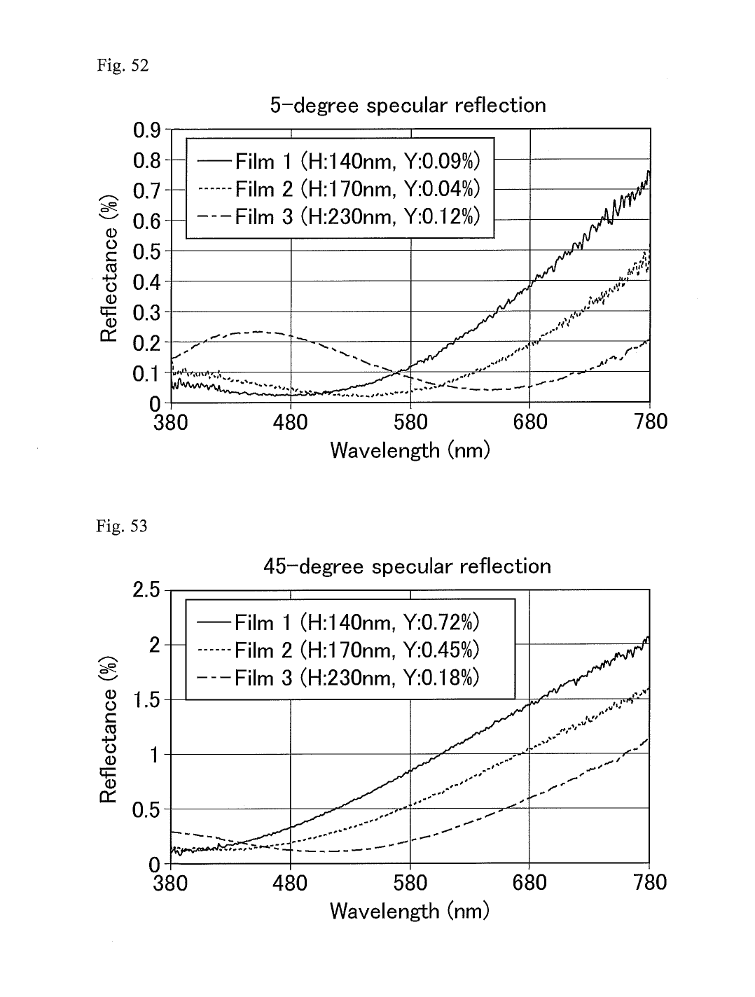

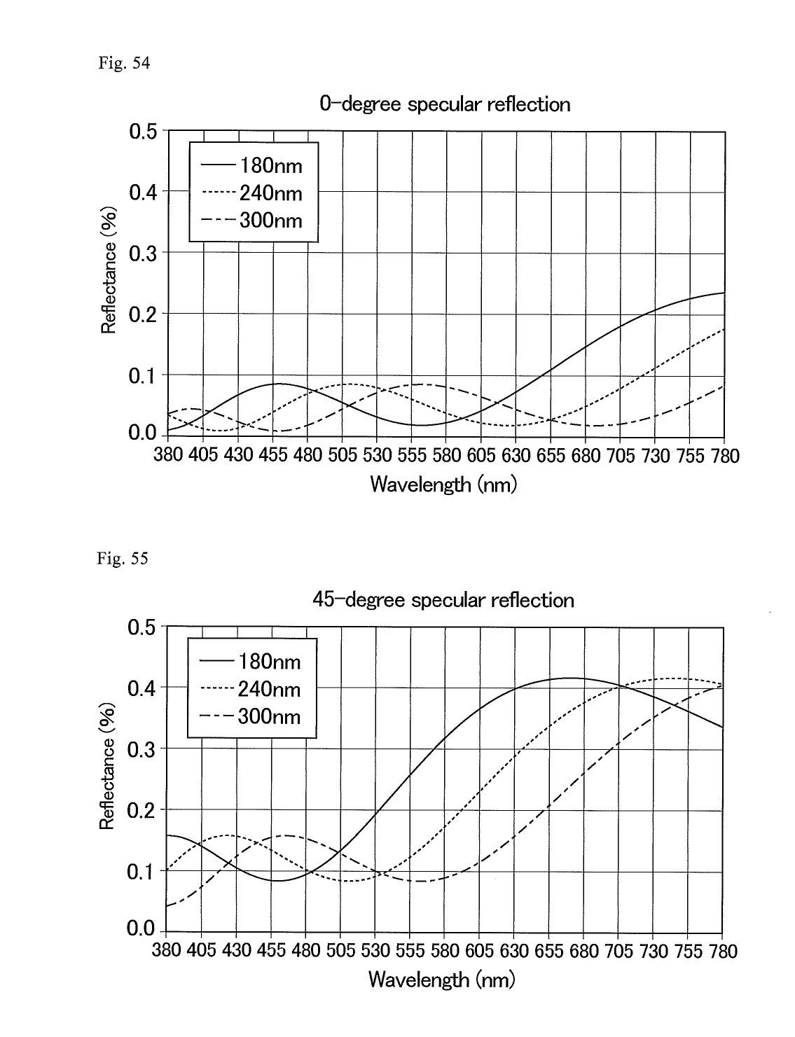

FIG. 52 is a graph collectively showing the reflection spectra of 5-degree specular reflection of the films 1 to 3. FIG. 53 is a graph collectively showing the reflection spectra of 45-degree specular reflection of the films 1 to 3. As shown in FIG. 52 and FIG. 53, use of a moth-eye structure with a high Y value in a front direction would minimize the increase in the Y value in an oblique direction. The film 2 seems the best based on the reflection spectrum of 5-degree specular reflection in FIG. 52. However, with reference to the spectra of the two directions in FIG. 52 and FIG. 53, the film 3 is found to be the best for achieving favorable Y values in both a 45 degree direction and a 5 degree direction. Thus, the setting of the film 3 is considered the best.

The above results show that the specularly reflected light spectrum of the moth-eye film depends on the pitch and height of the moth-eye structure, especially greatly on the height.

Similar results were obtained for the moth-eye films produced using the aluminum pipe or the electrodeposited sleeve as a substrate.

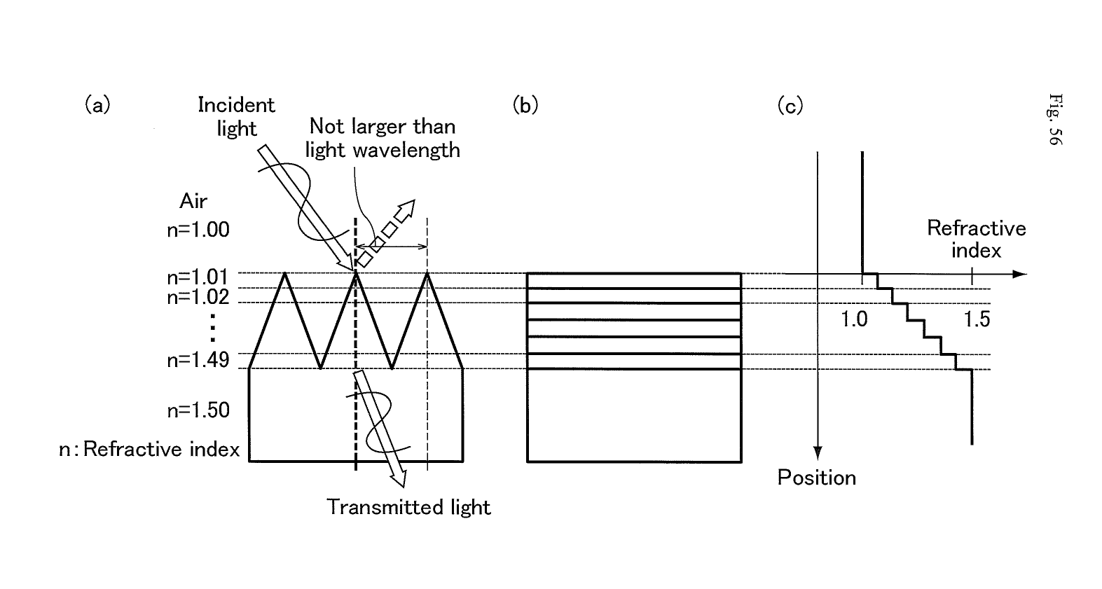

The specularly reflected light spectra of the moth-eye structures were calculated based on the effective medium theory. The results are described below. The reflection spectrum of 0-degree specular reflection and reflection spectrum of 45-degree specular reflection of three kinds of moth-eye structures having a height of 180 nm, 240 nm, and 300 nm were obtained. FIG. 54 and FIG. 55 show the results.

Similar results as those in the aforementioned test were obtained in all the cases. Namely, the followings are clarified.

As the height of the moth-eye structure increases, the entire spectrum shifts to the right.

As the measurement angle increases, the entire spectrum shifts to the upper left.

The three techniques described below are known for calculating reflection of light on a structure smaller than visible light wavelength.

### 1. Effective Medium Theory

The effective medium theory is a calculation technique in which a submicron-scale structure is coarse grained and is considered as a medium that has an average reflective index of the solute of space including the structure (such as solute forming the structure, or air). For the calculation, a moth-eye structure is considered as a multi-layered film consisting of a large number of films whose refractive indexes vary by gradation.

### 2. Rigorous Coupled Wave Analysis (RCWA)

RCWA is a technique of solving a relational expression (coupling equation) between incident light to a submicron-scale diffraction grating and diffracted light.

### 3. Finite-Difference Time-Domain Method (FDTD)

FDTD is a technique of sequentially solving Maxwell's equations.

A report says that all the techniques produce an identical result. The inventors of the present invention used the technique 1: the effective medium theory for the calculation. Herein, the techniques 2 and 3, which are common calculation methods (softs for the calculation are commercially available), are not examined in detail.

Non Patent Literatures 3 and 4 describe the technique 1 in detail. Thus, a method of applying this technique to a moth-eye structure is briefly described herein. The technique 1 includes the following steps 1 to 3.

Step 1

A moth-eye structure is finely divided into multiple layers in the thickness direction (see FIG. 56(a)).

Step 2

Herein, the refractive index of each layer is an average refractive index based on the volume ratio of the solutes forming the layers (see FIG. 56(b)). The relation between the refractive index and the position in the thickness direction creates a step graph (see FIG. 56(c)).

Step 3

Reflected light of light incident to the multi-layered film is calculated. The calculation is of a level that can be calculated by a common spreadsheet application. The parameters for the calculation are as follows.

The input values are incident angle, wavelength, number of the layers, thickness of each layer, and refractive index (may be complex numbers) of each layer.

A phase change δj of each layer is expressed by the following expression.

$${δ}_{j} = \frac{2 π}{{λ}_{0}} {n}_{j} {h}_{j} sin {θ}_{j}$$

A characteristic matrix [Mⱼ] of each layer is expressed by the following expression.

$$( \begin{matrix}{E}_{j - 1} \\ {H}_{j - 1}\end{matrix} ) = [ {M}_{j} ]$$

$$( \begin{matrix}{E}_{j - 1} \\ {H}_{j - 1}\end{matrix} ) = ( \begin{matrix}cos {δ}_{j} & i sin {δ}_{j} / {Y}_{j} \\ i sin {δ}_{j} \cdot {Y}_{j} & cos {δ}_{j}\end{matrix} ) ( \begin{matrix}{E}_{j - 1} \\ {H}_{j - 1}\end{matrix} )$$

A characteristic admittance Yⱼ of each layer is expressed by the following expression.

Yᵢ=\sqrt{∈₀/μ₀}nᵢ cos θᵢ

A product [M] of the characteristic matrixes of the layers is expressed by the following expression.

$$( \begin{matrix}{E}_{0} \\ {H}_{0}\end{matrix} ) = [ {M}_{1} ] [ {M}_{2} ] … [ {M}_{l} ]$$

$$( \begin{matrix}{E}_{l} \\ {H}_{l}\end{matrix} ) = ( \begin{matrix}{m}_{11} & {m}_{12} \\ {m}_{21} & {m}_{22}\end{matrix} ) ( \begin{matrix}{E}_{l} \\ {H}_{l}\end{matrix} )$$

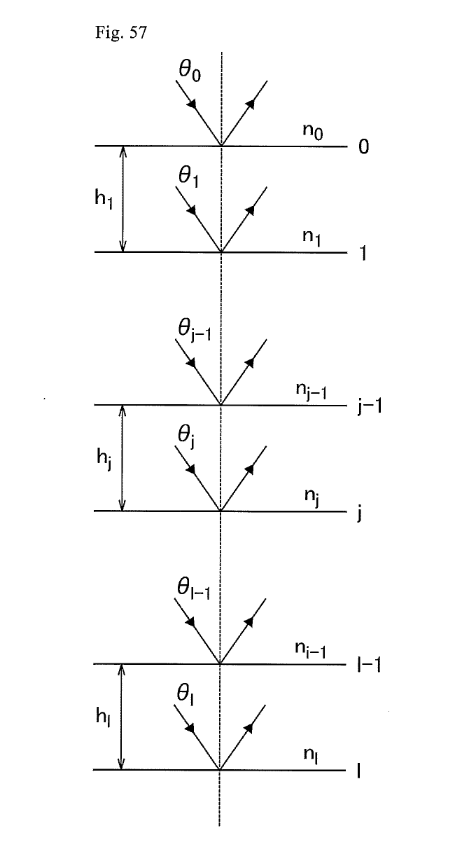

As shown in FIG. 57, the 8 represents an incident angle; h represents the thickness of the layer; and n represents the refractive index of the layer in the expression. Non-Patent Literature 6 describes the details.

The output value is a reflectance Ro, and is expressed by the following expression.

$${R}_{0} = {\vert \frac{{Y}_{0} ( {m}_{11} + {Y}_{l + 1} {m}_{12} ) - ( {m}_{21} + {Y}_{l + 1} {m}_{22} )}{{Y}_{0} ( {m}_{11} + {Y}_{l + 1} {m}_{12} ) + ( {m}_{21} + {Y}_{l + 1} {m}_{22} )} \vert}^{2}$$

The relation of the characteristic matrixes [Mⱼ] is determined as described below. In the case of s-polarized light, the following expressions are derived.

$${E}_{x} ( x , z : t ) = {E}_{j}^{+} exp \{ i ω t - \frac{2 πi {n}_{j}}{{λ}_{0}} ( x sin {θ}_{j} + z cos {θ}_{j} ) \} + {E}_{j}^{-} exp \{ i ω t - \frac{2 π i {n}_{j}}{{λ}_{0}} ( x sin {θ}_{j} - z cos {θ}_{j} ) \}$$

$${E}_{z} ( x , z : t ) = {E}_{j}^{+} exp \{ i ω t - \frac{2 π i {n}_{j}}{{λ}_{0}} ( x cos {θ}_{j} - z sin {θ}_{j} ) \} + {E}_{j}^{-} exp \{ i ω t - \frac{2 π i {n}_{j}}{{λ}_{0}} ( x cos {θ}_{j} + z sin {θ}_{j} ) \}$$

$${H}_{j} ( x , z : t ) = {H}_{j}^{+} exp \{ i ω t - \frac{2 πi {n}_{j}}{{λ}_{0}} ( x sin {θ}_{j} + z cos {θ}_{j} ) \} + {H}_{j}^{-} exp \{ i ω t - \frac{2 π i {n}_{j}}{{λ}_{0}} ( x sin {θ}_{j} + z cos {θ}_{j} ) \}$$

The right side and left side of the following Faraday's law formula are modified.

$$∇ \times E = - μ \frac{\partial H}{\partial t}$$

$${( ∇ \times E )}_{y} = \frac{\partial {E}_{x}}{\partial z} - \frac{\partial {E}_{z}}{\partial x} = - \frac{2 π i {n}_{j}}{{λ}_{0}} cos {θ}_{j} ( {E}_{j}^{+} - {E}_{j}^{-} ) \\ - μ \frac{\partial {H}_{j}}{\partial t} = - i ωμ {H}_{j}$$

These results derive the following relational expressions.

$$- i ωμ {H}_{j} = - \frac{2 π i {n}_{j}}{{λ}_{0}} cos {θ}_{j} ( {E}_{j}^{+} - {E}_{j}^{-} )$$

$${H}_{j} = \frac{2 π {n}_{j}}{{ωμλ}_{0}} cos {θ}_{j} ( {E}_{j}^{+} - {E}_{j}^{-} ) = \sqrt{\frac{{ɛ}_{0}}{{μ}_{0}}} {n}_{j} cos {θ}_{j} ( {E}_{j}^{+} - {E}_{j}^{-} )$$

$${H}_{j - 1} = \sqrt{\frac{{ɛ}_{0}}{{μ}_{0}}} {n}_{j} cos {θ}_{j} ( {E}_{j}^{+} {e}^{i {δ}_{j}} - {E}_{j}^{-} {e}^{- i {δ}_{j}} )$$

Also, the following relational expressions are derived from the boundary conditions.

Eⱼ=Eⱼ⁺+Eⱼ⁻

Eⱼ₋₁=Eⱼ⁺e^{iδ}^{ⱼ}+Eⱼ⁻e^{-iδ}^{ⱼ}

The relational expressions derive the relationship of the characteristic matrixes [Mⱼ] of the layers.

The concept of a pitch does not exist in the effective medium theory, whereas it exists in the techniques 2 and 3.

The following describes haze of a moth-eye film.

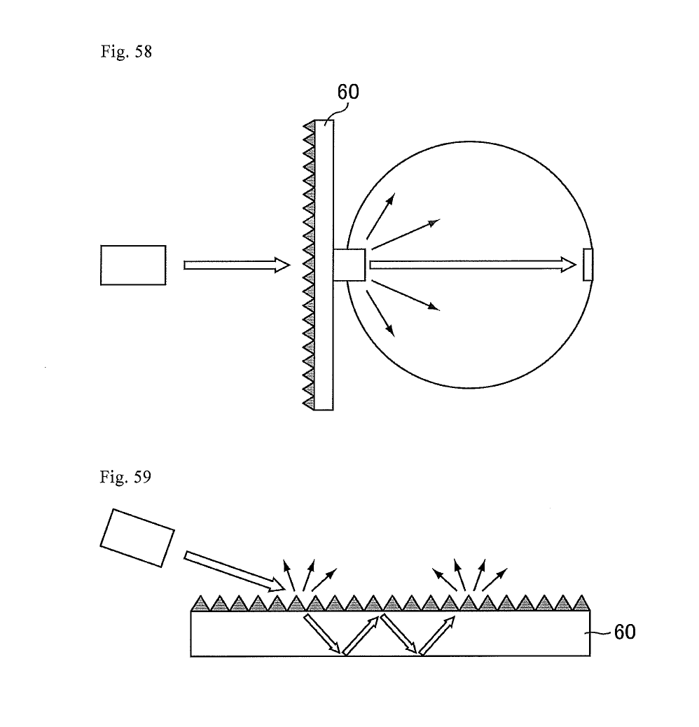

When a moth-eye film is irradiated with light, a haze component is a component that is diffused without linearly advancing through the film nor without being specular reflected. As shown in FIG. 58, the haze is usually measured as follows: a moth-eye film 60 is irradiated with linear light from an orthogonal direction; the linearly advancing light and diffused light in transmitted light are separately measured; and the haze is determined by the following expression.

Haze=Diffused light/(Linearly advancing light+Transmitted light)=(Total light transmitted−Linearly advancing light)/Total light transmitted

The points to be considered concerning the haze of a moth-eye film are that light to be incident to a sample is orthogonally applied to the sample, and that only the transmitted light is measured without measuring back-scattered light.

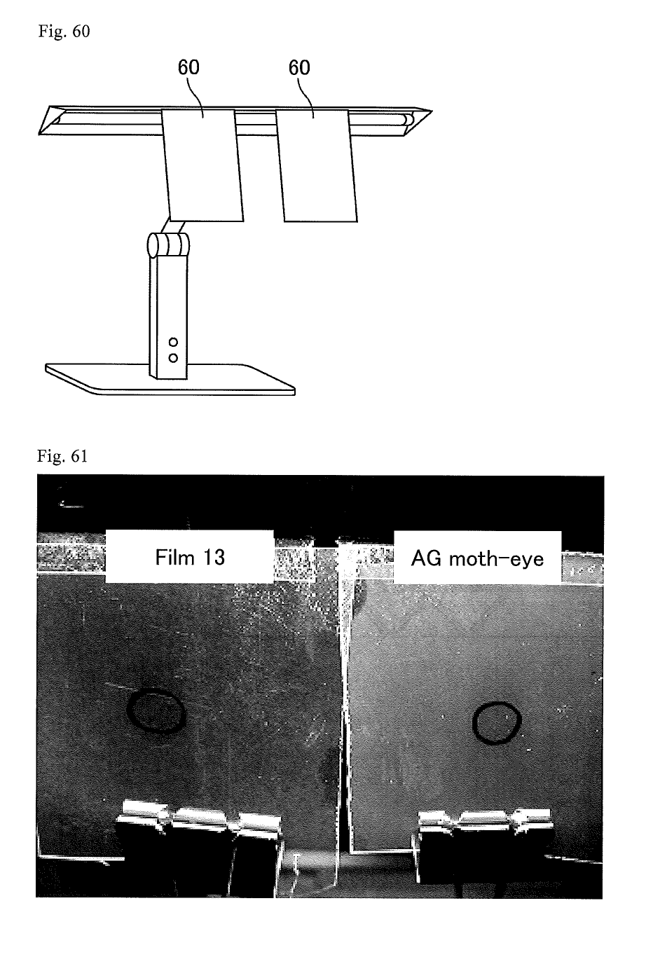

A viewer of a moth-eye film significantly recognizes haze when the moth-eye film 60 is irradiated with light from an oblique direction as shown in FIG. 59. At this time, two types of components exist: a component of the incident light that is directly back-scattered by the moth-eye structure (nanostructure), and a component that is guided through the moth-eye film 60 and is then scattered and emitted from a site away from the incident site. This is considered due to occurrence of a high level of diffraction phenomenon derived specifically from the moth-eye structure in the moth-eye film. In contrast, in the case of a usual film, the phenomenon of incident light to the surface of the film being guided through the film is not observed. Examples of simple methods to detect the component being guided through the film include a method of attaching the moth-eye film 60 to an edge of a desk light, marking a circle with a marker on the surface of the moth-eye film 60, and observing the marked portion with naked eyes, as shown in FIG. 60. This method was actually performed as shown in FIG. 60. In FIG. 61, a red circle having a diameter of approximately 1 cm is drawn. The inside and vicinity of the red circle are found to be reddish due to the diffused light. The moth-eye film in FIG. 61 is a moth-eye film single body in which a moth-eye structure is formed on a TAC film. Redness is not found in an observation of a sample in which the moth-eye film is attached to a glass plate. This indicates that light guiding contributes to scattering of light on the moth-eye film. FIG. 61 shows the film 13 and an AG moth-eye film. The AG moth-eye film is a film having a moth-eye structure on a surface with relatively large irregularities having a height of 700 to 800 nm and a pitch of substantially 20 μm. The AG moth-eye film can be produced, for example, by producing, as a substrate, an electrodeposited sleeve by forming an organic coating on the surface of a nickel roll by electrodeposition; preparing a porous alumina mold from the substrate by substantially the same method as mentioned above; and performing the shape transfer process using the mold.

Thus, not only reduction of the haze measured by the method shown in FIG. 58 but also suppression of the light scattering illustrated in FIG. 59 and FIG. 60 are desired. Herein, the former is referred to as front haze, and the latter is referred to as deviation haze.

### (Evaluation Test 2)

Two kinds of moth-eye films (films 15 and 16) were actually produced by the same method as that for the films 1 to 14, except for the following. The conditions for producing the porous alumina mold are different between the films 1 to 14 and the films 15 and 16. Specifically, the voltage in the anode oxidation treatment, the time for the anode oxidation treatment (AO time), and the time for the etching are different among the films. The mold for the film 15 was produced under a voltage of 55 V, an AO time of 120 seconds, and an etching time of 8 minutes. The mold for the film 16 was produced under a voltage of 65 V, an AO time of 90 seconds, and an etching time of 10 minutes. Further, the film 3, film 7, film 15, film 16, and film 13 each are attached to a business-card-size glass plate to prepare five kinds of samples. The voltages for the anode oxidation treatment in the production of the porous alumina molds for the films 3, 7, 15, 16, and 13 are 35 V, 45 V, 55 V, 65 V, and 80 V, respectively. The pitches of the moth-eye structures of the films 3, 7, 15, 16, and 13 are 85 nm, 115 nm, 135 nm, 160 nm, and 190 nm, respectively.

The five kinds of samples were hung in front of a fluorescent light as shown in FIG. 60, and the polarized haze was observed with naked eyes. The samples were observed in an angle of 45 degree, 50 degree, 60 degree, 75 degree, or 80 degree from the normal direction of the main surface of each sample.

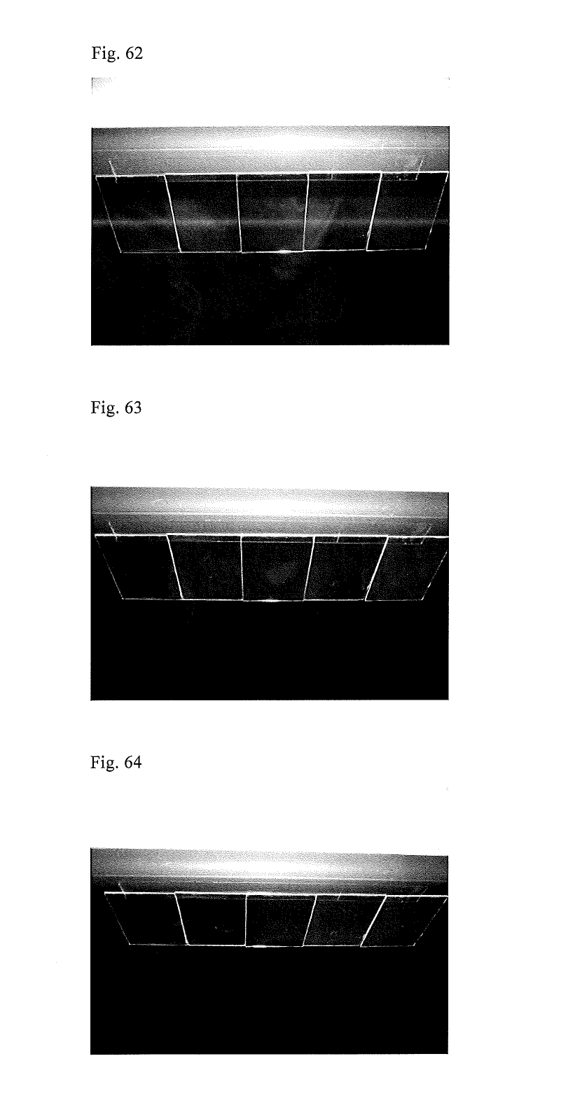

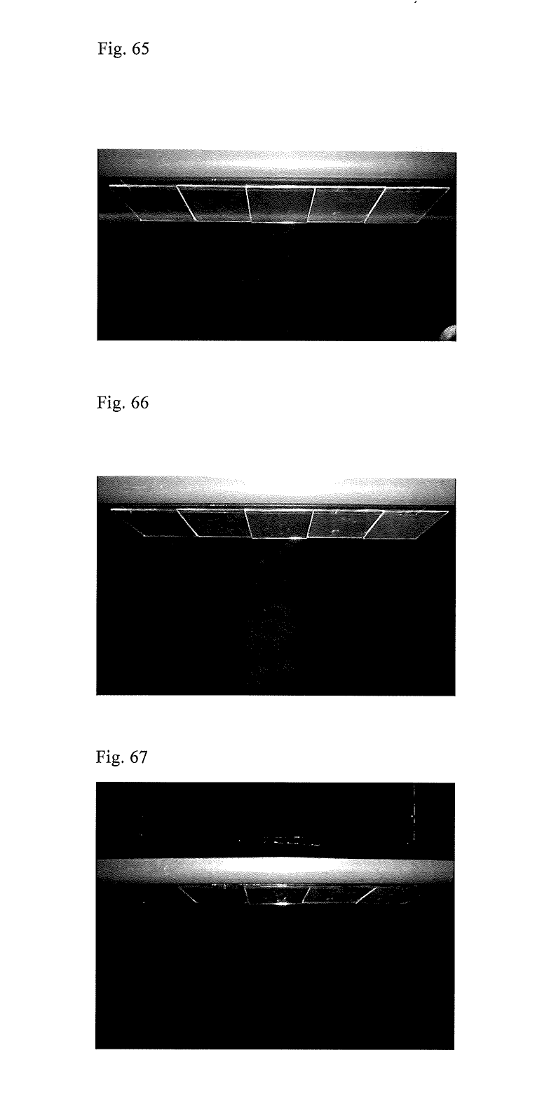

FIG. 62 to FIG. 67 each area photograph of the five kinds of samples taken for observing deviation hazes. In each figure, the film 3, film 7, film 15, film 16, and film 13 are disposed in this order from the left. Light scatters more on the moth-eye structure having a longer pitch in all the observation angles. Table 17 below shows the results of subjective evaluations on the deviation haze of the films by a plurality of people. The films which were transparent, white cloudy, and slightly white cloudy in the observation are marked “Good”, “Poor”, and “Not good”, respectively, in Table 17.

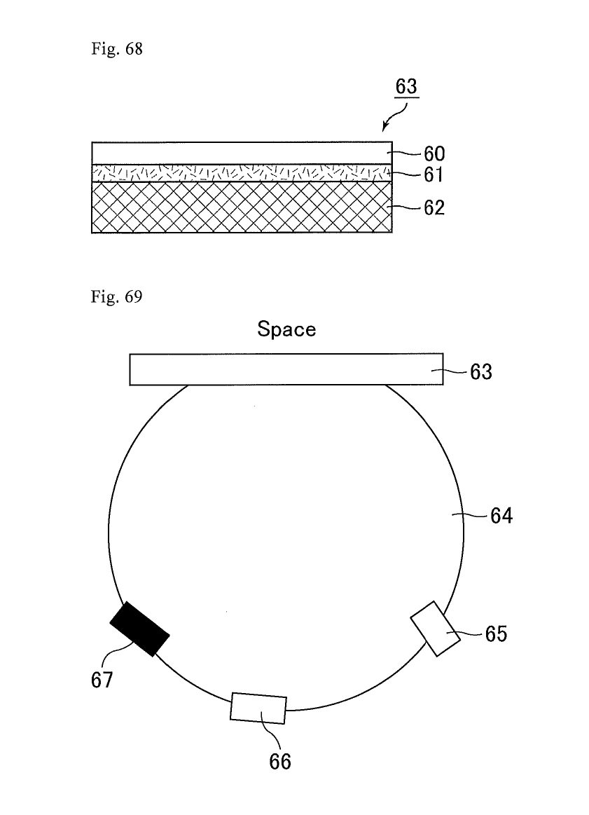

Separately, five kinds of samples were prepared from the films 3, 7, 15, 16, and 13. The front hazes and the deviation hazes of the films 3, 7, 15, 16, and 13 were measured using the samples. As shown in FIG. 68, samples 63 each were prepared by attaching the moth-eye film 60 (one of the films 3, 7, 15, 16, and 13) having a size of 63 mm×42 mm to a glass plate 62 having a thickness of 700 μm using an adhesive 61 (trade name: PDS1, thickness: 20 μm, produced by Panac Industries Inc.). A 80-μm thick TAC film was used as a substrate film in the films 3, 7, 15, 16, and 13. The thickness of an ultraviolet ray curable resin upon application was controlled to be 8 μm.

The front haze was measured with a haze meter NDH 2000 produced by Nippon Denshoku Industries Co., Ltd. The deviation haze was measured with a spectrophotometer CM-2600d produced by Konica Minolta Sensing under the specular components excluded (SCE) mode that excludes specular reflection. As shown in FIG. 69, the spectrophotometer includes an integrating sphere 64, a light source 65, a light receiver 66, and a specular reflection mask 67. An open space is provided at the rear of the sample 63. The sample 63 is disposed such that the surface having the moth-eye structure faces inside the integrating sphere 64.

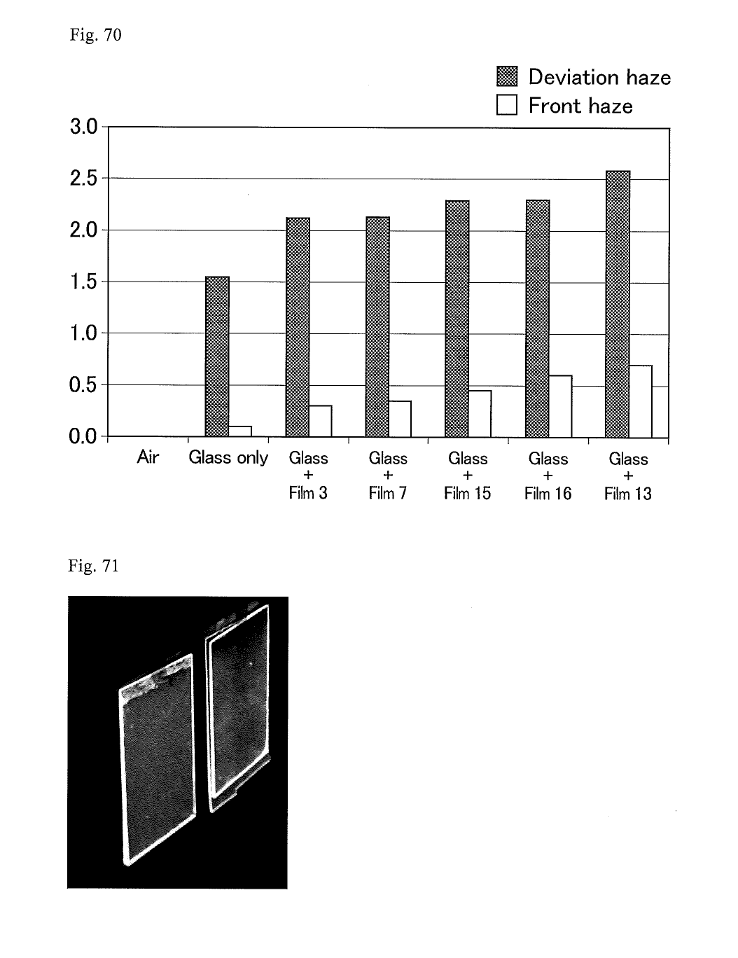

FIG. 70 and Table 17 below show the measurement results. A result of measurement on air without disposing any objects and a result of measurement on the glass plate 62 alone are also shown. The measurement results indicate that the moth-eye structure having a longer pitch leads to greater front haze and deviation haze. The results of the subjective evaluations indicate that the pitch P of the moth-eye structure is preferably not longer than 150 nm, and more preferably not longer than 120 nm. The film 16 has the same deviation haze value as that of the film 15; however, the films are very different concerning the visibility as shown in FIG. 62 to FIG. 67.

TABLE 17

| | | Pitch P | Height H | Deviation | | Subjective |
|---|---|---|---|---|---|---|
| Film No.. | Sample | (nm) | (nm) | haze haze | Front haze | evaluation |
| — | Air | — | — | 0.0 | 0.0 | — |
| — | Glass only | — | — | 1.5 | 0.1 | — |
| 3 | Glass + Film 3 | 85 | 230 | 2.1 | 0.3 | Good |
| 7 | Glass + Film 7 | 115 | 225 | 2.1 | 0.4 | Good |
| 15 | Glass + Film 15 | 135 | 220 | 2.3 | 0.5 | Not good |
| 16 | Glass + Film 16 | 160 | 225 | 2.3 | 0.6 | Poor |
| 13 | Glass + Film 13 | 190 | 280 | 2.6 | 0.7 | Poor |

### (Evaluation Test 3)

A moth-eye film (film 17) was actually produced using a mold in which the photoresist is patterned by interference exposure. The moth-eye structure of the film 17 had a pitch of 200 nm. The protrusions of the moth-eye structure were randomly arranged in the films 1 to 16 produced using the porous alumina mold, whereas the protrusions of the moth-eye structure were regularly arranged in a lattice pattern in the film 17. Moreover, the film 13 (pitch=190 nm) and the film 17 (pitch=200 nm) each were attached to a business-card-size glass plate to prepare two kinds of samples. The two kinds of samples were hung in front of a fluorescent light as shown in FIG. 60, and the polarized haze was observed with naked eyes.

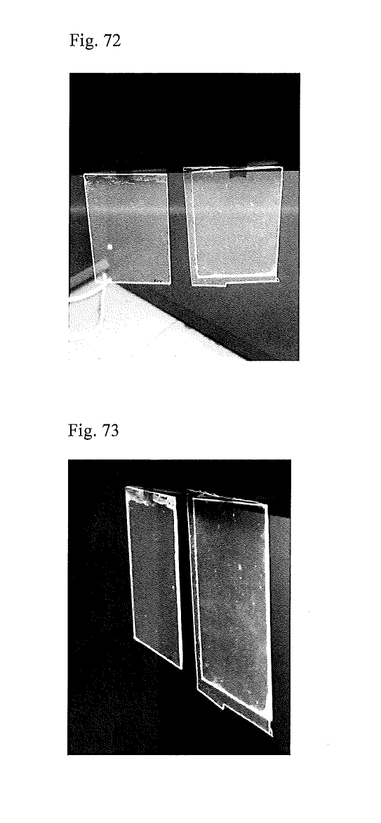

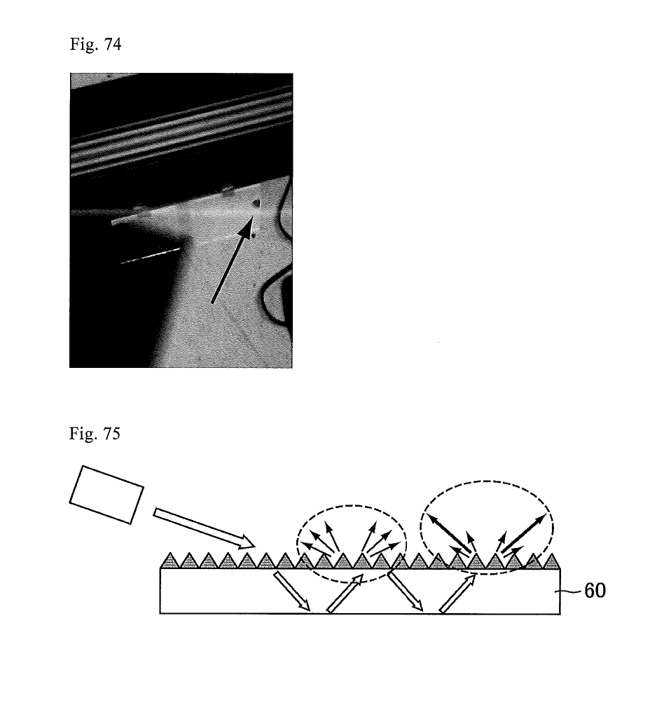

FIG. 71 to FIG. 74 each are a photograph of two kinds of samples taken for observing the deviation haze. In each figure, the film 13 is on the left and the film 17 is on the right. As shown in FIG. 71 to FIG. 73, the difference in the visibility between the film 13 and the film 17 is prominent in the observation from an oblique direction. The entire film 13 looked bluish as compared with the film 17. However, as shown in FIG. 74, a part (a part pointed by an arrow in FIG. 74) of the film 17 looked very bright and bluish in an observation from a specific direction. The results indicate that the film 17 having regularly arranged protrusions allows light (mainly blue light) to pass out of the film in an extremely limited direction, and that the film 13 having randomly arranged protrusions allows light (mainly blue light) to pass out of the film in a broad range of oblique directions. The reason is presumably as follows. As shown in FIG. 75, a part of external light incident to the moth-eye film 60 is guided through the film 60, and is emitted to the outside after causing a high-order diffraction phenomenon derived from the moth-eye structure. Presumably, the direction of the emitted light in the case of the moth-eye structure with randomly arranged protrusions (central portion in FIG. 75) is different from that in the case of the moth-eye structure with regularly arranged protrusion (right portion in FIG. 75).

### (Regularity of the Arrangement of Protrusions in Moth-Eye Film Produced Using Porous Alumina Mold)

An aluminum film having a thickness of 1 μm was formed by sputtering on surfaces of a plurality of glass substrates. The substrates having the films were subjected once to anodic oxidation so that an anodized layer (layer 1, 2, 3, 4, or 5) having a porous surface was formed. The layers 1 to 5 were formed under different anodic oxidation conditions as follows. The anodic oxidation was performed by immersing the substrate in an oxalic acid solution at 5° C. for forming the films 1 to 4, whereas the anodic oxidation was performed by immersing the substrate in a tartaric acid solution at room temperature (22° C.) for forming the film 5. The layer 1 was formed under a concentration of the oxalic acid solution of 0.03 wt %, a voltage of 45 V, and an AO time of 200 seconds. The layer 2 was formed under a concentration of the oxalic acid solution of 0.03 wt %, a voltage of 80 V, and an AO time of 350 seconds. The layer 3 was formed under a concentration of the oxalic acid solution of 0.6 wt %, a voltage of 200 V, and an AO time of 16 seconds. The layer 4 was formed under a concentration of the oxalic acid solution of 0.6 wt %, a voltage of 300 V, and an AO time of 5 seconds. The layer 5 was formed under a concentration of the tartaric acid solution of 2 wt %, a voltage of 200 V, and an AO time of 10 minutes.

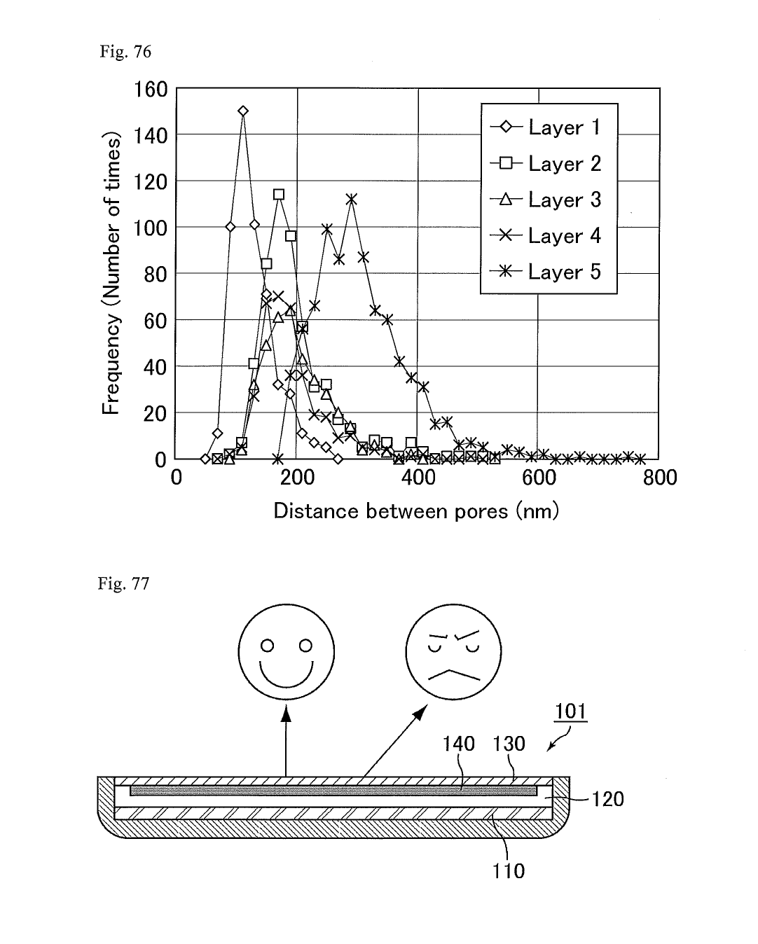

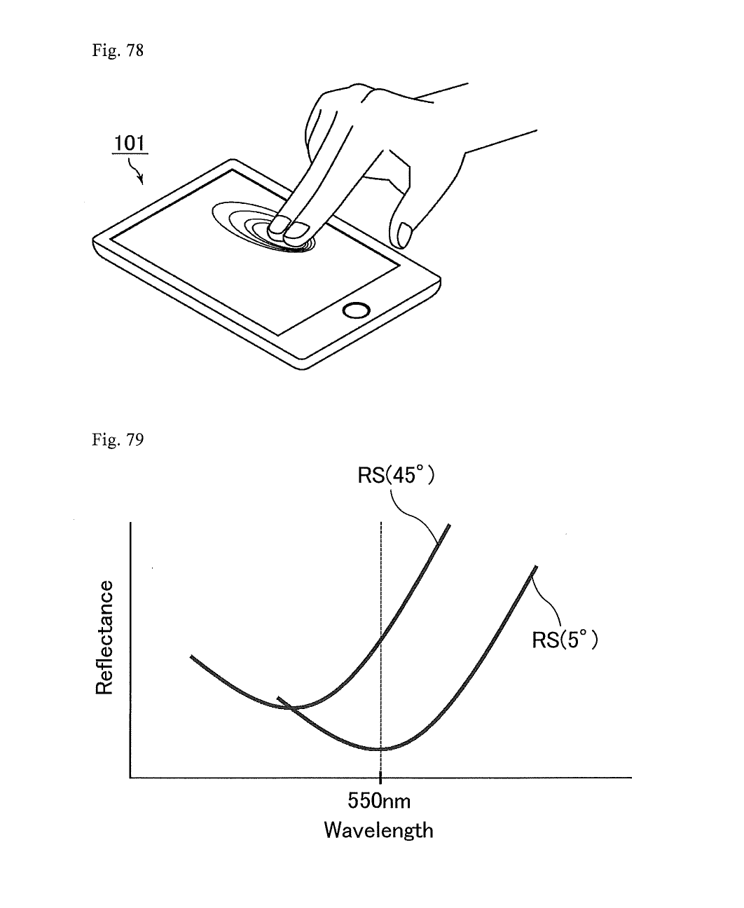

An SEM photograph (magnification=20000×) of the surface of each layer was taken. Distances from the center of each pore to the centers of the first to third nearest pores were measured for approximately 200 pores in a few micrometers square of the photograph (see FIG. 76 and Table 18 below for the distribution of the distance between pores in the layers). The average value (average distance) and the standard deviation of the distances were calculated. The pitch randomness (%) of each anodized layer was calculated by dividing the standard deviation by the average value. The average distance between pores was found to be 117.6 nm in the layer 1; 187.1 nm in the layer 2; 190.2 nm in the layer 3; 187.8 nm in the layer 4; and 295.8 nm in the layer 5. The pitch randomness of the anodized layer is found to be 29.7% in the layer 1; 33.0% in the layer 2; 29.5% in the layer 3; 32.6% in the layer 4; and 26.6% in the layer 5. The average distance between pores was found to change depending on the condition for the anodic oxidation, whereas the pitch randomness of the anodized layer was found to be almost constant regardless of the condition for the anodic oxidation. Moreover, the graph in FIG. 76 is not symmetric with respect to the peak value but notably in a shape having a longer tail on the right side of the peak.

TABLE 18

| Distance | | | | | |
|---|---|---|---|---|---|
| between | Frequency (number of times) | | | | |
| pores (nm) | Layer 1 | Layer 2 | Layer 3 | Layer 4 | Layer 5 |
| 50 | 0 | 0 | 0 | 0 | 0 |
| 70 | 11 | 0 | 0 | 0 | 0 |
| 90 | 100 | 2 | 0 | 2 | 0 |
| 110 | 150 | 7 | 4 | 5 | 0 |
| 130 | 101 | 41 | 32 | 27 | 0 |
| 150 | 71 | 84 | 49 | 67 | 0 |
| 170 | 32 | 114 | 61 | 70 | 0 |
| 190 | 28 | 96 | 64 | 65 | 36 |
| 210 | 11 | 57 | 43 | 36 | 56 |
| 230 | 7 | 31 | 34 | 19 | 66 |
| 250 | 5 | 32 | 28 | 18 | 99 |
| 270 | 0 | 17 | 20 | 9 | 86 |
| 290 | 0 | 13 | 14 | 10 | 112 |
| 310 | 0 | 5 | 4 | 5 | 87 |
| 330 | 0 | 8 | 6 | 4 | 64 |
| 350 | 0 | 7 | 3 | 4 | 60 |
| 370 | 0 | 1 | 0 | 0 | 42 |
| 390 | 0 | 7 | 2 | 1 | 35 |
| 410 | 0 | 3 | 0 | 2 | 31 |
| 430 | 0 | 0 | 0 | 0 | 15 |
| 450 | 0 | 1 | 0 | 0 | 16 |
| 470 | 0 | 1 | 0 | 0 | 6 |
| 490 | 0 | 1 | 0 | 1 | 7 |
| 510 | 0 | 1 | 0 | 0 | 5 |
| 530 | 0 | 0 | 0 | 0 | 1 |
| 550 | 0 | 0 | 0 | 0 | 4 |
| 570 | 0 | 0 | 0 | 0 | 3 |
| 590 | 0 | 0 | 0 | 0 | 1 |
| 610 | 0 | 0 | 0 | 0 | 2 |
| 630 | 0 | 0 | 0 | 0 | 0 |
| 650 | 0 | 0 | 0 | 0 | 0 |
| 670 | 0 | 0 | 0 | 0 | 1 |
| 690 | 0 | 0 | 0 | 0 | 0 |
| 710 | 0 | 0 | 0 | 0 | 0 |
| 730 | 0 | 0 | 0 | 0 | 0 |
| 750 | 0 | 0 | 0 | 0 | 1 |
| 770 | 0 | 0 | 0 | 0 | 0 |

If the layer was further repeatedly subjected to anodic oxidation and etching treatment, the pores would become deeper and larger so that the layer can be a porous alumina mold. Thus, the average distance and the pitch randomness of each layer are substantially identical to the average distance and the pitch randomness of pores of a porous alumina mold produced by repeating anodic oxidation under the same condition as that of the anodic oxidation of the layer, and etching, and are also substantially identical to the average distance and pitch randomness of the protrusions of the moth-eye structure produced using the mold. Thus, the above results revealed that the pitch randomness of the moth-eye structure of a moth-eye film produced using the porous alumina mold is almost constant, in a range of 25% to 35%, regardless of the condition for the anodic oxidation. A pitch randomness of the moth-eye structure within the range enables to prevent the film from being locally very bright like the moth-eye film having regularly arranged protrusions. Furthermore, a pitch randomness of the moth-eye structure within the range and a pitch of the moth-eye structure being not longer than 150 nm (preferably not longer than 120 nm) together enable to suppress the front haze and deviation haze on the entire film.

The anodic oxidation condition for the layer 1 is the same as that for the mold for the film 7. The anodic oxidation condition for the layer 2 is the same as that for the mold for the film 13. Moreover, the pitch randomness of an anodized layer formed according to the method described in Patent Literature 7 is almost the same as the pitch randomness of the layers 1 to 5.

### REFERENCE SIGNS LIST

1: Display device
10: Display panel
11, 12: Substrate
20: Air layer
30: Front sheet
40, 50, 60, 81: Film (Moth-eye film)
41: Moth-eye structure (Nanostructure)
42, 44, 70: Substrate
43: Protrusion (Convex portion)
61: Pressure sensitive adhesive
62, 71: Glass plate
63: Sample
64: Integrating sphere
65: Light source
66: Light receiver
67: Specular reflection mask
72: Aluminum pipe
73: Electrodeposited sleeve
74: Film roll
75: Substrate film
76: Die coater
77: Cutter
78, 79: Embossing device
82: Black acrylic plate
83: Light projecting section
84: Light receiving section
RS(5°): Reflection spectrum of 5-degree specular reflection
RS(45°): Reflection spectrum of 45-degree specular reflection

1. A display device comprising:
a display panel,
a front sheet disposed in front of the display panel with an air layer interposed therebetween, and
a film disposed on the front surface of the display panel or on the rear surface of the front sheet,
wherein the air layer has a thickness of not more than 50 μm,
at least one of the display panel and the front sheet can be warped,
the thickness of the air layer varies within a range of 0 μm to 50 μm when at least one of the display panel and the front sheet is warped,
the film includes a moth-eye structure on a surface contacting the air layer, and
a reflectance at at least one wavelength within a range of 600 to 780 nm is smaller than a reflectance at a wavelength of 550 nm in the reflection spectrum of 5-degree specular reflection of the moth-eye structure.

2. The display device according to claim 1,
wherein the front sheet has a Young's modulus of less than 70 GPa, and further comprises a component which deforms with the film upon deformation of the film.

3. The display device according to claim 1,
wherein the moth-eye structure has a height of from 200 nm to 350 nm.

4. The display device according to claim 1,
wherein the moth-eye structure has an aspect ratio of not more than 3.

5. The display device according to claim 1,
wherein the moth-eye structure has a pitch of not longer than 150 nm.

6. The display device according to claim 5,
wherein the moth-eye structure has a pitch randomness of from 25% to 35%.

7. The display device according to claim 1, further comprising a second film disposed on either of the front surface of the display panel or the rear surface of the front sheet on which the film is not disposed, the second film including a moth-eye structure on a surface contacting the air layer.
